(19) United States
(12) Patent Application Publication
(10) Pub. No.: US 2026/0095606 A1
(43) Pub. Date: Apr. 2, 2026

(54) METHODS AND SYSTEMS OF FACILITATING STREAMING OF EVENTS

(71) Applicant: Avinash Singh, Stow, OH (US)

(72) Inventor: Avinash Singh, Stow, OH (US)

(21) Appl. No.: 19/344,091

(22) Filed: Sep. 29, 2025

Related U.S. Application Data
(60) Provisional application No. 63/702,479, filed on Oct. 2, 2024.

(51) Int. Cl. H04N 21/24; H04N 21/2387; H04N 21/2662; H04N 21/4788; H04N 21/81

(52) U.S. Cl. CPC H04N 21/2407; H04N 21/2387; H04N 21/2662; H04N 21/4788; H04N 21/8146

(57) ABSTRACT

The present disclosure provides a method of facilitating streaming of events. Further, the method include receiving one or more sensor data. Further, the one or more sensors may be configured for generating the one or more sensor data by capturing one or more events. Further, the method include analyzing the one or more sensor data, generating one or more event representation data representing a virtual reconstruction of the one or more events based on the analyzing, processing the one or more event representation data, generating one or more streamable data for streaming the one or more events based on the processing, storing the one or more streamable data, and transmitting the one or more streamable data to one or more client devices.

### FIELD OF DISCLOSURE

The present disclosure generally relates to the field of data processing. More specifically, the present disclosure relates to methods and systems of facilitating streaming of events.

### BACKGROUND

The field of immersive multimedia systems is of growing importance as the field enables audiences to experience events, performances, and social interactions beyond the limitations of physical attendance or traditional broadcast models. The integration of advanced media technologies with communication networks has created opportunities for individuals and organizations to engage in shared experiences that transcend geography, physical constraints, and conventional modes of interaction.

A desirable objective in the field is to provide experiences that are both highly immersive and widely accessible, allowing participants to perceive events with a sense of depth, realism, and shared presence. Achieving the desirable objective requires systems that may deliver dynamic representations of real-world events in formats that are interactive, engaging, and inclusive across a variety of devices and user contexts. Further, there is a desire that such systems support synchronous and asynchronous participation, enable rich interaction between geographically dispersed audiences, and provide opportunities for creators and organizers to engage and monetize audiences in innovative ways.

The patent US20220417488A1 (Opportunistic Volumetric Video Editing) describes enhancing 3D objects by referencing existing object libraries, aiming to reduce storage and bandwidth requirements for streaming applications. The patent US20220417488A1 focuses on improving viewing experiences by personalizing volumetric video consumption. The patent U.S. Pat. No. 7,839,399B2 (Volumetric Display of Video Images Extracted from Arbitrary Backgrounds) describes a system for real-time extraction of video images from arbitrary backgrounds and their display in a volumetric format. The patent U.S. Pat. No. 7,839,399B2 emphasizes the capability to process and display video streams in a three-dimensional space without the need for controlled studio environments. The patent US20160286244A1 (Live Video Streaming Services) outlines an interactive video broadcasting service that enables multiple source devices to broadcast live video streams over a network to various viewing devices. The patent US20160286244A1 includes features like multi-perspective video sharing, video editing for replays, and synchronization of multiple live feeds related to the same event. The patent US20040104935A1 (Virtual Reality Immersion System) presents a virtual reality system that immerses users into a virtual environment by reacting to user movements and displaying relative 3D content in real-time. The patent US20040104935A1 includes tracking user positions using target markers and providing head-mounted displays with integrated video cameras and displays.

However, existing approaches in digital media distribution face several problems that limit the approaches' ability to achieve the desirable objective. Current systems are constrained by passive modes of consumption, where viewers have little control over the viewer's perspective or level of interaction. Many platforms restrict immersive experiences to specialized hardware ecosystems, limiting accessibility for the broader public. Available solutions also struggle with the technical demands of transmitting rich, high-fidelity media in real time across networks with varying bandwidth and latency conditions, leading to degraded quality of experience. Furthermore, immersive content creation remains inaccessible for most users due to reliance on costly or proprietary capture setups. Another set of challenges arises in the areas of privacy, content moderation, and safety within shared digital spaces, which are often inadequately addressed by conventional platforms. Creators and event organizers face fragmented monetization options, with few reliable mechanisms for real-time audience engagement, revenue generation, or integration of branded experiences. Moreover, current platforms often lack the scalability and adaptability necessary to support both large-scale events and intimate personal interactions within the same technological framework.

Therefore, there is a need for improved methods and systems of facilitating streaming of events that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating streaming of events. Further, the method may include receiving, using a communication device, one or more sensor data from one or more sensors. Further, the one or more sensors may be configured for generating the one or more sensor data by capturing one or more events. Further, the method may include analyzing, using a processing device, the one or more sensor data. Further, the method may include generating, using the processing device, one or more event representation data representing a virtual reconstruction of the one or more events based on the analyzing of the one or more sensor data. Further, the method may include processing, using the processing device, the one or more event representation data. Further, the method may include generating, using the processing device, one or more streamable data for streaming the one or more events based on the processing of the one or more event representation data. Further, the method may include storing, using a storage device, the one or more streamable data. Further, the method may include transmitting, using the communication device, the one or more streamable data to one or more client devices associated with one or more clients. Further, the one or more client devices may be configured for presenting the one or more streamable data.

The present disclosure provides a system for facilitating streaming of events. Further, the system may include a communication device. Further, the communication device may be configured for receiving one or more sensor data from one or more sensors. Further, the one or more sensors may be configured for generating the one or more sensor data by capturing one or more events. Further, the communication device may be configured for transmitting one or more streamable data to one or more client devices associated with one or more clients. Further, the one or more client devices may be configured for presenting the one or more streamable data. Further, the system may include a processing device communicatively coupled to the communication device. Further, the processing device may be configured for analyzing the one or more sensor data. Further, the processing device may be configured for generating one or more event representation data representing a virtual reconstruction of the one or more events based on the analyzing of the one or more sensor data. Further, the processing device may be configured for processing the one or more event representation data. Further, the processing device may be configured for generating the one or more streamable data for streaming the one or more events based on the processing of the one or more event representation data. Further, the system may include a storage device communicatively coupled to the processing device which may be configured for storing the one or more streamable data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating streaming of events, in accordance with some embodiments.

FIG. 4 illustrates a flowchart of a method 400 of facilitating streaming of events including generating, using the processing device 904, at least one rewatch streamable data for rewatching at least one event with playback controls, in accordance with some embodiments.

FIG. 5 illustrates a flowchart of a method 500 of facilitating streaming of events including analyzing, using the processing device 904, at least one dense point cloud data using at least one first algorithm, in accordance with some embodiments.

FIG. 6 illustrates a flowchart of a method 600 of facilitating streaming of events including receiving, using the communication device 902, at least one access selection for a plurality of event access options from at least one client device 910, in accordance with some embodiments.

FIG. 7 illustrates a flowchart of a method 700 of facilitating streaming of events including analyzing, using the processing device 904, at least one viewpoint request data using at least one event representation data, in accordance with some embodiments.

FIG. 8 illustrates a flowchart of a method 800 of facilitating streaming of events including analyzing, using the processing device 904, at least one social interaction data, in accordance with some embodiments.

FIG. 9 illustrates a block diagram of a system 900 for facilitating streaming of events, in accordance with some embodiments.

FIG. 10 illustrates a flowchart of a method 1000 of facilitating streaming of events including generating, using the processing device 904, at least one convolutional neural network, in accordance with some embodiments.

FIG. 11 illustrates a flowchart of a method 1100 of facilitating streaming of events including generating, using the processing device 904, at least one rewatchable alternate viewpoint data representing an alternate viewpoint of the at least one event, in accordance with some embodiments.

FIG. 12 illustrates a flowchart of a method 1200 of facilitating streaming of events including generating, using the processing device 904, a short-form video data representing a social media ready short video, in accordance with some embodiments.

FIG. 13 illustrates a flowchart of a method 1300 of facilitating streaming of events including analyzing, using the processing device 904, at least one user engagement data, in accordance with some embodiments.

FIG. 14 illustrates a flowchart of a method 1400 of facilitating streaming of events including generating, using the processing device 904, at least one gesture-modified streamable data, in accordance with some embodiments.

FIG. 15 illustrates a flowchart of a method 1500 of facilitating streaming of events including receiving, using the communication device 902, at least one selection of at least one of a plurality of privacy options from the at least one client device 910, in accordance with some embodiments.

FIG. 16 illustrates a flowchart of a method 1600 of facilitating streaming of events including determining, using the processing device 904, at least one codec, in accordance with some embodiments.

FIG. 17 illustrates a flowchart of a method 1700 of facilitating streaming of events including determining, using the processing device 904, a privilege of the at least one client to view the at least one event, in accordance with some embodiments.

FIG. 18 illustrates a flowchart of a method 1800 of facilitating streaming of events including receiving, using the communication device 902, at least one control selection for at least one of a plurality of audio language options, a plurality of camera angle options, a plurality of subtitle options, and a plurality of streaming quality options from the at least one client device 910, in accordance with some embodiments.

FIG. 19 illustrates a flowchart of a method 1900 of facilitating streaming of events including analyzing, using the processing device 904, a spatial audio request, in accordance with some embodiments.

FIG. 20 illustrates a flowchart of a method 2000 of facilitating streaming of events including generating, using the processing device 904, a shared playback data representing a shared session state of the at least one event for the plurality of clients, in accordance with some embodiments.

FIG. 21 illustrates a flowchart of a method 2100 of facilitating streaming of events including receiving, using the communication device 902, at least one token response to a token data from the at least one client device 910, in accordance with some embodiments.

FIG. 22 illustrates a flowchart of a method 2200 of an end-to-end process for facilitating streaming of events, in accordance with some embodiments.

FIG. 23 illustrates an architecture of a system 2300 for facilitating streaming of events, in accordance with some embodiments.

FIG. 24 depicts a data flow from heterogeneous capture devices to volumetric reconstruction, in accordance with some embodiments.

FIG. 25 depicts an artificial intelligence based reconstruction pipeline 2500 for facilitating streaming of events, in accordance with some embodiments.

FIG. 26 illustrates a flowchart of a compression and streaming subsystem 2600 of the system 2300, in accordance with some embodiments.

FIG. 27 depicts a real-time spatial co-viewing interface 2700 of the system 2300, in accordance with some embodiments.

FIG. 28 depicts a content moderation and privacy management interface 2800 of the system 2300, in accordance with some embodiments.

FIG. 29 illustrates a creator monetization dashboard interface 2900 of the system 2300, in accordance with some embodiments.

FIG. 30 illustrates an alternative flowchart of a method 3000 associated with the system 2300, in accordance with some embodiments.

FIG. 31 illustrates a block diagram of a system 3100 for facilitating streaming of events, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Definitions

For clarity and consistency, the following terms, which are used throughout the present disclosure, are defined as follows:

Event representation data: A temporally consistent three-dimensional scene data generated from heterogeneous sensor inputs (e.g., RGB-D, stereo, or volumetric capture devices), representing a volumetric reconstruction of at least one event.

Streamable data: Encoded and compressed media payload(s) derived from the event representation data, formatted for real-time delivery to client devices using protocols such as HLS, WebRTC, or MPEG-DASH.

Alternate viewpoint data: A reconstructed volumetric content generated in response to client viewpoint requests, enabling free-viewpoint navigation or rewatchable alternate perspectives.

Rewatch streamable data: A streamable data associated with replay sessions of prior events, including playback controls and synchronized session states.

Interactive streamable data: Interactive streamable data is the streamable data enhanced by a social interaction data (e.g., avatar presence, overlays, emoji reactions, chat, spatial audio) to represent a user engagement during an event.

Creator dashboard data: A user interface data transmitted to creators or event organizers, comprising engagement metrics, audience selections, and monetization options.

Viewer control data: Client-side selections for adjusting event playback, including audio language, camera angle, subtitles, or streaming quality.

Privileges data: A data describing access levels or entitlements of a plurality of clients to view specific events, validated by tokens.

Rendering capacity data: An information about computational and display capabilities of a client device, used to adapt codecs, bitrates, or level-of-detail parameters.

### Overview

The present disclosure describes a system and method for real-time, AI-based reconstruction and device-agnostic streaming of volumetric 3D video from heterogeneous inputs with integrated spatial co-viewing and interactive engagement features.

Further, the disclosed system is associated with GreenLight XR Media™.

Further, the present disclosure describes a system and method for capturing, reconstructing, and streaming volumetric 3D video content in real time using artificial intelligence (AI) and depth-aware computer vision techniques. The system enables heterogeneous video input sources, including stereo smartphones, 360° cameras, dual-lens webcams, and professional capture rigs, to feed into an AI-driven reconstruction pipeline that produces dynamic, free-viewpoint 3D scenes. The platform includes real-time encoding and compression, enabling device-agnostic streaming to smartphones, tablets, web browsers, smart TVs, and MR/VR headsets. An integrated interaction layer supports multi-user co-viewing, viewpoint control, video/voice/text overlays, and spatial annotations. The system also includes tools for content moderation, user privacy controls, and creator monetization via subscription, pay-per-view, or tiered access. The disclosed system advances immersive media delivery, democratizes volumetric content creation, and enhances social engagement in live and recorded 3D environments.

Further, the disclosed system relates generally to the field of immersive multimedia systems, and more specifically to systems and methods for capturing, reconstructing, encoding, and streaming volumetric 3D video content in real time, with integrated support for device-agnostic delivery and interactive multi-user engagement.

Further, traditional media platforms offer limited immersion, generally relying on fixed-camera, two-dimensional video streams that lack depth perception and real-time interactivity. While some advanced systems for 3D video capture exist, the advanced systems are often proprietary, hardware-dependent, costly, and inaccessible to general users or content creators. Furthermore, the mentioned solutions typically lack integrated support for live streaming, synchronized social interaction, and real-time user engagement features.

Further, volumetric video platforms to date have not adequately combined AI-based real-time reconstruction, heterogeneous device support, and social co-viewing into a unified, scalable system. Nor have the prior art systems integrated features critical for modern creators, such as spatial presence, viewpoint personalization, privacy control, content moderation, and monetization. Existing patents in related areas tend to cover individual components such as 3D reconstruction, video streaming, or interaction overlays, but not the cohesive end-to-end experience enabled by the disclosed system.

Further, the need for a flexible, scalable, and democratized platform that enables immersive, interactive, and socially connected 3D video viewing remains unmet. The disclosed system addresses the prior gap by combining AI-based scene reconstruction, low-latency encoding, device-agnostic delivery, and real-time user interaction into a comprehensive system for volumetric video communication and entertainment.

Further, the purpose of the disclosed system is to revolutionize how people experience and share live and recorded events by enabling immersive, real-time, device-agnostic 3D video streaming with social interaction. The present disclosure provides a system and method for capturing, processing, and streaming volumetric 3D video content in real-time, enabling immersive and device-agnostic viewing experiences with integrated social interaction. The disclosed system addresses the limitations of traditional 2D video platforms by delivering dynamic, free-viewpoint 3D scenes that may be experienced across a range of consumer and professional devices, including smartphones, tablets, mixed reality headsets, 3D displays, and standard web interfaces.

Further, the disclosed system enables both professional and user-generated content to be captured using heterogeneous input sources such as stereo smartphones, 360° cameras, and dual-lens webcams and get converted into spatial video streams enhanced with spatial audio, overlays, and real-time engagement tools. The platform associated with the disclosed system supports synchronous viewing among geographically dispersed users, allowing them to interact socially through shared environments, customized viewpoints, and multimedia overlays (e.g., selfies, comments, reactions).

Further, the disclosed system aims to democratize immersive media production, support hybrid live and asynchronous experiences, and revolutionize how people engage with events such as concerts, sports games, family gatherings, and creator-led streaming.

Further, the disclosed system aims to:
Transform passive viewing into shared immersive experiences

By allowing multiple users to co-watch events (e.g., concerts, sports games, family gatherings) in a volumetric 3D space, the platform fosters social presence, personalized viewpoints, and shared emotional engagement, regardless of physical location.
Deliver volumetric video over the internet to any device

The platform uses advanced compression, streaming protocols, and rendering techniques to enable smooth, real-time playback of reconstructed 3D video streams on a wide range of devices such as smartphones, laptops, VR/AR headsets, smart TVs, 3D projectors, and Room/Cave displays.
Empower creators with monetization and fan engagement tools

The disclosed system includes built-in support for creator dashboards, tiered access (free, subscription, PPV), live fan interaction tools, and analytics, making a new avenue for artists, performers, and influencers to grow the above mentioned people's audiences and generate income.
Support privacy, safety, and moderation in immersive environments

The platform integrates user-level control over visibility, audio/video masking, and AI-based content moderation, ensuring a safe and respectful environment for all participants.
Enable scalable deployment for diverse event types

The disclosed system is designed to support concerts, sports games, educational sessions, creator content, and personal family moments, with flexible ingestion pipelines, real-time processing, and integration with existing workflows.

Further, the disclosed system is built to be the next-generation media platform for co-present, immersive 3D video experiences, enhancing how people watch, share, and participate in live or on-demand events—anytime, anywhere, and with anyone.

Further, the disclosed system addresses several significant and persistent problems in the digital media landscape:
Passive and Isolated Streaming Experiences

Problem: Traditional video streaming platforms offer passive, 2D viewing that lacks social engagement. Viewers often watch alone and have no ability to co-experience the content in real time with others.

Solution: The disclosed system enables real-time spatial co-viewing in 3D environments where users may interact with each other, control the user's own camera angles, and experience the content together using spatial presence and reactions-bridging the social gap in digital media.
Lack of Device-Agnostic Immersive Media

Problem: Immersive media platforms (e.g., VR concerts or metaverse spaces) often require specialized hardware and are limited to siloed ecosystems, making the immersive media platforms inaccessible to mainstream audiences.

Solution: The disclosed system uses real-time compression, adaptive streaming, and modular rendering to deliver volumetric 3D video to a wide range of devices-including smartphones, laptops, TVs, VR/AR headsets, and 3D projectors-making immersive media broadly accessible.
Inaccessible Volumetric Video for Live Events

Problem: Volumetric video is traditionally reserved for expensive, offline use cases (e.g., Hollywood, museums, or military training), with high latency and poor scalability for live consumer-facing events.

Solution: The disclosed system provides a scalable, real-time pipeline for capturing, processing, and streaming volumetric video, enabling live concerts, sports events, creator shows, and family moments to be shared in immersive formats without post-production bottlenecks.
Limited Monetization and Fan Engagement for Creators

Problem: Content creators and performers face fragmented monetization tools and limited ways to engage fans in real time across platforms.

Solution: The platform offers an integrated creator monetization dashboard with options for pay-per-view, subscriptions, engagement metrics, and real-time audience interaction, therefore turning immersive streaming into a viable business model.
Inadequate Privacy and Moderation in Immersive Spaces

Problem: Emerging 3D and metaverse platforms have faced criticism for unsafe environments, harassment, and a lack of content moderation tools.

Solution: The disclosed system includes a built-in privacy and content moderation layer using AI-powered filtering, user-controlled visibility, and avatar/audio masking, ensuring secure and inclusive participation.
Fragmentation Between Live and On-Demand Experiences

Problem: Current platforms do not offer a seamless transition between live event participation and on-demand replay, especially in 3D or immersive formats.

Solution: The system supports synchronized timeline replay, allowing users to revisit or co-watch past events with friends as if live, preserving the social and spatial dynamics even in recorded content.

Further, the above mentioned features solve the core limitations of media platforms, transforming how people watch, interact with, and participate in digital content through immersive, social, and device-inclusive 3D streaming.

Further, the present disclosure provides a detailed description of how the disclosed system represents a significant improvement over existing technologies in the fields of video streaming, immersive media, and real-time communication:
From Passive Viewing to Immersive Co-Experiencing

Existing Technology: Traditional streaming platforms (e.g., YouTube™, Netflix™, ESPN+™, Twitch™) provide 2D video content with limited or no interactivity. While some traditional platforms allow for text-based chat (e.g., Twitch™), the traditional platforms lack spatial awareness, co-presence, and multi-user immersion. VR platforms (like Meta Horizon™ or Wave XR™) offer some immersive experiences but are hardware-restricted, siloed, or pre-rendered.

Improvement: The disclosed system enables true 3D co-viewing by reconstructing real-world events as volumetric video that may be explored in real time. Users share the same spatial scene with independent viewpoint control, video/voice/text overlays, and real-time reactions, simulating the feeling of physically attending events with friends-whether live or on-demand.
Real-Time, Device-Agnostic Volumetric Video Streaming

Existing Technology: Volumetric video technologies today (e.g., Microsoft Mixed Reality Capture™, Meta Codec Avatars™) are hardware-dependent, bandwidth-heavy, and not designed for real-time streaming. The volumetric video technologies are used primarily for offline production (e.g., game cutscenes or cinematic content), not scalable consumer media.

Improvement: The disclosed system introduces a compression and streaming subsystem that encodes reconstructed 3D video into efficient formats (e.g., MPEG-4, glTF, Draco) and streams the efficient format via adaptive protocols like WebRTC and HLS. The above mentioned enables low-latency, high-fidelity delivery of immersive 3D content across a broad spectrum of devices—from smartphones and laptops to VR/AR headsets and multi-projector rooms.
Integrated Monetization for 3D Content Creators

Existing Technology: Mainstream platforms (e.g., YouTube™, Instagram™, TikTok™) offer monetization, but only for 2D content and usually through ads, sponsorships, or limited tipping. Immersive platforms lack built-in creator tools for pricing tiers, fan data analytics, or event-based paywalls.

Improvement: The disclosed system features a Creator Monetization Dashboard where artists, athletes, influencers, and venues may set access tiers (free, subscription, pay-per-view), track real-time earnings, viewer count, and engagement, and manage payouts and event pricing. The above mentioned empowers creators to own and monetize immersive events directly, opening a new revenue channel in 3D streaming.
Built-In Privacy and Content Moderation Controls

Existing Technology: Most immersive platforms offer basic muting and blocking but lack advanced content moderation, especially in 3D or live environments. The above has led to widely reported harassment and safety issues in platforms like Meta Horizon™ or Rec Room™.

Improvement: The disclosed system includes a multi-layered privacy and moderation framework, featuring AI-based content filters (e.g., objectionable behavior or gestures), viewer-side masking and muting, and custom visibility settings for creators and participants. The above tools create a safe and respectful immersive environment, vital for families, educators, and professionals.
Intelligent Spatial Interaction and Replay

Existing Technology: Platforms like Zoom™, Discord™, or YouTube™ offer limited replay functionality and no spatial interactivity. VR events may record sessions, but without timeline synchronization or viewer control.

Improvement: The disclosed system supports synchronized 3D timeline replay, allowing users to rewatch past events with friends as if live, choose custom camera angles during replay, and interact with spatial chat and overlays even after the event. The above blurs the boundary between live and recorded content, turning every event into a reusable immersive asset.
Modular, Scalable Architecture for Diverse Use Cases

Existing Technology: Most immersive media systems are built for narrow use cases (e.g., games, training, and niche VR concerts) and are hard to adapt to general-purpose streaming or mixed audiences.

Improvement: The disclosed system is built as a modular platform with components for ingestion, encoding, multi-protocol streaming, rendering, interaction, and monetization. The above mentioned makes the system adaptable to live concerts, sports events, family celebrations, creator broadcasts, and educational sessions. The disclosed system's scalable architecture allows for broad deployment without needing specialized infrastructure at every site.

Further, the summary of improvements is tabulated as follows:

| Challenges in prior art | Improvements of the disclosed system |
|---|---|
| Passive, 2D experience | Immersive, multi-user 3D co-viewing |
| Limited device support | Real-time volumetric streaming to any |
| | device |
| No creator monetization | Built-in dashboard with tiered access |
| in immersive media | and analytics |
| Weak moderation tools | AI moderation + granular user privacy |
| | controls |
| No intelligent replay | Interactive 3D timeline co-watching |
| Narrow application scope | Scalable for sports, music, education, |
| | and family |

Further, the disclosed system brings together volumetric capture, immersive delivery, social interaction, and monetization tools into a single, accessible platform—offering a paradigm shift in how digital content is created, shared, and experienced.

Further, the individual and business demographics of the disclosed system are described in the present disclosure. The Ideal Customer Profile (ICP) for the disclosed system centers on stakeholders in the live-event streaming ecosystem, spanning from end-users to enterprise partners.

Further, the primary audience types for the disclosed system are as follows:
Immersive Sports & Concert Fans

Profile: Tech-savvy, engagement-driven individuals, sports enthusiasts, and music lovers who seek richer, more immersive content experiences.

Needs: Desire a front-row, 3D-like perspective of live events from home or on-the-go.

Pain Points: Traditional 2D broadcasts feel detached and passive; the customers crave real-time presence.
Event Organizers & Venues

Profile: Sports leagues, concert promoters, stadiums, and amphitheaters aiming to expand reach and innovate fan engagement.

Needs: Digital offerings that mimic real attendance, New revenue streams through virtual ticketing, sponsorship overlays, and enhanced monetization.

Pain Points: Saturated digital media landscape; challenge of innovating viewing experience to stand out.
Brands & Advertisers

Profile: Sports and entertainment brands looking to differentiate via next-gen advertising.

Needs: Immersive ad formats integrated into volumetric, social broadcast environments.

Pain Points: Standard ad units fail to captivate XR audiences; ROI on engagement is diminishing.
XR Tech Partners & Platform Integrators

Profile: Companies in AR/VR hardware, software developers, OTT providers, telecoms, and XR infrastructure providers.

Needs: Robust content pipelines to showcase XR capabilities and joint ventures in production, distribution, or platform integration.

Pain Points: Struggle to find compelling, large-scale use cases that justify XR adoption and investment.

Further, a customer is ideal due to the following aspects:
High engagement value: The customer places a premium on immersion and interaction.
Monetization potential: The customer incentivizes innovative ticketing, sponsorship, and ad formats.
Technical readiness: The customer has the infrastructure to support volumetric streaming and XR experiences.
Strategic alignment: The customer aims to lead rather than follow in the evolving digital event space.

Further, the ideal customer of the disclosed system is a forward-thinking participant in the live-event sphere, someone eager to blend cutting-edge immersive tech with monetization and engagement ambitions. Whether a sports league aiming to bring fans into the arena from the fans' couches, a stadium exploring virtual access, a brand seeking XR ad innovation, or a platform provider looking to anchor around volumetric streaming, all the above customers fit the bill.

Further, the disclosed system is a proprietary, AI-powered platform enabling real-time, device-agnostic streaming of volumetric 3D video with social co-viewing capabilities. The disclosed system transforms how audiences engage with live and recorded experiences by offering immersion, interactivity, and inclusivity across a range of contexts.

Further, the benefits of an end user are the following:
Immersive Access: Fans experience events as if they were present and able to view from any angle, zoom, or switch perspectives in real time.
Social Connection: Built-in watch parties let friends and family co-attend games and concerts virtually, with reactions, overlays, and commentary enhancing shared emotional presence.
Flexible Viewing: Device-agnostic playback across smartphones, VR headsets, smart TVs, and 3D displays ensures convenience anywhere.

Further, the benefits of the event organizers and venues are as follows:
Extended Reach: Sell digital seats to fans who may not be able to attend in person, creating new revenue streams without physical limitations.
Immersive Fan Engagement: Offer enhanced experiences—such as VIP 3D backstage passes or immersive replays—that differentiate the event organizer's brand.
Operational Efficiency: Low-intrusion multi-camera capture methods enable integration without disrupting live productions.

Further, the benefits of brands and advertisers are as follows:
Next-Gen Ad Formats: Integrate branded content and product placements into 3D scenes, interactive overlays, or virtual spaces, far beyond flat ad banners.
Engagement Metrics: Spatial engagement and shared experiences drive higher viewer attention and actionable data.
Targeted Immersion: Custom experiences based on viewer interests and behaviors deliver personalized brand storytelling.

Further, the benefits of XR Tech Partners and Platform Integrators are as follows:
Compelling Use Case: Provides a robust anchor application for XR ecosystems, with real-world demand across sports, music, and social domains.
Interoperability: Device-agnostic architecture and standards-based streaming (e.g., glTF, WebRTC, HLS) make integration seamless.
Accelerated Adoption: Enables hardware partners, ISPs, and 3D platforms to showcase XR capabilities in relatable, monetizable settings.

Further, the benefits of the video content creators are as follows:
Differentiation: Stand out in the creator economy with immersive, interactive 3D content that goes beyond prior art platform norms.
Revenue Tools: Access built-in monetization via ticketing, subscriptions, PPV events, and branded partnerships.
Creative Control: Intuitive tools to produce and edit volumetric content with personalized reactions, overlays, spatial audio, and more.

Further, the benefits of the Family Video Sharing Cohort are as follows:
Real Presence: Recreate family memories in rich, spatial formats that feel like “being there” again.
Social Viewing: Privately co-watch milestones like birthdays and recitals with loved ones across the globe-complete with reactions and messages.
Ease of Use: Simple capture from everyday devices, private sharing, and multi-device playback make the disclosed system accessible to all generations.

Further, the benefits of multiple features of the disclosed system are as follows:

| Features | Benefits |
|---|---|
| Real-time volumetric | Deepens emotional engagement and |
| streaming | immersion |
| Device-agnostic delivery | Maximizes accessibility and reach |
| Social co-viewing | Reinforces connection and shared |
| functionality | experience |
| Creator and fan | Enables sustainable value exchange |
| monetization tools | across the ecosystem |
| AI-powered capture & | Simplifies production and unlocks |
| rendering | content at scale |

Further, the invention provides a unified system and method for real-time volumetric 3D video streaming, enabling immersive media experiences using AI-based reconstruction and heterogeneous capture sources. Video content is acquired from a wide variety of input devices ranging from consumer-grade smartphones and webcams to professional volumetric rigs, and is processed through a machine learning pipeline that produces depth-aware 3D representations. The representations are compressed and encoded using low-latency formats compatible with modern streaming protocols, and then delivered to a range of end-user devices, including smartphones, tablets, head-mounted displays, and traditional web browsers. A spatial interaction layer supports real-time user engagement through features such as co-viewing, avatar representation, emoji reactions, text/video/voice overlays, and adjustable viewing perspectives.

Further, additional system components include synchronization mechanisms for multi-source capture, privacy settings for user control, automated moderation of user content, and tools that enable content creators to monetize the events through paywalls, subscriptions, or tiered access. The disclosed system also enables scalable deployment for a range of live and recorded events, including concerts, sports, education, and remote social gatherings.

Further, the disclosed system vertically integrates several technical subsystems into an end-to-end value chain:
Capture Subsystem: Accepts real-time and recorded input from a variety of consumer and professional devices. Metadata and timecodes are synchronized via a central coordination module.
AI Reconstruction Pipeline: Utilizes convolutional neural networks and depth estimation techniques to convert multi-view or stereo imagery into a unified 3D model, represented as point clouds, voxel grids, or textured meshes.
Compression and Encoding Module: Applies real-time compression using MPEG-4, glTF, or Draco, with adaptive bitrate encoding for optimal delivery across variable networks and device types.
Device-Agnostic Streaming Engine: Uses protocols such as WebRTC and HLS to support delivery to smartphones, tablets, web browsers, MR/VR headsets, and 3D-capable displays.
Interactive Engagement Layer: Includes real-time features such as avatar positioning, emoji overlays, camera angle control, spatial chat, and text/video annotations. Session data is synchronized across users to ensure cohesive social experiences.
Moderation and Privacy Controls: Implements rule-based and AI-enhanced moderation of user-generated content, as well as options for masking, muting, or selective visibility within shared sessions.
Monetization Dashboard: Allows content creators to configure access options (free, pay-per-view, subscription) and provides real-time analytics on engagement, earnings, and viewer behavior.

Further, the detailed integration enables both professional and user-generated volumetric content to be streamed, interacted with, and monetized in real-time immersive environments. The disclosed system enables real-time, device-agnostic volumetric 3D video streaming with integrated social interaction, a complex challenge requiring coordinated innovation across computer vision, machine learning, rendering systems, and immersive media design. The core technology supports both professional and user-generated content and is optimized for spatial audio and immersive interaction layers.

Further, the core platform capabilities of the disclosed system are:

i. Immersive 3D Event Capture
State-of-the-art multi-pod stereo, time-of-flight, and structured light camera arrays capture high-fidelity volumetric data in real-time, ensuring a lifelike representation of the event space.
Advanced depth-aware RGB-D and Near-Infrared (NIR) video streams work in concert to reconstruct spatial environments, people, and motion with unprecedented accuracy and detail.
The disclosed system democratizes immersive media by supporting both professional broadcasts and home video uploads. The versatility allows users to capture and share a wide range of events, from large-scale concerts to intimate family gatherings like birthdays, weddings, and recitals.
   ii. Real-Time 3D Generation & Rendering
A proprietary 3D Multiview Dynamic Reconstruction algorithm represents a significant leap forward in 3D scene generation. The sophisticated algorithms process dense point clouds to create temporally consistent 3D scenes, ensuring smooth and realistic visual experiences.
Leveraging the power of GPU acceleration, the disclosed system supports interactive, real-time 360° video playback. The above allows users to explore the event space freely, changing the user's perspective at will without experiencing lag or diminished quality.
Cutting-edge AI-powered mesh fusion, motion tracking, and scene understanding technologies work in harmony to deliver seamless realism. The above features enable the platform to accurately represent complex environments and dynamic movements, enhancing the overall immersive experience.
The spatial audio system goes beyond traditional stereo sound, synchronizing audio cues with user orientation to create a fully immersive soundscape. The above allows users to perceive sound directionality and distance, further enhancing the sense of presence within the virtual environment.
   iii. Adaptive 3D Streaming & Global Distribution
The disclosed system employs advanced compression techniques for both mesh and point cloud data, coupled with state-of-the-art encoding protocols (H.264/H.265 for video, Opus for audio). The mentioned approach significantly minimizes bandwidth demands without compromising on visual or audio quality, ensuring a smooth experience even on slower network connections.
The platform leverages real-time content delivery via global Content Delivery Networks (CDNs) and implements adaptive streaming technology (MPEG-DASH). The above combination ensures consistent, high-quality performance across a diverse range of networks and devices, from high-speed fiber connections to mobile data networks.
The platform provides extensive cross-platform support, which includes mobile devices, tablets, AR/VR headsets, smart displays, and room-scale XR setups. The versatility allows users to access immersive experiences through a preferred device, maximizing accessibility and user comfort.
   iv. Social Engagement Layer
The disclosed system revolutionizes the concept of remote viewing by allowing users to co-attend events in virtual shared spaces via “Watch Parties.” The above feature recreates the social aspect of attending events together, even when physically apart.
The platform facilitates rich interaction between viewers through a variety of channels, including spatial voice chat, text messaging, customizable emotes, real-time reactions, and live commentary. The above features combine to create a vibrant, engaging social atmosphere that mirrors the energy of in-person events.
Content creators, influencers, and families may host interactive, replayable events with custom social overlays. The above functionality opens new possibilities for engagement, allowing hosts to tailor the experience to the audience and create memorable, shareable moments.
Participants enjoy unprecedented control over the viewing experience. The participants may explore the event from any angle, zoom in on points of interest, and pause the action to savor key moments, or insert personalized highlights and statistics. The level of interactivity transforms passive viewers into active participants, deeply engaged with the content.
   v. Flexible Viewing Infrastructure
The disclosed system offers seamless integration with a wide array of XR devices, including but not limited to Meta Quest, Apple Vision Pro, and Microsoft HoloLens. The disclosed system also supports traditional viewing methods through Head-Mounted Displays (HMDs), smart glasses, tablets, and mobile phones, ensuring that users may access an immersive experience regardless of the preferred device.
Optimized rendering offload technology significantly reduces local device requirements, enhancing battery life while maintaining high framerates. The above approach allows the disclosed system to deliver high-quality experiences even on less powerful devices, broadening the potential user base.

Further, the platform provides comprehensive Software Development Kits (SDKs) and Application Programming Interfaces (APIs) for popular development environments such as Unity™, Unreal Engine™, Autodesk Maya™, and Blender™. The mentioned tools enable third-party content developers and visualizers to create and integrate custom content, further expanding the possibilities of our platform.

Further, the disclosed system is a full-stack redefinition of social media as a spatially shared experience. Unlike existing solutions that either (a) deliver passive immersive content or (b) enable isolated VR co-presence, the platform combines multi-source capture, dynamic 3D reconstruction, real-time rendering, and social engagement into one cohesive, scalable system.

Further, there is currently no widely available solution that enables:
Real-time 3D video streaming from both high-end and home-grade capture sources.
Cross-platform output compatibility, including non-immersive 2D viewing modes.
Synchronized, spatially-aware co-viewing experiences with real-time interaction.

Further, the above integration unlocks entirely new use cases for families attending a wedding remotely in 3D, fans watching a game from different cities but feeling as though the fans are sitting together, educators engaging remote classrooms through shared holographic presence, all without requiring specialized hardware.

Further, the disclosed system is not just a streaming platform; but the disclosed system is a next-generation social ecosystem designed to drive real-time connection, engagement, and creator-driven community experiences. The immersive social media layer transforms passive viewing into participatory entertainment, elevating user interaction through shared presence, expression, and contribution.

Further, users may co-attend live or on-demand events such as concerts, sports, family gatherings, and educational seminars in spatially rendered virtual environments that feel like private theaters or lounges. The above 3D spaces are customizable, enabling attendees to see, hear, and interact with one another in real time. Friends across the globe may feel like they are seated side-by-side, cheering, chatting, and celebrating together. Event organizers and influencers may host branded or themed watch parties to drive fan engagement and loyalty. Further, the system may include interactive reactions such as Video-Selfies, Emojis, Voice Chat, and AR Filters.

Further, the disclosed system may include a dynamic social tool as follows to mirror the expressiveness of in-person interaction:
Volumetric selfie-videos: Utilize stereoscopic cameras to overlay self onto shared space for all participants to see.
Spatial Voice Chat: Hear people around an individual as if the individual is truly nearby, with proximity-based audio positioning.
Emojis and Animated Reactions: React to moments with spatial presence and gesture-based responses that appear within the shared 3D space.
Augmented Reality Filters: Layer AR effects—team colors, face paint, fun effects—over avatars or surroundings to enhance personal expression and thematic immersion during events.

Further, the disclosed system empowers creators, streamers, and independent performers by enabling:
Upload of user-generated 360° and stereoscopic videos, which are automatically converted into immersive 3D experiences using a volumetric pipeline.
Creator storefronts with built-in monetization tools, including subscriptions, tips, and pay-per-event access.
Licensing of immersive content for replay in private or public social venues-turning creators into spatial broadcasters and enabling micro-entrepreneurship in immersive media.

Further, to increase stickiness and repeat engagement, the platform includes a robust gamification framework.
3D “Moments”: Capture and share volumetric highlights (e.g., reactions to game-winning plays or concert finales) with social networks as short immersive clips.
Participation Badges and Achievements: Earn recognitions for attending events, inviting friends, or creating content by helping build identity and reputation within the community.
Social Quests and Leaderboards: Join event-based challenges and co-op activities, compete for top spots, and unlock exclusive virtual goods and avatars.

Further, the above mentioned capabilities position the disclosed system not merely as a competitor in the streaming space, but as the vanguard of a new media era-one where immersive, emotionally connected, and socially interactive experiences are not add-ons, but the foundation. The above holistic integration of breakthrough technologies and human-centered design gives the disclosed system a clear runway to category leadership and long-term defensibility in a rapidly evolving digital landscape.

Further, the following are the aspects of the disclosed system for real-time generation and streaming of volumetric 3D video, the disclosed system comprising:
a capture module configured to receive video input from a plurality of heterogeneous sources, including at least one of: stereoscopic smartphones, dual-lens webcams, 360° cameras, or volumetric capture rigs.
a reconstruction engine comprising a machine learning model trained to generate depth-aware volumetric representations of dynamic scenes from said heterogeneous video inputs in real time.
a compression and encoding module configured to convert said volumetric representations into a streamable 3D media format optimized for low-latency transmission.
a device-agnostic streaming module configured to deliver the streamable 3D media to a plurality of client devices, including smartphones, tablets, head-mounted displays, web browsers, and smart TVs.
an interaction layer configured to enable spatial co-viewing by multiple users and support real-time engagement features, including user-controlled viewpoints, avatars, media overlays, and synchronized reactions.

Further, the present disclosure provides a method for capturing, reconstructing, and streaming volumetric 3D video with synchronized multi-user interaction:
receiving video data from a plurality of heterogeneous capture devices, including at least one of: a stereo smartphone, a 360° camera, or a volumetric rig.
reconstructing a dynamic 3D scene using a real-time AI-based reconstruction pipeline that generates depth-aware representations of the scene.
encoding the reconstructed 3D content into a streamable format for delivery across multiple device types.
streaming the encoded 3D content to a plurality of end-user devices using a device-agnostic transport protocol.
enabling users to participate in a shared co-viewing session that supports spatial navigation, multimedia annotations, avatar presence, and interactive gestures.

Further, the reconstruction engine utilizes a convolutional neural network (CNN) trained on multimodal RGB-D datasets to predict geometry and motion. Further, the reconstruction engine fuses multiple video streams using spatial calibration and frame timecode alignment.

Further, the volumetric 3D content comprises one or more of: point clouds, mesh surfaces, or voxel representations.

Further, the encoding module supports compression formats selected from the group consisting of MPEG-4, glTF, Draco, and custom point cloud codecs.

Further, the streaming module uses adaptive bitrate streaming based on real-time bandwidth estimation at the client end.

Further, the interaction layer enables viewers to embed spatial tags, selfie video reactions, and emoji animations into the scene. Further, the interaction layer includes spatial positioning and head tracking support for immersive MR/VR rendering.

Further, the reconstruction pipeline includes machine learning-based depth estimation and multi-view stereo fusion.

Further, the disclosed system dynamically adjusts encoding parameters based on client device rendering capacity.

Further, the spatial co-viewing includes synchronized perspective updates, timecode alignment, and shared session state.

Further, the client devices render the 3D video using WebGL, Unity3D, or native mobile 3D engines.

Further, the disclosed system comprises a feedback analytics module configured to collect user engagement data, including dwell time, interaction frequency, and avatar movement patterns.

Further, the method included in the present disclosure comprises a step of moderating user-generated overlays using a combination of keyword filtering, community reporting, and AI-based content analysis.

Further, the capture module is configured to accept real-time streams and asynchronous uploads from consumer devices.

Further, the streaming module further supports playback rewind, time-jumping, and asynchronous co-viewing modes.

Further, the shared co-viewing session includes user identity tokens, encrypted communication, and session persistence features.

Further, the interaction layer provides gesture-based control, enabling users to navigate the 3D scene via swipes, pinch gestures, or head tilts.

Further, the volumetric video sessions are stored for later access and replay with full interactivity preserved.

Further, the synchronization module is configured to maintain temporal and spatial consistency between multiple input streams using timecode alignment, frame interpolation, and sensor fusion.

Further, the shared co-viewing session is synchronized using a master time signal broadcast to all participating client devices to ensure consistent viewpoint transitions and event progression.

Further, the interaction layer includes user-selectable privacy controls allowing individuals to mask avatars, limit location visibility, restrict communication channels, and opt out of engagement features.

Further, the method described in the present disclosure may include a step of applying privacy-preserving techniques to anonymize user interaction data using pseudonymization, obfuscation, or client-side aggregation prior to analytics processing.

Further, the interaction layer includes an AI-based content moderation engine configured to detect and suppress inappropriate overlays, messages, or avatars in real time using natural language processing and image recognition.

Further, the disclosed system may include a multi-layered moderation module for automated filtering, community flagging, and manual review for all user-generated multimedia annotations.

Further, the disclosed system may include a monetization module configured to enable content creators to define access tiers, charge pay-per-view or subscription fees, and receive micropayments based on real-time engagement metrics and viewership data. Further, the creators are provided with a dashboard displaying live engagement analytics, revenue breakdowns, and content performance across various events and user segments.

Further, the disclosed system operationalizes the following live video streaming process:
Capturing live events in 360-degree 3D, encompassing people and objects in motion, ambient light, and spatial sound in real-time.
Merging moving images and scenes into a 3D volume.
Rendering 360-degree 3D images in motion to all compatible XR devices.
Creating a seamless 3D video stream.
Transmitting and distributing the content via the Internet.
Enabling the social engagement layer for spatial co-watching.

Further, the disclosed system comprises the following components:
Active depth Red=Blue-Green Stereo Cameras
Near Infrared (NIR) Cameras
Stereoscopic smartphone cameras
External triggers for cameras
Central Processing Units (CPU)
Graphical Processing Units (GPU)
Spatial Microphones
Audio Mixing Console
Video Production Console
Image Rendering software
Video codecs
Audio codecs
Content Delivery Networks (CDNs)
Streaming video display devices

Further, the disclosed system comprises:

Active depth Red-Blue-Green Stereo Cameras: an array of active 3D stereo Red-Blue-Green cameras to capture a scene from multiple viewpoints.
Near Infrared (NIR) Cameras, which enhance depth perception and image quality in low-light conditions.
Stereoscopic smartphone cameras enable families and video content creators to upload creations.
External triggers for camera synchronization at high frame rates.
High-end Central Processing Units (CPUs) specifically optimized for video processing, working in tandem with GPUs.
High-end Graphical Processing Units (GPUs), such as the NVIDIA™ Titan X, are crucial for real-time video processing and rendering.
Spatial microphones to ensure spatial consistency.
Audio Mixing Console to synchronize both scene audio and ambient audio.
Event production console to manage and coordinate the production and streaming process.
Image Rendering software that transforms the captured 3-D footage into a format suitable for display devices.
Video codecs for the efficient encoding, decoding, and compression of video files.
Audio codecs for the efficient encoding, decoding, and compression of audio files.
Robust content distribution network (CDN) that ensures fast and reliable delivery of live streams.
Display devices for video viewing, including tabletop displays, and room/cave displays-integrated with platform elements through device-native SDKs (software development kits).

Further, the camera pods consisting of active Red-Blue-Green depth cameras and Near Infrared cameras capture live scenes from multiple angles, and transmit the images frame-by-frame to the Production Console. (Stereoscopic smartphone cameras and webcams may be used to upload amateur videos to the platform for sharing.) The cameras are intrinsically and externally synced using triggers to maintain image consistency.

Further, the producer, using the Production Console, selects the scenes and images to be streamed. The video frames selected by the production console are sent to a group of dedicated CPUs for image processing and color texturing.

Further, the CPUs transmit the two-dimensional video frames to two or more Graphical Processing Units, which then perform rapid image reconstructions to three-dimensional volume format.

Further, the directional microphones transmit the main and ambient sounds in a separate stream through the audio mixer. The output from the GPU processing is then synthesized with the spatial audio on high-end CPUs for rendering.

Further, the Rendering software is utilized to add the capability to integrate with commercially available display devices, adapting to the native bitrates of these devices. The devices include wearables such as glasses and head-mounted devices, smartphones, room-size and tabletop displays, and 3D projectors.

Further, the video and audio outputs from the synthesizing and rendering CPUs are then encoded and compressed using industry-standard video/audio codecs to produce video streams for transmission.

Further, the output streams are then distributed over the internet through Content Delivery Networks (CDNs), which are then accessed by the preferred display devices used by audiences.

Further, the disclosed system is a comprehensive, end-to-end solution that revolutionizes the way live events are experienced. The state-of-the-art technology stack enables individuals to capture live scenes with unprecedented detail, reconstruct intricate 3D moving images, convert seamlessly to video and audio streaming protocols, distribute efficiently through robust content delivery networks, and provide breathtaking 3D live displays on a wide range of commercially available devices.

Further, the disclosed system comprises the following key technical elements working together to deliver an unparalleled viewing experience:
An advanced array of active 3D stereo depth cameras for real-time, high-quality capture. The cutting-edge cameras ensure that every nuance, every movement, and every detail of the live event is captured with extraordinary precision, allowing viewers to feel as if the viewers are physically present at the venue.
A state-of-the-art Graphics Processing Unit (GPU) setup optimized for rapid 3D image and motion processing. The GPU guarantees smooth and seamless playback for viewers, handling complex visual data with ease and efficiency.
Innovative point-cloud fusion approaches for 3D reconstruction enable the creation of incredibly realistic and immersive visual experiences, transforming raw data into vivid, three-dimensional environments that viewers may explore and interact with.
Advanced spatial audio technology that accurately captures and reproduces user position and orientation. The above feature significantly enhances the overall immersive experience for the audience, providing a soundscape that adapts and responds to the viewer's perspective within the virtual environment.
Cutting-edge compression and transmission techniques engineered to ensure low-latency, high-quality distribution. The above mentioned technologies work in concert to deliver real-time content to the audience without compromise, maintaining the integrity of the visual and audio experience even across vast distances and varying network conditions.
Seamless integration capabilities with a wide range of rapidly emerging video display devices. The above flexibility makes the service accessible to a broad spectrum of users, ensuring compatibility with everything from high-end VR headsets to mainstream smartphones and tablets.

Further, by leveraging the advanced technologies, the disclosed system is not just streaming events, the disclosed system is transporting viewers into the heart of the action, creating unforgettable experiences that blur the lines between physical and virtual presence. As the disclosed system continues to push the boundaries of what's possible in live-event streaming, the disclosed system remains committed to innovation, quality, and the relentless pursuit of the ultimate immersive experience. The technology isn't just changing how people watch live events, the technology is revolutionizing how audiences experience the technology.

Further, the disclosed system comprises a capture and production layer. The capture and production layer may include a capture equipment to capture and produce immersive live events for the sports and entertainment industry. The state-of-the-art equipment ensures the highest quality content for the streaming media service. The following components form the backbone of the capture capabilities of the capture and production layer:
Depth Cameras and Sensors: The capture stack employs advanced depth-sensing cameras, including LiDAR (Light Detection and Ranging), NIR (Near-Infra Red), and ToF (Time of Flight) systems, alongside high-resolution RGB cameras. The above combination allows the layer to capture intricate details of the environment, creating a rich, three-dimensional representation of the event space. The sensors work in tandem to provide accurate depth information, enabling realistic AR overlays and immersive VR experiences.
360° and 180° VR Cameras: The stack includes top-of-the-line virtual reality cameras such as the Insta360 Titan™, Kandao Obsidian™, and Z CAM V1 Pro™. The cameras capture ultra-high-definition 360-degree and 180-degree videos, providing viewers with a fully immersive experience. The multi-lens setups on the cameras ensure seamless stitching and minimal distortion, resulting in breathtaking panoramic visuals that transport viewers directly into the heart of the action.
Volumetric Capture Rigs: For premium experiences, the capture stack offers volumetric capture capabilities using systems like 8i™ and Microsoft Mixed Reality Capture™. The sophisticated rigs allow the disclosed system to create full 3D visuals of performers or players, adding an unprecedented level of realism to virtual experiences. Volumetric capture enables viewers to move around and interact with digitally recreated performers, blurring the line between the physical and virtual worlds.
Drones & Cable Cams: To provide dynamic AR overlays and unique camera angles, the capture stack enables state-of-the-art drones and cable camera systems. The mobile platforms allow the disclosed system to capture sweeping aerial shots, follow fast-moving subjects, and provide perspectives that were previously impossible to achieve. The flexibility of the disclosed system enables the platform to create more engaging and varied content, enhancing the overall viewing experience.
The camera pods are well-calibrated and synchronized for background segmentation and consistency across all cameras, using state-of-the-art stereo matching techniques. The calibration steps also ensure homogeneous and consistent color information among the cameras. All the cameras in the array are synchronized through the use of external triggers, such that consistent scene images are captured and processed.
Ambisonic Microphones/Binaural Audio: Audio is a crucial component of any immersive experience. The platform uses high-end spatial audio capture systems, such as the Senheiser AMBEO V Mic™, to record and reproduce sound with pinpoint accuracy. The ambisonic microphones capture audio from all directions, allowing the platform to create a three-dimensional soundscape. The technology ensures that the audio perfectly complements the visual experience, providing a truly immersive environment for audiences.

Further, the disclosed system may include live production tools to bring the captured content to life in real-time. The cutting-edge software solutions enable the disclosed system to deliver high-quality, interactive experiences to the viewers:
Live Switchers: The disclosed system utilizes powerful live production software such as vMix™, Vizrt™, and Unreal Engine™-based compositors. The live production software allows the production team to seamlessly switch between multiple camera feeds, add real-time graphics and overlays, and create compelling visual compositions on the fly. The flexibility of the disclosed system enables the disclosed system to adapt quickly to the dynamic nature of live events, ensuring that viewers always have access to the most engaging and relevant content.
Real-time Stitching Software: To create seamless 360-degree video experiences, the platform employs state-of-the-art stitching software like Mistika VR™, VideoStitich™, and LiveSphere™. The stitching software processes the output from multi-camera setups in real-time, blending the separate video streams into a single cohesive 360-degree panorama. The technology enables smooth, high-quality content with minimal latency, enhancing the immersive experience for viewers.

Live Encoding/Streaming: At the heart of the streaming infrastructure are robust encoding and streaming solutions. The GPU-accelerated systems ensure that high-quality video streams are efficiently compressed and delivered to viewers with minimal delay. The use of cloud-based solutions like AWS Elemental MediaLive™ allows for scaling the streaming capacity dynamically, ensuring smooth performance even during peak viewership periods. By combining the above advanced capture and production tools, the disclosed system is able to create unparalleled immersive experiences for sports and entertainment events. The technology stack enables the disclosed system to push the boundaries of what's possible in live event streaming, offering the audience a truly next-generation viewing experience.

Further, the disclosed system performs depth estimation by generating a spatial mesh that scans the physical images as a dense 3D point cloud. The disclosed system employs proprietary 3D Multiview Dynamic Image Reconstruction algorithms, incorporating AI/ML for scene understanding and reconstruction. Elements of the approach include:
Temporally Consistent 3D Reconstruction: The algorithm employs state-of-the-art method for generating temporally consistent 3D models in real-time. The method tracks the spatial mesh and fuses the data across cameras and frames.
In addition, the disclosed system incorporates Consistent Online Dynamic Depth algorithms for seamless per-frame stereo, motion, and fusion networks.
After fusing depth data, the disclosed system adds color and texture to the images from the input RGB images.
The disclosed system synthesizes each remote audio source to ensure that the audio and visual cues are matched for proper location and orientation.
The disclosed system incorporates AI and machine learning algorithms for scene understanding and reconstruction, to enhance depth estimation and texturing during image processing, resulting in high-quality, high-resolution outputs.
The disclosed system includes a technical architecture utilizing multiple GPUs (Graphical Processing Units) across multiple machines to achieve real-time performance. The camera pods provide input to high-end PCs that compute depth and foreground segmentation, which are then transmitted to high-performance GPUs for fusion into 3D video formats. The tasks are highly parallelizable and therefore are implemented on a multiple-GPU architecture for speed.
The depth maps and segmentation masks from all the PCs and GPUs are collected and synthesized on a master PC.

Further, the disclosed system includes a server infrastructure, wherein the server infrastructure may include the following components:
High-Performance Servers: The servers are crucial for handling the complex tasks of real-time video encoding, rendering, and streaming. The disclosed system utilizes cloud-based solutions like Amazon Web Services™ (AWS) or Google Cloud Platform™ (GCP) to ensure scalability and reliability.
GPU Accelerators: Graphics Processing Units (GPUs) are vital for real-time AR rendering and machine learning tasks. The disclosed system employs NVIDIA Tesla™ or AMD Radeon Instinct™ GPUs to accelerate computationally intensive processes, ensuring smooth and responsive AR experiences.

Further, the XR Development Tools include the following Programming Languages:
C#, C++, or Python: The languages form the backbone of AR applications and backend development. C# is commonly used with Unity™, C++ with Unreal Engine™, and Python for backend services and machine learning algorithms.
JavaScript (Three.js): The versatile language, particularly when used with the Three.js library, is ideal for creating web-based AR experiences. The language allows for the development of cross-platform AR applications that may run directly in web browsers.

Further, the AR Model Creation Tools include the following components:
3D Modeling Software: Industry-standard tools like Blender (open-source), Autodesk Maya, or 3ds Max™ are essential for designing and creating high-quality 3D assets. The powerful applications allow for the creation of detailed models, textures, and animations that form the visual foundation of the disclosed system's AR experiences.
Photogrammetry Software: Tools like Agisoft Metashape™ or RealityCapture™ enable the creation of highly accurate 3D models from real-world scans. The technology is crucial for generating realistic digital twins of physical objects or environments.
AI/ML Models: The implemented cutting-edge artificial intelligence and machine learning models for advanced features such as object detection, gesture recognition, and scene understanding. The models enhance the interactivity and responsiveness of the disclosed system's AR experiences.
SLAM (Simultaneous Localization and Mapping): The technology is vital for the precise placement of AR objects in the environment. The disclosed system utilizes frameworks like ARCore (for Android) or ARKit (for iOS) to implement SLAM capabilities, ensuring that virtual objects appear convincingly anchored in the real world.
Multi-View Stereo (MVS): To generate accurate depth maps for each frame, the disclosed system employs the following:
   Open VMS/OpenVMS: The mentioned open-source structure-from-motion and dense reconstruction pipeline offers a flexible and customizable solution for 3D reconstruction.
   NVIDIA Kaolin: A PyTorch library for 3D deep learning, which provides state-of-the-art algorithms for 3D reconstruction and rendering.
   Alternative Methods: Cutting-edge techniques like Neural Radiance Fields (NeRF) and Instant Neural Graphics Primitives (instant-ngp) for even more realistic and efficient 3D reconstructions. The methods offer the potential for higher quality results with less computational overhead.
   COLMAP: The comprehensive Structure-from-Motion (SfM) and Multi-View Stereo (MVS) pipeline is instrumental in processing large sets of images to create accurate 3D reconstructions of complex scenes or objects.
   Collaborative Platforms: Platforms like Niantic's Lightship™ are utilized for creating multi-user experiences. The tools enable the development of shared environments where multiple users may interact with the same virtual objects in real-time, enhancing the social and collaborative aspects of the disclosed system.

Further, to accomplish the crucial success elements of live 3D video streaming, the platform meets demanding standards for reconstruction, streaming speeds, and the visual quality of the obtained scenes:
The video stream from the capture stage and the fusion stage goes through compression and encoding for transfer over wide-area networks with low latency rates.
Signal from the live scene is acquired through satellite uplinking and downlinking, or via connectivity at the event location if the content is being encoded on-site from the venue.
In addition, the disclosed system utilizes standard international codecs for audio and video sharing, to ensure high-quality video/audio with the lowest bitrates:
   Skype™ Audio Codecs: G.729, SVOPC, SILK, and Opus, for low-latency transforms and high-definition quality audio transmission.
   YouTube™ H.264/MPEG-4 Part 10 AVC Advanced Video Coding.
   MPEG-DASH (Dynamic Adaptive Streaming over HTTP), which modulates streaming quality based on network conditions, HLS (HTTPS Live Streaming), RTMP (Real Time Messaging Protocol), RTSP (Real Time Streaming Protocol).
   The platform incorporates various encoding profiles available in the H.264/H.265 family of standards: MVC Multiview Video Coding profiles, SHP Stereo High Profile for stereoscopic 3D video, MHP Multiview High Profile, MDHP Multiview Depth High Profile, and H.265/MPEG-H Part 2 HEVC High Efficiency Video Coding.

Further, the disclosed system licenses the necessary codecs associated with encoding profiles based on the compression and transmission requirements of the disclosed system. The patents of the encoding profiles are owned by many providers and administered by MPEG LA™.

Further, the server-side streaming infrastructure comprises the following:
Media Servers: The disclosed system utilizes advanced media servers such as Wowza™, Red5™, or custom-built solutions using WebRTC media servers. The servers form the backbone of the streaming infrastructure, ensuring smooth and reliable content delivery to our users.
Edge Servers/CDNs: To achieve low-latency content delivery, the disclosed system implements a robust network of edge servers and Content Delivery Networks (CDNs). The primary choice of the disclosed system is AWS CloudFront™ known for global reach and high performance.
Edge Nodes: To further enhance the experiences, the disclosed system deploys edge nodes strategically near users' locations. The nodes handle low-latency processing, significantly reducing delay and improving the overall immersive experience.
Encoding Machines: The disclosed system incorporates high-performance servers equipped with GPU acceleration capabilities. The specialized machines handle real-time encoding tasks, ensuring that the live streams are processed and delivered with minimal delay.

Further, the video streaming and encoding components of the disclosed system are as follows:
FFmpeg and GStreamer: The powerful, open-source multimedia frameworks are at the core of the video processing and encoding pipeline. FFmpeg's versatility and GStreamer's modular architecture allow the disclosed system to handle a wide range of video formats and implement complex processing workflows.
Low-Latency Streaming Protocols: For interactive streams, such as front-row concert seats, the disclosed system implements WebRTC, RTMP, or HLS protocols. The technologies enable near real-time communication, crucial for maintaining the immediacy of live events.
MPEG-DASH+CMAF: To deliver high-quality 4K/8K 360° content, the disclosed system utilizes MPEG-DASH (Dynamic Adaptive Streaming over HTTP) in combination with CMAF (Common Media Application Format). The pairing allows for adaptive bitrate streaming, ensuring optimal viewing experiences across various network conditions and devices.
HLS (fallback): To ensure broader device compatibility, the disclosed system implements HTTP Live Streaming (HLS) as a fallback option. The above mentioned widely supported protocol helps the disclosed system to reach users on older devices or in regions with limited technology adoption.
360° Video Players: The platform features custom-built 360° video players, enhanced with open-source solutions like A-Frame and Video.js with specialized plugins. The players offer intuitive controls and smooth playback for the immersive content.
3D and Volumetric Video Formats: To support cutting-edge XR experiences, the disclosed system implements several advanced formats:
   glTF (GL Transmission Format): The GL Transmission Format, optimized for real-time 3D applications, is used for efficient delivery of 3D assets.
   MPEG V3C (Volumetric Video Coding): As the industry standard for volumetric video, V3C enables the disclosed system to deliver high-quality, three-dimensional representations of live performances and events.
   MPEG PCC (Point Cloud Compression): The technology allows the disclosed system to efficiently compress and transmit point cloud data, crucial for certain types of 3D content.
   H.265 (HEVC): The technology utilizes high-efficiency video encoding standard for compressing RGB-D (color and depth) data, essential for creating realistic 3D environments.
   Draco: Google™ 's 3D mesh compression library is implemented to optimize the delivery of complex 3D models and scenes.
   AWS Elemental Suite™: To leverage the power of cloud-based encoding and streaming, the disclosed system integrates the services. The suite of services includes AWS™ MediaConvert for file-based video transcoding, AWS™ MediaLive for live video processing and encoding, AWS™ MediaPackage for video origination and packaging, AWS™ MediaStore for media-optimized storage and delivery.

Further, the disclosed system may include one or more XR SDKs and APIs such as the following:
OpenXR: As a cornerstone of the development strategy, the disclosed system adopts OpenXR, a unified API standard that ensures broad VR/AR hardware compatibility. The OpenXR allows users to create experiences that work seamlessly across multiple XR platforms.
Mobile AR Development: To cater to the growing mobile AR market, the disclosed system integrates both ARKit (Apple) and ARCore (Google) into the development pipeline. The powerful SDKs enable the disclosed system to create compelling AR experiences for iOS and Android devices, respectively.
XR Headset Compatibility: To ensure the content is accessible on major XR platforms, the disclosed system implements the Oculus™ SDK, SteamVR™, and Viveport™ SDK. The multi-platform approach maximizes the potential audience and provides flexibility for users with different hardware preferences.
Vuforia™: For advanced object tracking and overlay capabilities, the disclosed systems incorporate Vuforia™ into the toolkit. The powerful engine enables the disclosed system to create more interactive and context-aware experiences, enhancing the overall user engagement.

Further, the content management system of the disclosed system is tailored to manage XR assets and associated metadata. The system streamlines the content pipeline, allowing for efficient organization, updating, and deployment of XR experiences.

Further, the backend servers of the disclosed system are built using a combination of technologies to ensure optimal performance and scalability as follows:
Node.js: For handling real-time communications and high-concurrency tasks.
Python (Flask/Django): For robust API development and data processing.
Go: For high-performance microservices and system-level operations.
Databases: To manage the complex data requirements of the XR platform, the disclosed system employs a multi-database strategy.
MongoDB: For flexible, document-based storage of user profiles and content metadata.
PostgreSQL: For structured data and complex queries related to analytics and reporting.
Firebase: For real-time data synchronization and offline support in mobile applications. The above approach ensures efficient data management, quick retrieval, and seamless synchronization across the platform.

Further, the content delivery associated with the disclosed system is as follows:
Edge-based CDN: To ensure rapid content delivery and minimize latency, the disclosed system implements a robust edge-based Content Delivery Network. The primary options of the disclosed system are as follows:
   AWS CloudFront™: Leveraging a global network of edge locations and integration with other AWS™ services.
   Cloudflare Stream™: Utilizing an optimized video delivery and processing capabilities of Cloudflare Stream™.
   Fastly™: Taking advantage of the powerful edge computing features of Fastly™, the chosen CDN solution provides:
      Multi-bitrate XR video delivery, adapting to various network conditions and device capabilities.
      Edge compute functionality for dynamic overlays, enabling real-time integration of statistics, live chat, and other interactive elements.
Multi-CDN Strategy: To ensure global reach and maintain redundancy, especially crucial for serving sports fans worldwide, the disclosed system implements a multi-CDN approach. The strategy involves:
   Load balancing across multiple CDN providers.
   Intelligent routing based on performance metrics and geographical factors.
   Failover mechanisms to ensure uninterrupted service in case of regional outages

Further, the disclosed system may include low-latency protocols as follows:
WebRTC (Web Real-Time Communication): The protocol is a primary choice for real-time, interactive streaming scenarios such as live concerts and virtual meetings. WebRTC offers several advantages:
   Sub-second latency, crucial for maintaining the “live” feel of events.
   Built-in support for peer-to-peer connections reduces server load.
   Native implementation in modern web browsers eliminates the need for plugins.
UDP-based Protocols: To complement WebRTC and ensure the quickest possible data transmission, the disclosed system also implements custom UDP (User Datagram Protocol) based solutions. The UDP is particularly useful for:
   Transmitting time-sensitive data such as user interactions or positional updates in VR environments.
   Reducing overhead in scenarios where perfect reliability is less critical than speed.
   Implementing proprietary optimizations for specific use cases.

Further, the disclosed system may include a high bandwidth & low latency technology as follows:
5G and Wi-Fi 6/6E: To support the high-bandwidth, low-latency requirements of XR streaming, the disclosed system optimizes the platform for next-generation wireless technologies.
5G: Leveraging ultra-low latency and high-speed capabilities for mobile XR experiences.
Wi-Fi 6/6E: Utilizing the increased bandwidth and reduced interference for home-based XR streaming.
The disclosed system is designed to automatically detect and take advantage of the technologies when available, while still providing optimized experiences on older networks.
Fiber-Optic Connections: For production facilities and server-side infrastructure, the disclosed system prioritizes high-speed fiber-optic connections. The above ensures:
   Minimal latency in content ingestion and processing.
   High-bandwidth capacity for handling multiple simultaneous streams.
   Reliable, consistent performance for mission-critical operations

Further, the disclosed may integrate with CDN Integration:
Edge Computing Capabilities: The CDN integration goes beyond simple content caching, incorporating advanced edge computing features:
   Real-time content transformation and optimization at the edge.
   Dynamic ad insertion and personalization.
   Localized content processing to reduce the main server load.
Global Scalability: The CDN strategy is designed for rapid global scaling, allowing the disclosed system to:
   Expand into new markets with minimal infrastructure investment.
   Handle sudden spikes in traffic, such as during major sporting events.
   Maintain consistent performance across diverse geographical regions.
AWS™ (Amazon Web Services): As a primary cloud service provider, AWS™ forms the backbone of the disclosed system's infrastructure. The disclosed system leverages various AWS™ services to ensure scalability, reliability, and performance:
   AWS™ MediaLive: For high-quality live video processing and encoding.
   AWS™ S3: For scalable object storage of media assets and user-generated content.
   AWS™ EC2: For flexible compute resources, allowing us to scale our processing power as needed.
   AWS™ Lambda: For serverless computing, enabling efficient execution of code in response to events.
   Amazon™ SageMaker: For implementing machine learning models to enhance user experiences and content recommendations.

Further, the disclosed system may integrate with cloud services to ensure scalability, reliability, and performance. By leveraging advanced technologies and strategies, the disclosed system is well-positioned to deliver cutting-edge XR experiences for live sports and entertainment events, ensuring high-quality, low-latency streaming to users worldwide.

Further, the disclosed system may include an XR Experience Layer (User Devices), wherein the XR Experience Layer includes a set of supported devices. The disclosed system is designed to be compatible with a wide range of extended reality (XR) devices through device-native SDKs (Software Development Kits), ensuring that users may access immersive live-event streaming experiences through various technological mediums. The supported devices include:
VR Headsets: The disclosed system offers full support for cutting-edge virtual reality headsets, including the Meta™ quest 3, which provides a standalone, high-resolution experience. Additionally, the disclosed system caters to PC-tethered devices such as the HTC™ Vive and Valve™ Index, known for superior tracking and visual fidelity. For console users, the disclosed system ensures compatibility with the PlayStation™ VR, bringing immersive content to the living room gaming setup.
AR Glasses/Headsets: The disclosed system embraces augmented reality technologies, supporting devices like the Microsoft™ HoloLens and Magic Leap™. The AR headsets overlay digital content onto the real world, creating a mixed reality experience.
PCs/Consoles: For users preferring a more traditional setup, the disclosed system is optimized for high-performance PCs and gaming consoles. The above includes support for the latest graphics processing units (GPUs) such as NVIDIA™ RTX and AMD™ Radeon Series, ensuring smooth, high-fidelity tethered experiences that may rival standalone headsets in visual quality.
Mobile Devices: Recognizing the ubiquity of smartphones and tablets, the disclosed system provides robust mobile support. The disclosed system platform leverages ARKit for iOS devices and ARCore for Android, allowing users to enjoy augmented reality experiences through personal devices. The mobile integration ensures that the content is accessible to a broad audience, even without specialized XR hardware.
Smart TVs & PCs: For a relaxed viewing experience, the disclosed system offers a flat 360° viewing mode compatible with smart TVs and standard PCs. The mentioned viewing mode allows users to navigate immersive environments using a mouse or remote control, providing a taste of XR content without the need for a headset.
Rooms and Caves Displays: The disclosed system pushes the boundaries of immersive experiences by supporting projection-based systems that do not require wearable devices. The disclosed system is compatible with products of industry leaders such as Musion™, IglooVision™, Barco™, and innovative startups like TiltFive™ and LookingGlass™ to create stunning, shared XR experiences in physical spaces
3D Projectors: To cater to users seeking a more traditional yet immersive home theater experience, the disclosed system ensures compatibility with popular 3D projectors. Models such as the Optoma™ HD142X, BenQ™ TK800, and Epson™ Home Cinema 2040 may be used to create large-scale 3D viewing experiences, bridging the gap between conventional and XR content consumption.
Hologram Tabletops: Pushing the envelope of futuristic viewing experiences, the disclosed system supports various hologram table technologies. The innovative devices including offerings from Weisman Worldwide™, Voxon™, and Axiom Holographics™, project three-dimensional objects that appear to rise up to a meter from the table surface, creating a unique and engaging way to interact with the content.

Further, the disclosed system may include custom-built XR applications. The applications are the gateway through which user's access immersive live-event streaming experiences. Further, the development tools used to ensure optimal performance, scalability, and compatibility across all supported devices of the disclosed system are as follows:
Unity™: The disclosed system's primary development engine for mobile, standalone, and headset applications. The tool's versatility allows the disclosed system to create high-quality, performant experiences that may be easily deployed across multiple platforms. The tool's robust feature set and extensive asset store enable developers of the disclosed system to rapidly prototype and implement new features.
WebXR™: To provide seamless browser-based experiences, the disclosed system leverages WebXR™ technology. The tool allows users to access a content of the platform directly through the user's web browsers without the need for separate app installations, reducing friction and increasing accessibility.
Unreal Engine™: For most visually demanding content, particularly ultra-high fidelity concert experiences, the disclosed system utilizes Unreal Engine™. The tool's advanced rendering capabilities and powerful real-time graphics allow for creation of stunningly realistic virtual environments that push the boundaries of what's possible in live-event streaming.

Further, the disclosed system is packed with innovative features designed to enhance the user experience and create truly immersive live events. The key features include:
Multiple Camera POVs with 360° Switching: Users may seamlessly switch between various camera angles and enjoy full 360-degree views of the event. The mentioned feature allows for a personalized viewing experience, letting users choose a preferred perspective or explore the entire venue at will.
AR Overlays: The disclosed system enhances the viewing experience with augmented reality overlays that provide additional context and interaction. The overlays include real-time player statistics during sports events, synchronized lyrics for music concerts, and interactive merchandise pop-ups that allow for instant purchases without leaving the immersive environment.
Live Fan Interactions: The disclosed system fosters a sense of community and engagement through live fan reactions, chat functionality, and interactive moments. The users may cheer for their favorite teams or artists, vote on event outcomes, and participate in polls, all in real-time, creating a shared experience that goes beyond passive viewing.
Spatial Audio: To complete the immersive experience, the disclosed system implements advanced spatial audio technology that syncs with the user's head movement. The spatial audio creates a realistic soundscape that adjusts dynamically as users explore the virtual environment, enhancing the sense of presence and realism.

Further, the backend infrastructure of the disclosed system is as follows:
Cloud Infrastructure: The disclosed system utilizes a multi-cloud strategy, incorporating services from industry leaders such as Amazon Web Services™ (AWS), Google Cloud Platform™ (GCP), and Microsoft Azure™. The approach provides the disclosed system with:
   GPU-accelerated instances: The powerful computing units are crucial for live encoding and rendering, enabling delivery of high-quality, low-latency streams to viewers.
   Auto-scaling groups: The feature allows the disclosed system to dynamically adjust resources based on user demand, ensuring smooth performance during peak viewership periods such as major sporting events or concerts.
   Global content delivery network (CDN): To minimize latency and provide the best possible viewing experience for users worldwide.
   Storage Solutions: For efficient management of a vast content library, the disclosed system employs:
      Amazon™ S3/Google™ Cloud Storage: The mentioned cloud-based object storage services are ideal for securely storing and rapidly retrieving recorded content and replays. The cloud-based object storage services offer unlimited scalability and high durability, ensuring our valuable media assets are protected and easily accessible.
      The storage solutions may include a content lifecycle management, wherein the content lifecycle management is an automated system to archive older content and optimize storage costs while maintaining quick access to popular replays.
      Further, the storage solutions may include a database architecture for a multi-tiered database strategy, ensuring efficient data management and retrieval. Further, the database architecture may include:
         PostgreSQL: The robust, open-source relational database system handles the disclosed system's core data needs, including user profiles, ticketing information, and session data. The PostgreSQL ACID compliance ensures data integrity for critical transactions.
         Redis™: As an in-memory data structure store, Redis powers the disclosed system's real-time features, such as live chat, instant reactions, and temporary session storage. Redis's low-latency performance is crucial for creating an interactive, engaging user experience.
         Elasticsearch™: The powerful search and analytics engine called Elasticsearch™ enables lightning-fast queries across our vast content library. The users may quickly find specific highlight replays, search for their favorite artists or players, and discover new content based on their preferences.

Further, the disclosed system may include one or more APIs and Services Integrations to provide a seamless and secure user experience, wherein the APIs are as follows:
User Authentication and Access Control:
   OAuth 2.0 protocol: Enables secure, token-based authentication and authorization for third-party integrations.
   Firebase Auth: Provides a robust, scalable user authentication system with features like multi-factor authentication and account linking.
   Custom ticketing system: Integrated with the disclosed system's authentication services to manage event access and VIP privileges.
Payment Processing and Subscription Management:
   Stripe: Primary payment gateway, offering support for multiple currencies and payment methods.
   Apple Pay and Google Pay: Integrated for seamless mobile payments, improving conversion rates on iOS and Android devices.
   Subscription lifecycle management: Automated systems for handling recurring billing, upgrades, downgrades, and cancellations.
Metadata Management System: Centralized database for performers, teams, and events, ensuring consistent and up-to-date information across all platforms. API-driven content tagging allows dynamic categorization and improved discoverability of live and recorded content. Integration with external data providers incorporates real-time sports statistics, entertainment news, and other relevant data to enrich the user's experience.

Further, the comprehensive backend infrastructure forms the foundation of the disclosed system's ability to deliver high-quality, interactive live streaming experiences for sports and entertainment events. By leveraging cutting-edge technologies and services, the disclosed system ensures scalability, reliability, and innovation in the platform.

Further, the network architecture supporting the disclosed system may include:
5G or Wi-Fi 6/6E: Cutting-edge wireless technologies are crucial for mobile XR (Extended Reality) experiences and arena-based viewers. 5G offers ultra-fast speeds and low latency, while Wi-Fi 6/6E provides enhanced performance in crowded areas, ensuring seamless connectivity for thousands of concurrent users.
Fiber uplink: A high-capacity fiber optic connection from the venue to the edge cloud or central server is essential. The dedicated link ensures minimal latency and maximum bandwidth, enabling real-time data transmission for live XR experiences.
Fiber-Optic Connections: For production and server-side needs, fiber-optic networks provide unparalleled speed and reliability. The connections support the high-bandwidth requirements of XR content creation, processing, and distribution, ensuring smooth operations behind the scenes.

Further, the latency optimization support for the disclosed system may be as follows:
Edge compute: Implementing edge computing solutions for real-time encoding and rendering near the venue significantly reduces latency. The mentioned approach brings processing power closer to the end-users, enabling faster content delivery and more responsive XR experiences.
Edge-based CDN: Utilizing advanced Content Delivery Networks (CDNs) such as AWS CloudFront™, Cloudflare Stream™, or Fastly™ is crucial for efficient content distribution. The edge-based CDN offers:
   Multi-bitrate XR video delivery, adapting to various network conditions and device capabilities.
   Edge compute capabilities for dynamic overlays, allowing real-time integration of statistics, live chat, and other interactive elements.
   Multi-CDN strategy: Implementing a global network of CDN Points of Presence (PoPs) ensures worldwide reach and redundancy. The mentioned approach is particularly important for serving sports fans across different geographic locations, providing low-latency access to XR content regardless of the viewer's location.

Further, the low-latency protocols included in the disclosed system are as follows:
WebRTC (Web Real-Time Communication): The protocol is ideal for real-time, interactive streaming scenarios such as live concerts or virtual meetings. WebRTC enables peer-to-peer connections, reducing server load and minimizing latency.
UDP-based protocols: User Datagram Protocol (UDP) based solutions offer quicker data transmission compared to TCP (Transmission Control Protocol). While UDP sacrifices some reliability for speed, UDP is crucial for maintaining real-time responsiveness in XR applications where immediacy is paramount.

Further, the cloud services used in the disclosed system are as follows:
AWS™ (Amazon Web Services): Leveraging AWS™ provides unparalleled scalability, robust media processing capabilities (e.g., AWS™ MediaLive for live video processing), vast storage options, and powerful compute resources. The cloud infrastructure allows the disclosed system to dynamically adjust resources based on demand, ensuring optimal performance during peak usage and cost-efficiency during quieter periods.

Further, by implementing the above comprehensive network infrastructure, the disclosed system ensures a high-quality, low-latency XR streaming experience for sports and entertainment events. The combination of advanced connectivity, edge computing, and cloud services creates a robust foundation for delivering immersive content to a global audience.

Further, the disclosed system implements a comprehensive analytics and monitoring system to ensure optimal performance and user engagement. The disclosed system comprises several key components:
Real-time engagement dashboards (utilizing industry-leading tools such as Mixpanel™ and Amplitude™):
   The dashboards provide instant insights into user behavior, content performance, and overall platform engagement.
   Metrics tracked include viewer retention rates, session duration, and content popularity.
   Data visualization tools allow for quick identification of trends and anomalies.
Viewer attention heatmaps: Sophisticated tracking of head rotation and viewing angles within the VR environment, visual representation of areas that attract the most viewer attention during live events, and insights used to optimize camera placement and content framing for future broadcasts.
Quality of Experience (QoE) monitoring:
   Continuous tracking of crucial performance metrics such as bitrate adaptation and buffering instances.
   Comprehensive headset compatibility testing to ensure smooth functionality across various VR devices.
   Regular analysis of user feedback to identify and address potential experience issues.
Server monitoring (utilizing Grafana™ and Prometheus™):
   Real-time tracking of server health, load balancing, and resource utilization.
   Automated alerts for potential issues to enable proactive problem-solving.
   Historical data analysis for capacity planning and infrastructure optimization.

By implementing the above robust analytics and monitoring solutions, the disclosed system ensures a high-quality, immersive experience for all users while continuously improving the service based on data-driven insights.

Further, in the rapidly evolving landscape of digital content distribution, robust security measures and effective Digital Rights Management (DRM) systems are paramount. The comprehensive approach to security and content protection encompasses several cutting-edge technologies and best practices:
Digital Rights Management (DRM):
   The disclosed system implements a multi-DRM strategy utilizing industry-leading technologies. Widevine, developed by Google™, caters to Android and web platforms. Apple's™ FairPlay ensures content protection on iOS devices and Safari browsers. Microsoft's™ PlayReady offers broad device support, including Xbox consoles and Windows devices. The above diverse approach guarantees maximum compatibility and security across various platforms and devices.
   Tokenized streaming URLs: To enhance access control, the disclosed system employs tokenized streaming URLs. The method generates unique, time-sensitive tokens for each viewing session, preventing unauthorized access and content sharing. Tokens are cryptographically signed and validated in real-time, ensuring only legitimate users may access premium content.
   End-to-end encryption for live feeds: Given the time-sensitive nature of live sports and entertainment events, the disclosed system implements robust end-to-end encryption for all live streams. The process secures the content from a source to the viewer's device, safeguarding against interception and unauthorized redistribution.

Further, the enhanced security and privacy measures associated with the disclosed system are as follows:
Encryption: The disclosed system employs state-of-the-art encryption protocols to secure all data streams. The protocols include SSL/TLS (Secure Sockets Layer/Transport Layer Security) for all network connections, ensuring that data transmitted between servers and users' devices remains confidential and tamper-proof. Additionally, the protocols include AES (Advanced Encryption Standard) 256-bit encryption for data at rest, providing an extra layer of protection for stored user information and content.
Authentication: To prevent unauthorized access and account hijacking, the disclosed system implements a robust multi-factor authentication (MFA) system. Users may choose from various second-factor options, including SMS codes, authenticator apps, or biometric verification where supported. The robust MFA system significantly reduces the risk of account compromises, even if passwords are somehow obtained by malicious actors.
Privacy Protection: The disclosed system is committed to safeguarding user privacy and maintaining compliance with global data protection regulations. The disclosed system adheres to the stringent requirements of the General Data Protection Regulation (GDPR) for European users and the California Consumer Privacy Act (CCPA) for California residents. The privacy measures include:
   Transparent data collection and usage policies.
   User consent management for data processing.
   Secure data storage with regular audits and updates.
   Data minimization practices to collect only essential information.
   User rights management, including the right to access, rectify, and erase personal data.

Further, by implementing the above comprehensive security and privacy measures, the disclosed system ensures that the users may enjoy a premium live-event streaming service with confidence, knowing that the personal information of the users and the users' viewing experiences are well-protected.

Further, the additional features of the disclosed system are as follows:
NFT ticketing or digital collectibles (blockchain): Leveraging blockchain technology, the disclosed system may offer unique, verifiable digital assets to the users. The above mentioned may include limited edition virtual tickets, exclusive memorabilia, or even moments from live events, creating a new revenue stream and enhancing fan engagement.
Interactive avatars or volumetric presence for virtual meet & greets: By incorporating advanced 3D modeling and real-time rendering techniques, the disclosed system may create lifelike digital representations of athletes or entertainers. The technology enables fans to interact with idols in a virtual space, fostering a sense of personal connection despite physical distances.
AI-based camera direction for automated scene switching: Utilizing machine learning algorithms, the platform may analyze live footage in real-time, identifying key moments and automatically switching between camera angles. The AI-based camera direction ensures that viewers never miss crucial action, enhancing the overall viewing experience.
Digital twin venues for hybrid virtual concerts/stadiums: By creating highly detailed, virtual replicas of real-world venues, the disclosed system may offer a blended experience that combines the energy of live events with the accessibility of virtual attendance. The above feature may allow for unlimited virtual attendance while maintaining the authentic feel of being present at the venue.
AI/ML Integration: Artificial Intelligence and Machine Learning may be employed for personalization, adaptive streaming, or gesture recognition. The AI/ML integration may include tailoring content recommendations based on viewing history, automatically adjusting stream quality based on network conditions, or enabling intuitive gesture-based controls for an immersive viewing experience.
Blockchain/Web3: While primarily suited for niche use cases, blockchain technology may be implemented for digital rights management or decentralized content ownership. The blockchain technology may provide a transparent and secure way to manage content rights and royalties, potentially revolutionizing how content creators are compensated.
Digital Twins/IoT Integration: For industrial XR platforms, the disclosed system may create virtual representations of physical objects or systems, integrated with Internet of Things (IoT) devices. The mentioned feature may have applications in training simulations, remote monitoring, or predictive maintenance in various industries.
Interactivity Features: To enhance user engagement, the disclosed system may implement gesture controls, voice commands, or eye tracking. The mentioned features may allow for more intuitive navigation and control of the platform, especially when used in conjunction with VR or AR devices.
Analytics and Monitoring: Robust analytics tools may be integrated to track performance, user interactions, and application usage. The data may be crucial for the continuous improvement of our service, allowing us to identify popular features, troubleshoot issues, and tailor offerings to user preferences.
Scalability: The disclosed system may be designed to handle varying user loads dynamically. The scalability feature ensures smooth performance during peak times, such as major sporting events or concerts, while efficiently managing resources during periods of lower demand.

By carefully implementing the optional enhancements, the disclosed systems aim to stay at the forefront of live-event streaming technology. The mentioned features not only differentiate the service from competitors but also provide the users with an unparalleled, immersive, and interactive viewing experience.

Further, the disclosed system is a real-time, device-agnostic volumetric 3D video streaming system designed for immersive, interactive social experiences. The optimal manufacturing method integrates both hardware-agnostic software architecture and scalable cloud-native infrastructure to support dynamic 3D content capture, reconstruction, compression, streaming, and interaction. The method combines the following core stages:
Modular Software Stack Development
   Approach: Employ a microservices-based architecture implemented primarily in C++, Python, and Rust for performance-intensive modules (e.g., 3D reconstruction, spatial encoding), and JavaScript/TypeScript for client-side interaction layers.
   Tools: The tools used are containers (e.g., Docker, Kubernetes) to ensure modular deployment and scalability.
   Advantages: Facilitates continuous integration/continuous deployment (CI/CD), rapid updates, and load-balanced scaling for user-generated and professional content.
Cross-Device Input Standardization
   Approach: Develop cross-platform input adapters that normalize and preprocess data from heterogeneous devices (e.g., stereo cameras, 360° cameras, and LiDAR smartphones).
   Method: The disclosed system implements a hardware abstraction layer (HAL) that automatically detects and configures input streams, applying format-specific calibration for depth alignment, camera pose estimation, and frame synchronization.
   Tools: The tools used are OpenCV, MediaPipe, and custom deep learning models to unify data across formats.
Volumetric Reconstruction and Scene Encoding
   Approach: Manufacture core 3D reconstruction modules using a hybrid of traditional structure-from-motion (SfM) and learned neural implicit surface modeling (e.g., NeRF-like architectures).
   Implementation: The disclosed system optimizes inference and training pipelines with TensorRT and ONNX for GPU acceleration in real-time scenarios.
   Compression: The disclosed system implements advanced geometry and texture compression using glTF, Draco, and proprietary point cloud quantization methods to balance quality and bandwidth.
Real-Time Streaming Subsystem
   Approach: Encode reconstructed 3D scenes into streamable formats using adaptive bitrate logic and dynamic scene segmentation.
   Protocols: The disclosed system uses a dual-path pipeline supporting both WebRTC (low latency) and HLS/DASH (scalable broadcast) for different end-use scenarios.
Edge Optimization: The disclosed system integrates CDN edge caching with optional edge-based transcoding for low-latency delivery.
Spatial Interaction Layer and Avatar Engine
   Approach: Implement an event-driven interaction engine that synchronizes avatar motion, emoji reactions, voice data, and UI overlays in a shared 3D environment.
   Frameworks: The disclosed system uses Unity™ or Unreal Engine™ for front-end rendering, with Photon™ or Agora™ for spatial voice sync and multiplayer state management.
   Manufacturing Consideration: The disclosed system is deployed as SDK packages for integration into third-party apps or use as a standalone GreenLight™ XR Media Player.
Security, Privacy, and Moderation Layer
   Approach: Integrate privacy controls and moderation pipelines during software compilation and deployment.
   Methods: Include in-app settings for masking, user muting, and visibility preferences. Employ TensorFlow Lite models at the edge to detect and filter inappropriate content before broadcast.
   Compliance: Build according to privacy regulations (e.g., GDPR, COPPA) from the codebase level up.
Deployment and Continuous Optimization
   Method: Distribute the compiled platform via cloud-native environments such as AWS™ or Azure™ using serverless components (e.g., AWS™ Lambda, API Gateway) for on-demand compute scaling.
   Monitoring: Employ user analytics dashboards to iterate and refine latency, bandwidth, and engagement KPIs.
   Customization: The disclosed system allows for region-specific deployments, white-labeled front ends, and custom event skins/themes.

Further, the best manufacturing method for the disclosed system is not a traditional hardware fabrication, but instead the systematic development, assembly, and deployment of an advanced, modular software ecosystem. The disclosed system harmonizes real-time 3D video reconstruction, adaptive compression, and immersive interaction-delivered via scalable, cloud-based infrastructure and compatible with everyday consumer devices. The mentioned approach enables mass adoption, content democratization, and robust monetization pathways for creators and organizations.

Further, a purpose of the invention is to live-stream video of sporting and entertainment events in 3-Dimensional volume format through social media.

Further, the disclosed system comprises five primary modules: (1) a capture module for acquiring video data from heterogeneous sources; (2) a reconstruction engine using machine learning to create volumetric representations; (3) a compression and encoding module; (4) a device-agnostic streaming engine; and (5) an interaction layer enabling real-time co-viewing and engagement.

Further, the capture module accepts inputs from a wide range of devices, including stereo smartphones, 360° cameras, dual-lens webcams, and professional volumetric rigs. The reconstruction engine includes a convolutional neural network trained on RGB-D datasets and implements multi-view fusion and depth estimation techniques. The resulting 3D models are represented as point clouds, meshes, or voxels.

Further, the encoding module applies real-time compression techniques such as glTF, MPEG-4, or Draco, and supports adaptive bitrate adjustment based on client bandwidth. The streaming module supports delivery to smartphones, web browsers, smart TVs, and MR/VR headsets using WebRTC, HLS, or custom protocols.

Further, the interaction layer includes synchronized playback control, avatar-based presence, emoji reactions, chat overlays, and multimedia annotations. The disclosed system enables privacy controls for muting, masking avatars, or limiting visibility. Moderation tools use NLP and image recognition to flag inappropriate content.

Further, the monetization module allows content creators to define paywalls, access tiers, and receive payments tied to engagement metrics. A dashboard provides real-time performance insights, earnings, and audience feedback.

Further, alternative embodiments may incorporate edge processing, hybrid cloud architectures, or integration with third-party platforms.

Further, the patent US20220417488A1—Volumetric 3D Video Generation from Heterogeneous Inputs discusses methods for detecting and manipulating objects within volumetric videos to enhance user experience, primarily focusing on editing and presentation aspects rather than real-time reconstruction from diverse input sources. The disclosed system's approach to real-time volumetric reconstruction from both high-end and consumer-grade devices, optimized for edge processing, is novel and not directly addressed by existing patents.

Further, the patent U.S. Pat. No. 7,839,399B2—Edge-Optimized Real-Time 3D Reconstruction describes a system for real-time extraction of video images from arbitrary backgrounds and their display in a volumetric format, focusing on the extraction and display aspects. While the patent U.S. Pat. No. 7,839,399B2 addresses real-time processing, the patent U.S. Pat. No. 7,839,399B2 does not delve into edge-optimized reconstruction from heterogeneous inputs, indicating that the disclosed system's solution offers unique advancements in the mentioned area.

Further, the patent US20160286244A1 Multi-Device, Display-Agnostic Output Rendering outlines an interactive video broadcasting service enabling multiple source devices to broadcast live video streams to various viewing devices, including features like multi-perspective video sharing and contextual data insertion. While the patent US20160286244A1 covers multi-device broadcasting, the patent US20160286244A1 does not specifically address volumetric 3D rendering across diverse display types, indicating that the disclosed system's display-agnostic rendering engine is distinct and novel.

Further, the patent US20040104935A1-Spatial Audio Rendering for Immersive Group Presence presents a virtual reality immersion system with a head-mounted display and tracking capabilities, focusing on visual immersion rather than spatial audio rendering. The disclosed system's integration of ambisonics and binaural rendering for spatial audio positioning is a unique feature not directly covered by existing patents.

Further, Patent US20160286244A1-Social Engagement Infrastructure includes features like multi-perspective video sharing and user engagement tools, focusing on interactive video broadcasting services. While the patent US20160286244A1 addresses interactive features, the disclosed system's comprehensive social engagement infrastructure, including avatars, shared gestures, and gamification within 3D environments, offers novel aspects not encompassed by existing patents.

Further, the disclosed system's technology integrates multiple innovative components—real-time volumetric 3D video generation from diverse inputs, edge-optimized reconstruction, display-agnostic rendering, spatial audio, and immersive social engagement—that collectively offer a unique solution not directly addressed by existing patents.

Currently, individuals are accustomed to watching events and programs on traditional television screens or online platforms in a flat, two-dimensional (2D) format. However, the conventional viewing experience limits the level of immersion and engagement that viewers may experience with the content. Whether the streamed content is sports games, concerts, or other live events, the static and less immersive representation fails to capture the full potential of engagement and immersion of the occasion.

Further, the disclosed system is an innovative streaming social platform that aims to revolutionize the live event experience in the sports and entertainment industry. The main objective of the platform is to redefine how people engage with sports, concerts, and other entertainment events. The platform achieves the above mentioned by leveraging cutting-edge technologies such as Augmented Reality (AR), Virtual Reality (VR), 3D cameras, 5G networks, and AI/ML. In recent times, advancements in scene capture technology and consumer virtual/augmented reality hardware have made real-time view tracking more precise and accessible. As a result, the disclosed system is able to create immersive viewing experiences on a large scale. Imagine being at the center of the action, feeling the energy and excitement as if the individual were physically present with the individual's friends and family. The disclosed system's advanced streaming social media capabilities enable the content creators to transmit live event footage in stunning 3-dimensional formats, providing an immersive experience that transports the audience into the event itself.

Further, the disclosed system is aimed at individuals who wish to view sporting and entertainment events (such as concerts) through video streaming on laptops, smartphones, and other online display devices, and who wish to engage with friends and family during the live events in virtual space.

Further, the disclosed system has the potential to revolutionize the way viewers perceive and engage with live events. By harnessing the power of three-dimensional (3D) and social media technology, the disclosed system aims to create a genuinely immersive and interactive experience for audiences. The objective of the disclosed system is to transform the way individuals consume sports and entertainment by introducing cutting-edge live-event streaming in a captivating 3D format through social media. By capturing the depth and realism of the events, viewers may have front-row seats, experiencing the excitement and energy from the comfort of the viewers' own homes, and with friends and family in virtual space. Through the disclosed system, viewers may no longer be passive observers but active participants in the virtual world. The viewers may have the freedom to explore different perspectives, switch between camera angles, and even interact with virtual elements within the event environment. The viewers may be able to invite friends and family to view the live events together and interact on the platform during the events. The level of immersion and engagement may redefine the way audiences connect with the user's favorite sports teams, artists, and performers.

The disclosed system's platform is at the forefront of a transformative wave, leveraging the convergence of emerging technologies and expertise to disrupt the traditional broadcasting and streaming landscape.

Further, the disclosed system is an innovative video streaming platform that seamlessly transforms two-dimensional images from multiple cameras into three-dimensional video streams transmitted over the internet for viewer consumption in real time.

Further, the disclosed system comprises several system components working together to achieve the purpose of the invention goal: capture systems support professional production workflows, 3D image construction is automatic and scalable to high processing throughput, and results are compressed to be compatible with a data rate close to common media formats for transmission. Visual quality from any angle matches traditional video, and the format is displayable in real-time on a wide range of consumer devices. The viewers gather together in an interactive, social platform for shared experiences.

The disclosed system is designed to satisfy Quality of Service requirements for live, 3-D video streaming:
Low latency and immediate availability.
Changes in viewpoint.
Image scale.
Resolution in differing light conditions.
Network speed.

Further, the key components of the disclosed system may include:
An array of active 3D stereo depth camera pods for real-time high-quality capture.
Graphics Processing Unit (GPU) setup for rapid 3D image and motion processing.
Inventive point-cloud fusion approaches for 3D reconstruction.
Spatial audio that captures user position and orientation.
State-of-the art compression and transmission for low-latency, high-quality distribution.
Seamless integration with rapidly emerging video display devices.

Further, the key elements of each of the process steps and associated technologies with the disclosed systems are described below.
Capturing live event: For full 360 degree capture of the scenes of interest, the disclosed system integrates the best of the major 3D sensing and machine vision technologies, combining elements of stereo vision, time-of-flight, structured light, and laser triangulation techniques to capture the three-dimensional details of the scenes in focus. The disclosed system employs camera pods placed in strategic positions. Each pod captures a unique viewpoint of the subject/scene. The array of camera pods covers the event from multiple angles, ensuring that every live scene is captured with high fidelity and resolution. Each pod consists of Near Infra-Red cameras (NIR) and Red-Green-Blue Depth (RGB-D) color cameras, which generate RGB and Depth video streams. Each pod serves as a texture in the scene to help estimate depth, even in the case of texture-less surfaces. The first step of the capture is to generate depth streams, which require full intrinsics and extrinsics calibration. The camera pods are well-calibrated and synchronized for background segmentation and consistency across all cameras, using state-of-the-art stereo matching techniques. The calibration step also ensures homogeneous and consistent color information among the RGB cameras. The calibration step makes the signal consistent across all the RGB cameras. All the cameras in the array are synchronized through the use of external triggers, such that a consistent scene image is captured and processed. In the disclosed system, the full spectrum of professional video production and post-production capabilities is enabled. To capture the audio, the capture platform utilizes an array of microphones to capture both the subject's audio and the ambient noise. The array of microphones is a combination of directional/open-air microphones, headset microphones, and handheld wireless mics with windscreens, synthesized through an audio mixer for faithful capture of spatial audio. Proper lighting is utilized to capture the dynamic image contours necessary for 3D reconstruction.
Synthesizing video and audio to create dynamic 3D images: The disclosed system creates 3D videos that are temporally consistent, live in real-time. The disclosed system performs depth estimation by generating a spatial mesh scanning the physical images as a dense 3D point cloud. The disclosed system employs proprietary 3D Multiview Dynamic Image Reconstruction algorithms, incorporating AI/ML for scene understanding and reconstruction.
Rendering streaming video for display: The 3D streaming video output is integrated through device-native SDKs (Software Development Kits) with a range of devices, including VR and AR displays, glasses, HMDs (Head-Mounted Displays), smartphones, tabletop displays, and room and cave displays.
The disclosed system utilizes third-party authoring and rendering software (hardware-agnostic tools such as Unity™, Unreal™, and Maya™, as well as hardware-specific tools such as Facebook™ Quill, Apple™ Reality Composer, and Google™ Blocks) to integrate 3D video streams with displays.
A selection of the following display technologies for live 3D video displays is integrated and tested with the platform:
   Rooms and Caves (for projection without wearables): Musion™, IglooVision™, Barco™, Kelyn3D™, HyperVSN™, TiltFive™, and Kickstarter™ LookingGlass.
   3D Projectors: Optoma™, BenQ™, Epson™ Home Cinema, and VanKYO
   Tabletops: Weisman™ Holo Table, Hologram Table™, Axiom Holographics™, and TiltFive™.
   HMDs, Glasses, and Smartphones:
      AR: HoloLens, Magic Leap™, iPad, and Apple™ Vision Pro
      VR: Google™ Glass, HTC™ Vive, Oculus™ Quest and Rift™, Windows™ MR Headset, and Playstation™ VR.
   Mobile apps: Numerous mobile applications are available on different mobile operating systems, through wireless or wired connections. With apps such as MultiPresenter™, Asus™ WiFi Projection, ViewSonic™ Wireless vPresenter, Acer™ eDisplay, Panasonic™ Wireless Projector, and Epson™ iProjector, the platform provides capabilities for a flexible and affordable set of solutions for watching videos on a big screen.
The platform also allows for integrations with display devices by offloading the video stream to a rendering PC and connecting to the display device through WiFi. The above integration allows for maintaining a consistent framerate, reduces perceived latency, conserves battery life on the device, and enables high-end rendering capabilities, which are not always available on mobile GPUs and other display devices.

Further, the step of creating a 3D video and audio stream is as follows:
The video stream from the capture stage and the fusion stage goes through compression and encoding for transfer over wide-area networks with low latency rates.
Signal from the live scene is acquired through satellite uplinking and downlinking, or via connectivity at the event location if the content is being encoded on-site from the venue.
Live streaming video data is encoded into an interpretable digital format that a wide variety of devices recognize.
The disclosed system utilizes the widely-used H.264 encoding standard for streaming, but standards like H.265, VP9, and AV1 are also enabled.
The mentioned encoding process compresses the video by removing redundant visual information. (For example, in a stream of someone talking against the background of a blue sky, the blue sky does not need to be rendered again for every second of video, since the blue sky does not change a lot. Therefore, the blue sky is stripped out from most frames of the video.)

Further, once the video stream is ready, the platform streams the video stream over the Internet. With the lightning-fast speeds of 5G networks, the platform provides a seamless streaming experience in real-time, without any delays or buffering. The above allows audiences to truly immerse themselves in the action and enjoy the event.

Key features of the disclosed system's streaming distribution include:
Pull-based Adaptive Streaming HTTP over TCP. (The technology is used by services such as Netflix™, Hulu™, YouTube™, etc.).
Progressive Download: video played as soon as a necessary amount of data is retrieved and buffered (2-10 s) of video playtime.
All display devices in the market support HTTP, which uses the pull technology protocol and traverses middle boxes (firewall, etc.).
Fragmented MP4 file format.
Appropriate video frame for compression and transmission.
Adaptive HTTP Streaming: a combination of adaptive video quality (bitrate) control and progressive downloading.

Further, the disclosed system allows for streaming options such as below:
Audio languages
Camera angles
Subtitle languages
Bitrates

Further, the disclosed system allows protocols to enable the insertion of ads. To enable a seamless streaming experience, the platform expects to work with Content Distribution Networks for faster and efficient distribution through strategically placed servers to reduce network burden and download time. The disclosed system is associated with leading players such as including Akamai™, Amazon™ CloudFront, AWS™, CD Networks™, Level 3™, and Limelight Networks™.

Further, the method described in the present disclosure is an end-to-end unique process and a technical architecture designed to capture live scenes and actions, transform 2D images to 3D volume form, and transmit over the internet for consumption in real time. The above is achieved through
360 degree capture from multiple angles by active stereo depth and near-infrared camera.
Utilize throughput-oriented parallel GPU and CPU architecture for rapid image processing.
Unique point-cloud fusion algorithms, enhanced through scene recognition and processing by deep learning techniques.
Open-architecture rendering and encoding to match with emerging commercial devices, extending beyond standard AR/VR devices and smartphones to room/cave and tabletop/3d projector display devices.

Further, the most efficient production of live 3D video streaming for viewers is through an end-to-end capture through the method described above. The method is designed to meet strict Quality of Service standards of speed, latency, and quality necessary for 3D live action video transmission.

Further, in some embodiments, an additional improvement may be achieved by integrating AI-based automated camera direction. The feature may address the technical problem of manual scene switching in multi-camera volumetric captures. The system may employ machine learning models trained to detect salient actions, gestures, or sound peaks, and may automatically select or blend viewpoints. In other embodiments, reinforcement learning models may optimize camera transitions based on historical viewer engagement, thereby enhancing the technology of intelligent video production.

Further, in some embodiments, an additional improvement may be enabled through blockchain-backed ticketing and digital rights management. The mentioned feature may address the technical problem of unauthorized access and piracy in immersive media streams. The system may issue cryptographically verifiable NFT tickets or tokenized access keys, which may be validated through blockchain consensus. In other embodiments, blockchain-based ownership records may support resale or revenue-sharing mechanisms, thereby improving the technology of secure digital rights enforcement in streaming systems.

Further, in some embodiments, an additional improvement may be achieved through digital twin venue replication. The digital twin venue replication may solve the technical problem of limited immersion in virtual attendance. The system may generate photorealistic replicas of stadiums, theaters, or concert halls, which may be streamed as hybrid environments alongside volumetric performers. In other embodiments, IoT sensors embedded in physical venues may provide real-time environmental metadata (e.g., lighting, crowd movement) that may be synchronized into the digital twin. The capability may advance mixed-reality venue simulation technologies.

Further, in some embodiments, an additional improvement may involve edge-based AI reconstruction. The edge-based AI reconstruction may address the technical problem of centralized processing bottlenecks in cloud-only pipelines. The system may deploy lightweight neural networks to edge nodes near capture devices, thereby reducing upstream bandwidth by transmitting compressed intermediate representations rather than raw video. In other embodiments, federated learning may be employed to update reconstruction models across distributed edge nodes without centralized data aggregation, thereby improving distributed AI streaming infrastructures.

Further, in some embodiments, an additional improvement may be achieved through immersive analytics integration. The immersive analytics integration may address the technical problem of limited user feedback in immersive streaming. The system may capture gaze tracking, motion trajectories, and spatial interactions, and may process through real-time analytics dashboards. In other embodiments, heatmaps may be generated to optimize camera placement or content personalization. For example, in a sporting event, gaze data may reveal which players receive the most audience attention, allowing adaptive zooms and overlays. The immersive analytics integration may advance the field of XR engagement analytics technology.

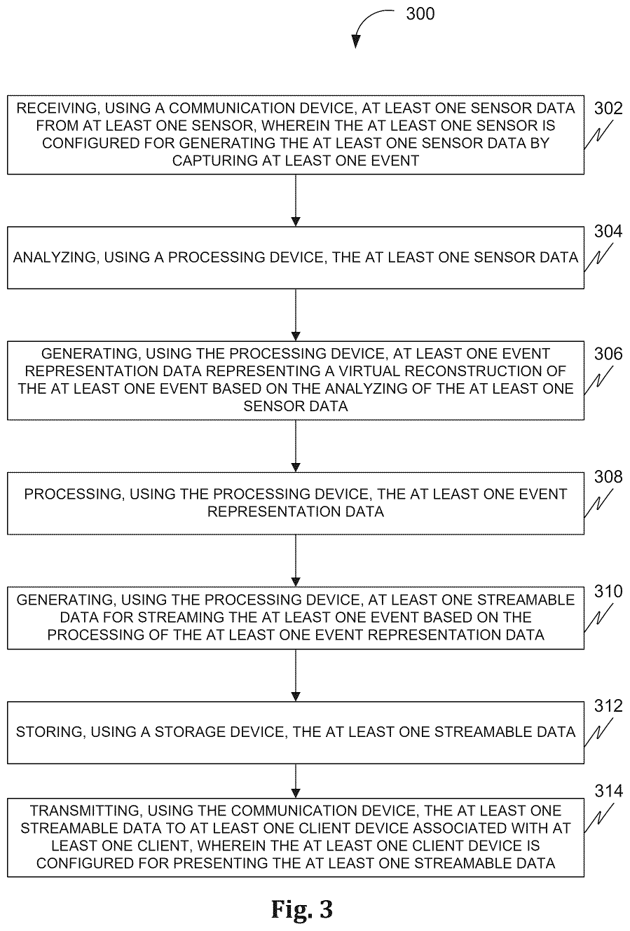

Further, FIGS. 3-21 describes a computer-implemented method of facilitating streaming of events. Further, the computer-implemented method includes a step of receiving at least one sensor data from at least one sensor capturing at least one event using a communication device. Further, the computer-implemented method includes a step of generating an event representation data representing a volumetric reconstruction of the at least one event using the processing device. Further, the computer-implemented method includes a step of processing the event representation data to generate streamable data. Further, the computer-implemented method includes a step of transmitting the streamable data to at least one client device for presentation of the at least one event.

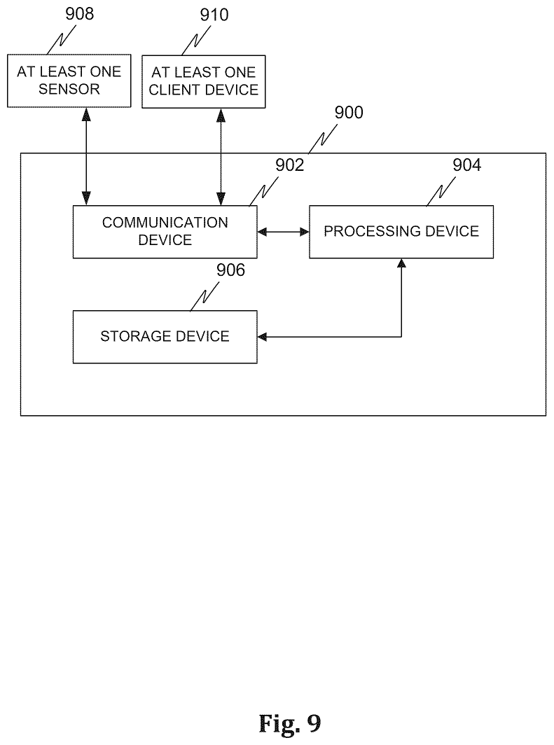

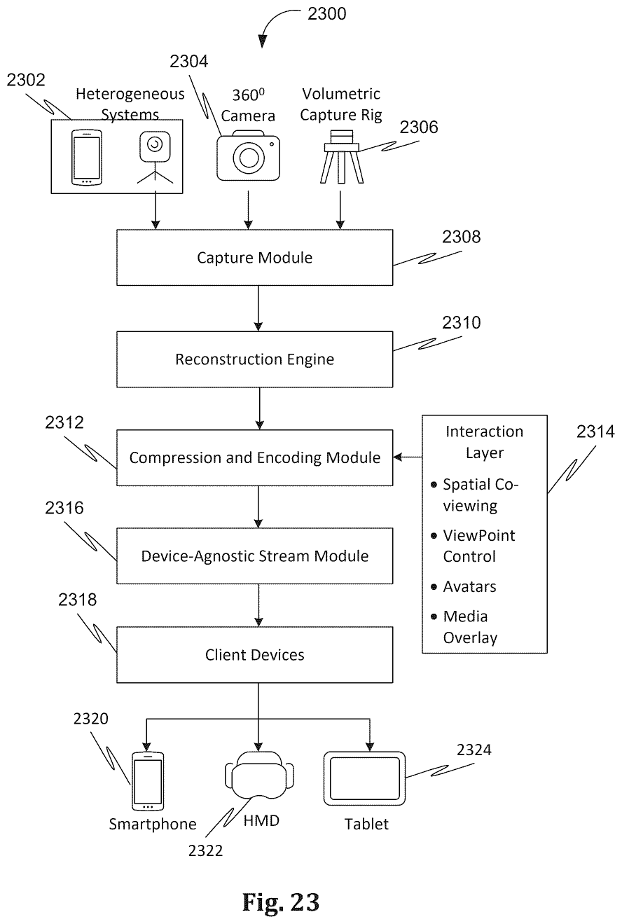

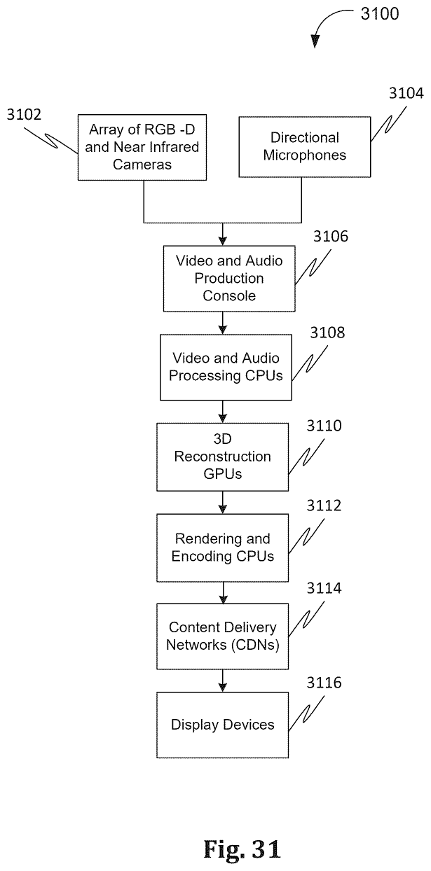

Further, FIG. 9, FIG. 23, and FIG. 31 describe a system for facilitating the streaming of events. Further, the system includes at least one communication device configured to receive a sensor data and transmit a streamable data. Further, the system includes at least one processing device configured to generate the event representation data from the sensor data. Further, the at least one processing device is further configured to process the event representation data to generate the streamable data. Further, the system includes at least one storage device configured to store the streamable data. Further, at least one client device is configured to present the streamable data.

Further, the present disclosure describes a non-transitory computer-readable medium storing instructions which, when executed by at least one processing device, cause the at least one processing device to perform the method of facilitating streaming of events. Further, the method includes a step of receiving at least one sensor data from at least one sensor, wherein the at least one sensor is configured for generating the at least one sensor data by capturing at least one event. Further, the method includes a step of analyzing the at least one sensor data. Further, the method includes a step of generating at least one event representation data representing a virtual reconstruction of the at least one event based on the analyzing of the at least one sensor data. Further, the method includes a step of processing the at least one event representation data. Further, the method includes a step of generating at least one streamable data for streaming the at least one event based on the processing of the at least one event representation data. Further, the method includes a step of storing the at least one streamable data. Further, the method includes a step of transmitting the at least one streamable data to at least one client device associated with at least one client. Further, the at least one client device is configured for presenting the at least one streamable data.

Further, the generating of the at least one event representation data comprises generating the at least one event representation data using at least one artificial intelligence model for the virtual reconstruction of the at least one event. Further, the processing of the at least one event representation data is further based on the generating of the at least one event representation data using the at least one artificial intelligence model.

Further, the method includes a step of receiving at least one rewatch request associated with a recording of the at least one event from the at least one client device. Further, the method includes a step of analyzing the at least one rewatch request. Further, the method includes a step of retrieving the at least one streamable data based on the analyzing of the at least one rewatch request. Further, the method includes a step of processing the at least one streamable data. Further, the method includes a step of generating at least one rewatch streamable data for rewatching the at least one event with playback controls based on the processing of the at least one streamable data. Further, the method includes a step of transmitting the at least one rewatch streamable data to the at least one client device. Further, the at least one client device is configured for controlling a playback of the at least one rewatch streamable data.

Further, the processing of the at least one event representation data includes a step of compressing the at least one event representation data and encoding the at least one event representation data using an adaptive bitrate encoding technique based on the compressing of the at least one event representation data. Further, the generating of the at least one streamable data is further based on the encoding of the at least one event representation data.

Further, the transmitting of the at least one streamable data further includes a step of transmitting the at least one streamable data using at least one protocol.

Further, the method includes a step of generating at least one dense point cloud data representing at least one dense point cloud of at least one first entity in the at least one event based on the analyzing of the at least one sensor data. Further, the method includes a step of analyzing the at least one dense point cloud data using at least one first algorithm. Further, the generating of the at least one event representation data is further based on the analyzing of the at least one dense point cloud data. Further, the generating of the at least one event representation data includes a step of generating at least one temporally consistent three-dimensional scene data representing a volumetric representation of an event space of the at least one event based on the analyzing of the at least one dense point cloud data.

Further, the processing of the at least one event representation data further includes a step of processing the at least one event representation data using at least one codec.

Further, the method includes a step of generating at least one creator dashboard data based on the at least one event representation data. Further, the at least one creator dashboard data includes a plurality of event access options. Further, the at least one creator dashboard data represents a user interface element presenting engagement metrics of the at least one event and the plurality of event access options. Further, the method includes a step of transmitting the at least one creator dashboard data to the at least one client device. Further, the at least one client device is further configured for presenting the at least one creator dashboard data. Further, the method includes a step of receiving at least one access selection for the plurality of event access options from the at least one client device. Further, the step of generating of the at least one streamable data is further based on the at least one access selection.

Further, the method includes a step of receiving at least one viewpoint request data from the at least one client device. Further, the at least one viewpoint request data represents a request for a different viewpoint of the at least one event. Further, the method includes a step of analyzing the at least one viewpoint request data using the at least one event representation data. Further, the generating of the at least one streamable data is further based on the analyzing of the at least one viewpoint request. Further, the step of generating of the at least one streamable data further includes a step of generating at least one alternate viewpoint data representing the different viewpoint based on the analyzing of the at least one viewpoint request data.

Further, the method includes a step of receiving at least one social interaction data from the at least one client device. Further, the at least one social interaction data is associated with a social interaction of the at least one client with a plurality of clients streaming the at least one event. Further, the method includes a step of analyzing the at least one social interaction data. Further, the generating of the at least one streamable data is further based on the analyzing of the at least one social interaction data. Further, the generating of the at least one streamable data further comprises generating at least one interactive streamable data representing a social presence of the at least one client in the at least one event based on the analyzing of the at least one social interaction data.

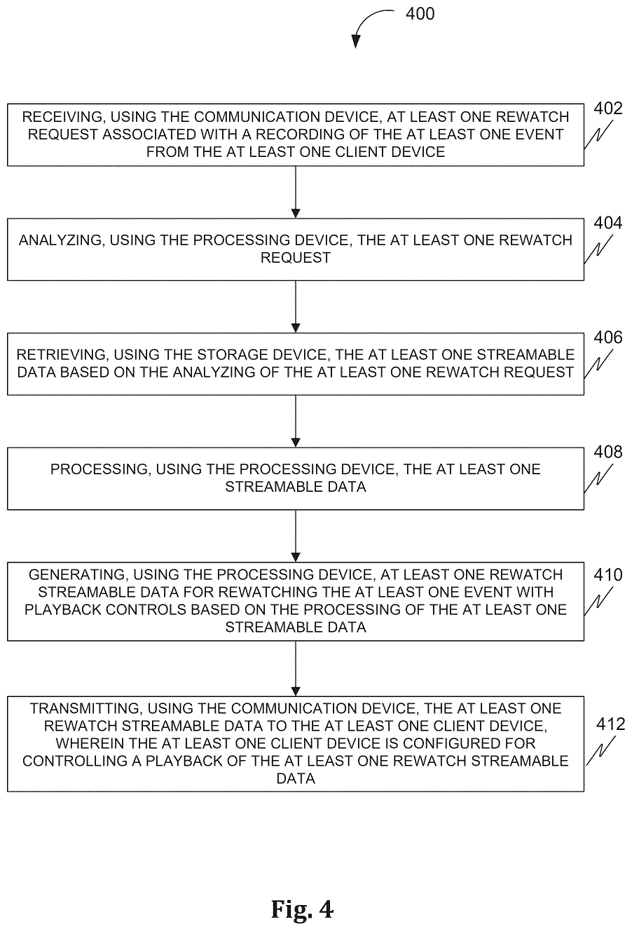

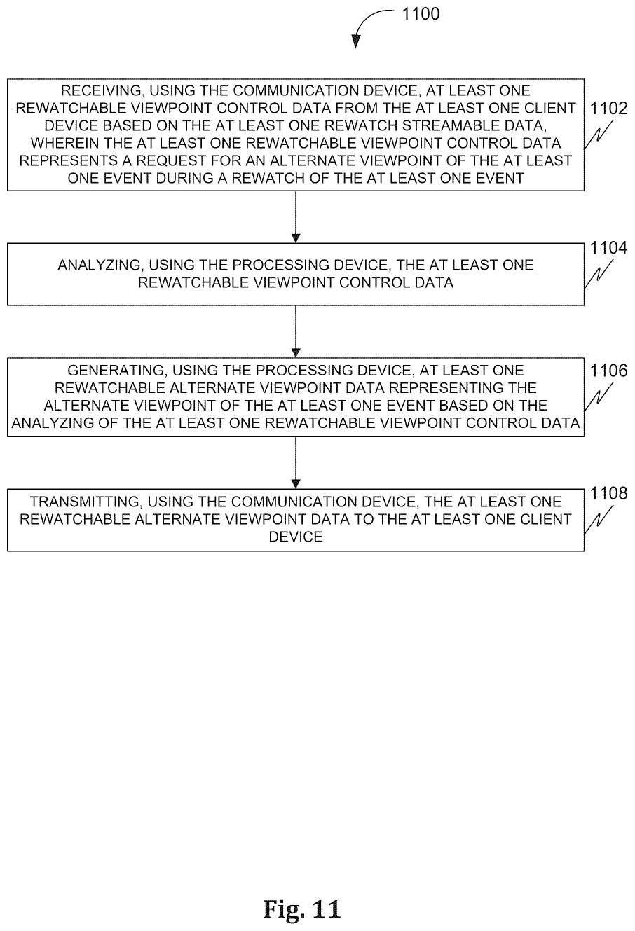

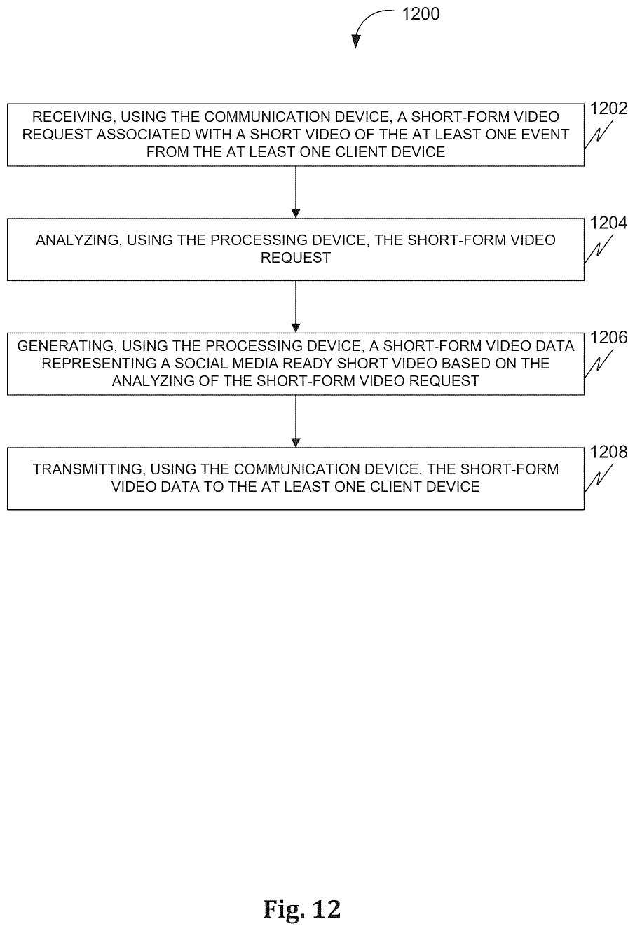

Further, FIG. 4, FIG. 11, and FIG. 12 describe a feature of rewatch and replay. Further, the feature of rewatch and replay includes receiving rewatch requests, generating rewatchable streamable data with playback controls, generating rewatchable alternate viewpoints, and generating short-form video clips.

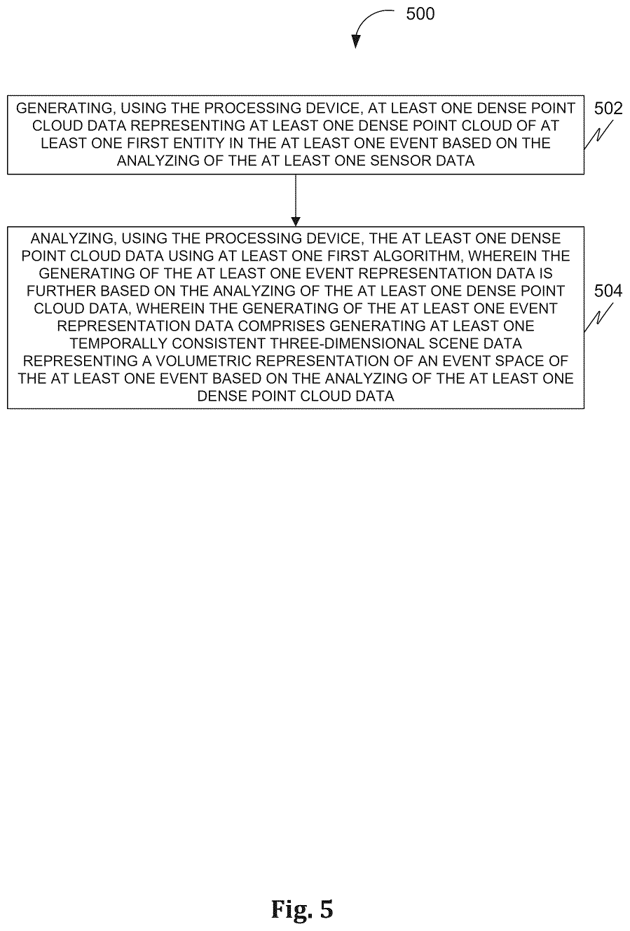

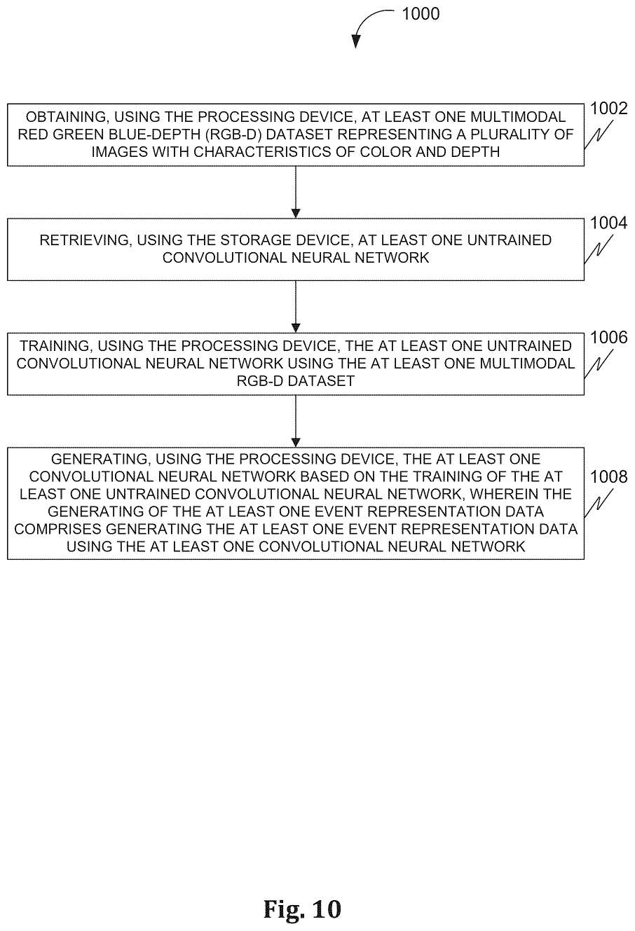

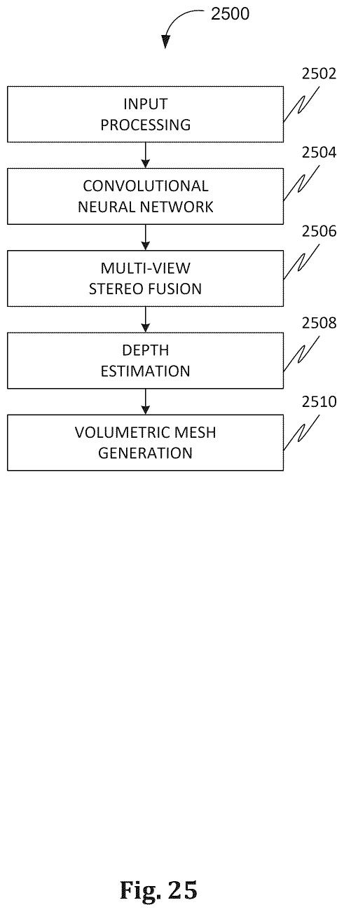

Further, FIG. 5, FIG. 10, and FIG. 25 describe a feature of dense point clouds and artificial intelligence (AI) reconstruction. The feature includes generating a dense point cloud data, training convolutional neural networks (CNNs) with multimodal Red-Green-Blue-Depth (RGB-D) datasets, and generating volumetric meshes.

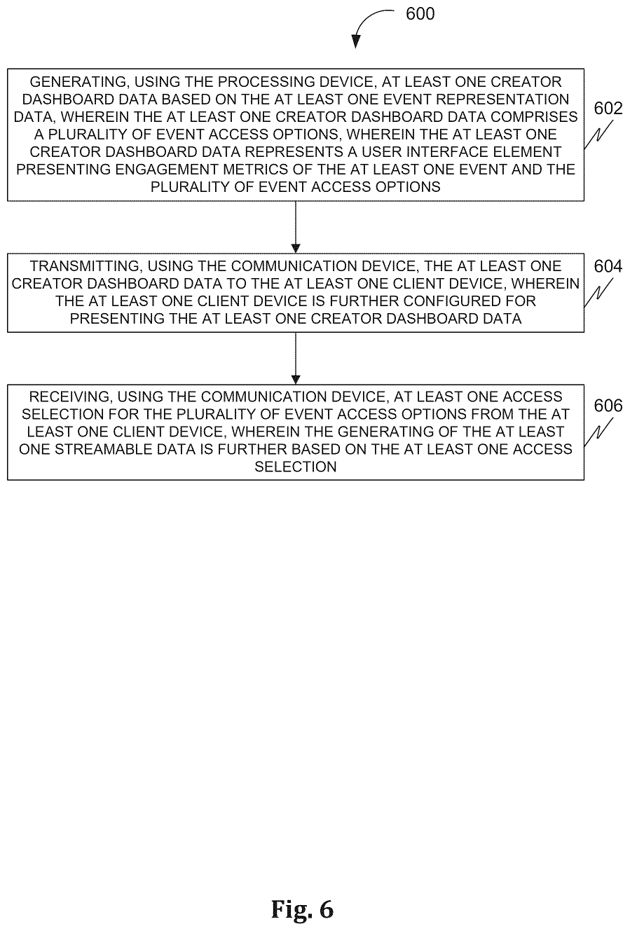

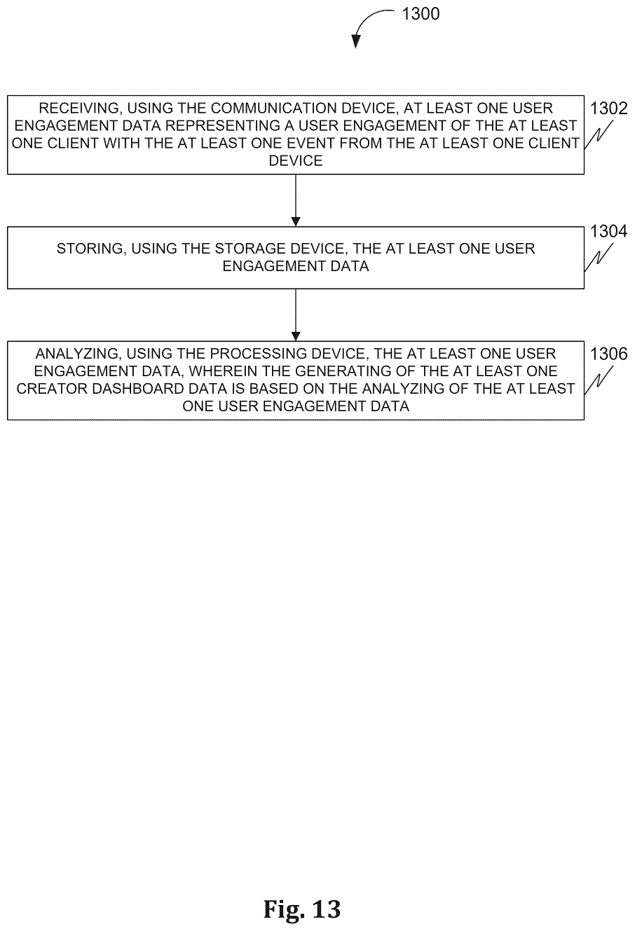

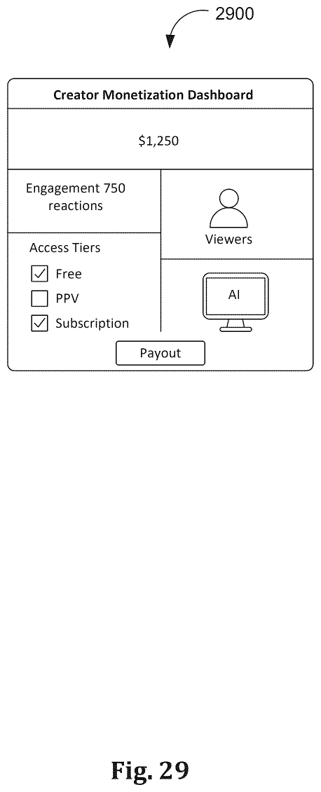

Further, FIG. 6, FIG. 13, and FIG. 29 describe a feature of a creator dashboard and engagement analytics. The feature includes transmitting creator dashboard data with event access options, analyzing user engagement data, and generating monetization dashboards with access tiers.

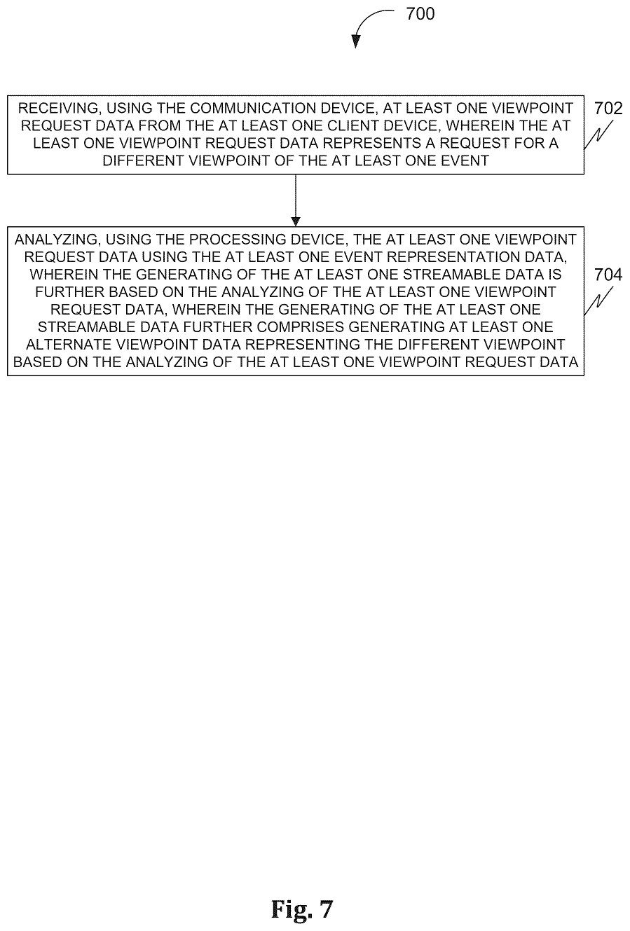

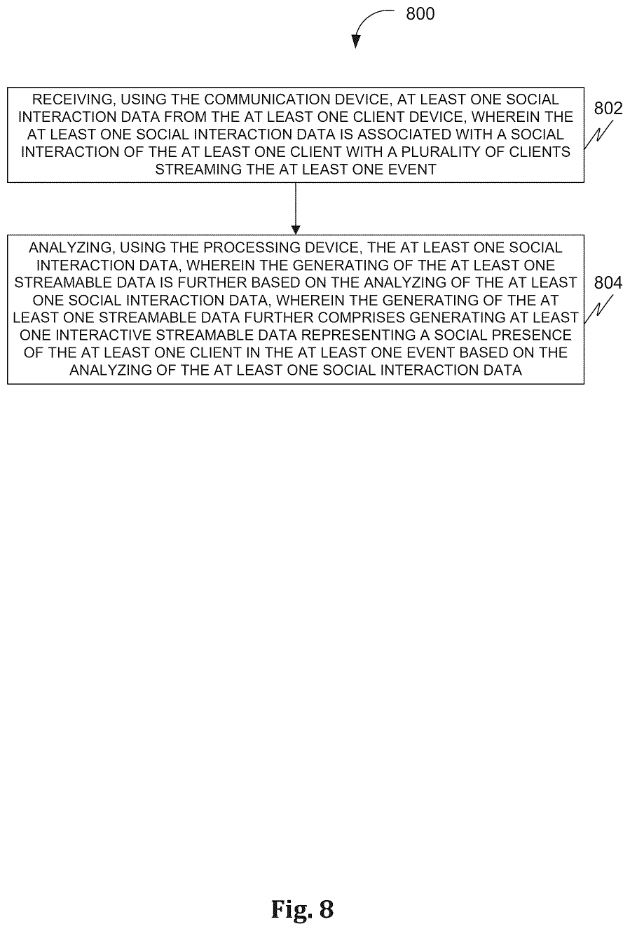

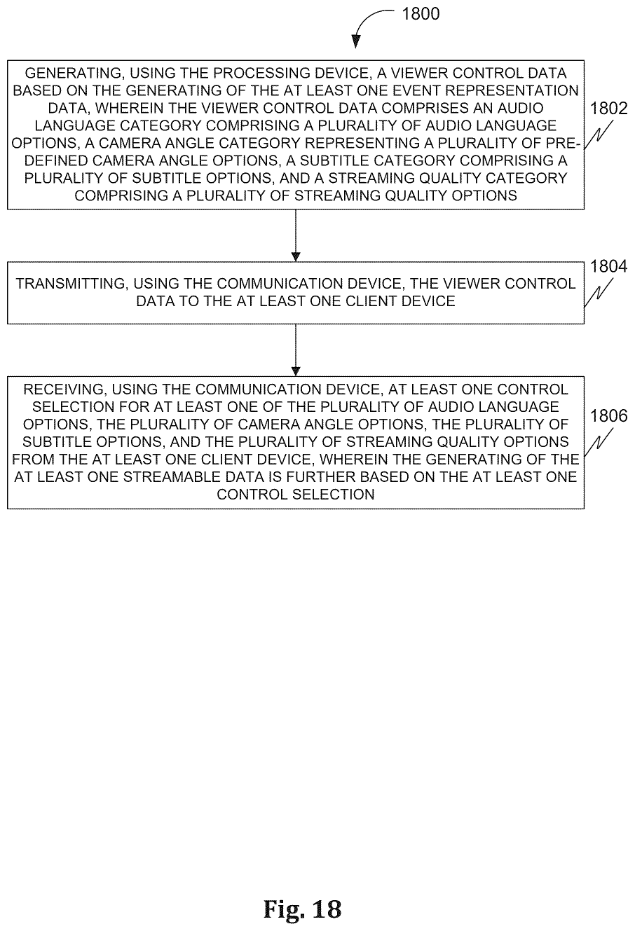

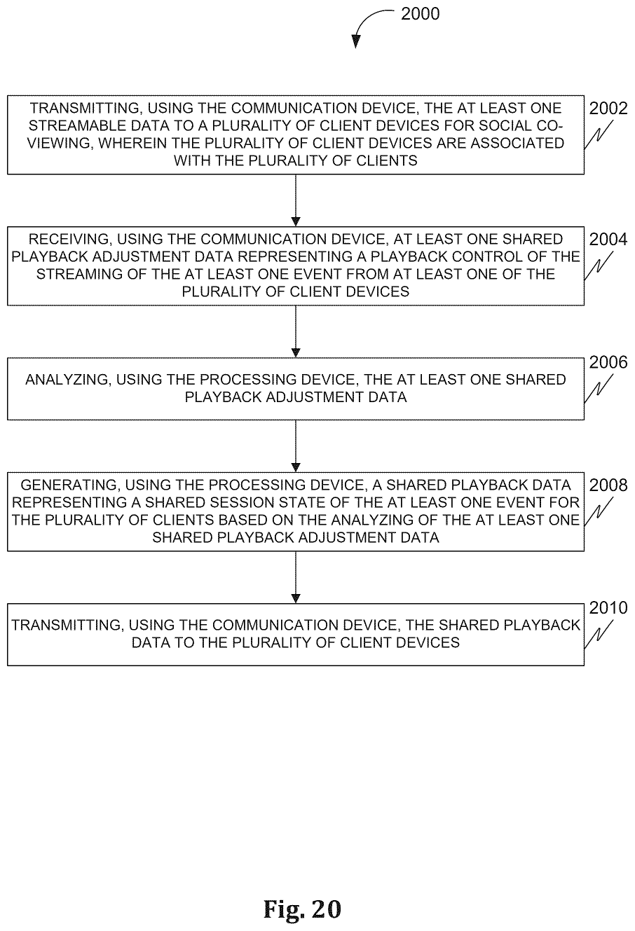

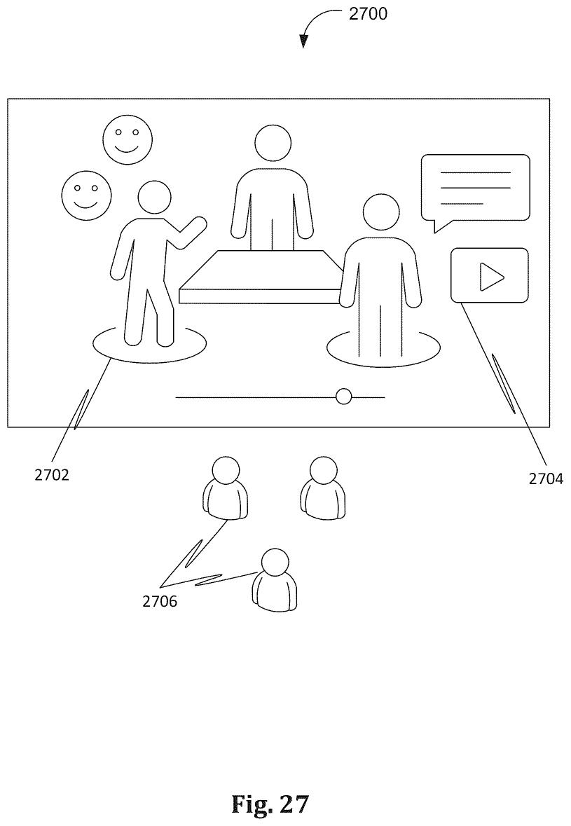

Further, FIG. 7, FIG. 8, FIG. 18, FIG. 20, and FIG. 27 describe a feature of viewpoint and interactive controls. The feature includes processing viewpoint requests, generating alternate viewpoint data, generating interactive streamable data, generating viewer control data, and generating shared playback session states.

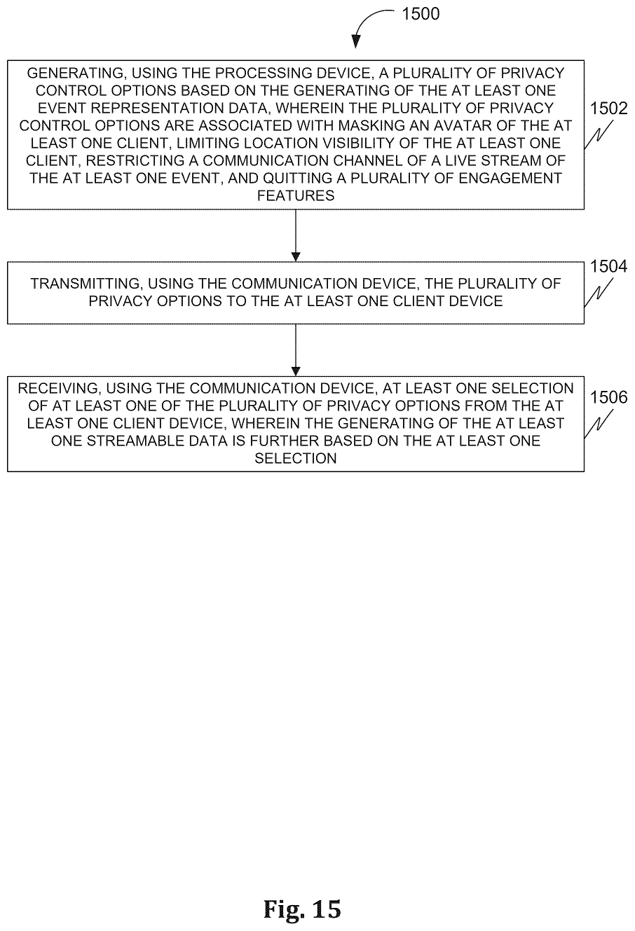

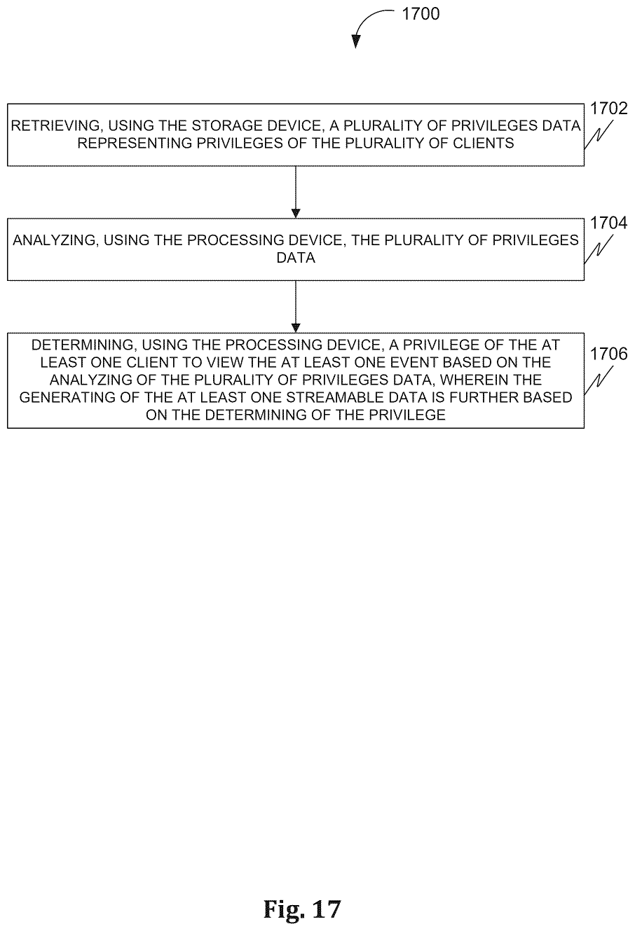

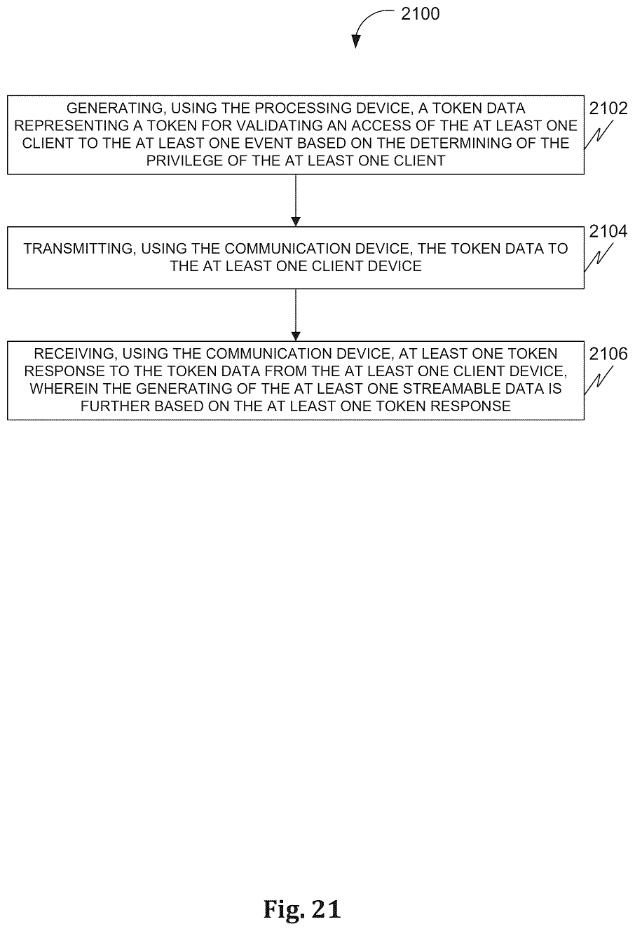

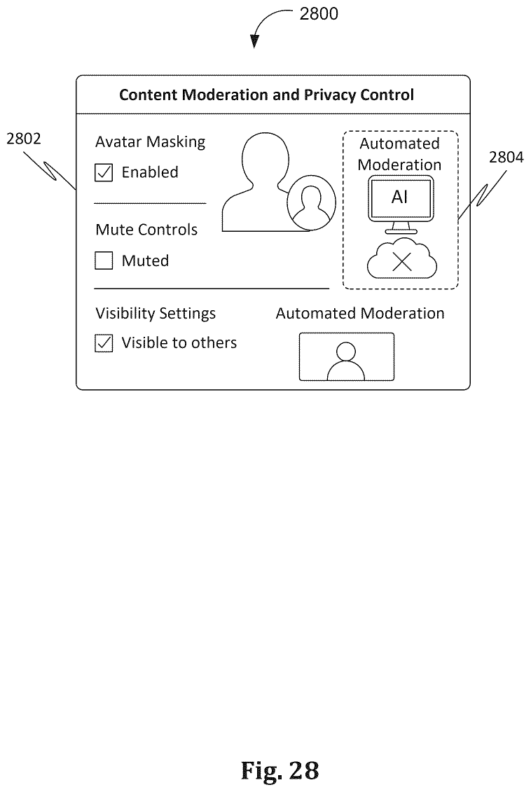

Further, FIG. 15, FIG. 17, FIG. 21, and FIG. 28 describe a feature of privacy, privileges, and tokens. The feature includes generating privacy control options, analyzing privileges data, generating and validating tokens, and performing avatar masking and moderation.

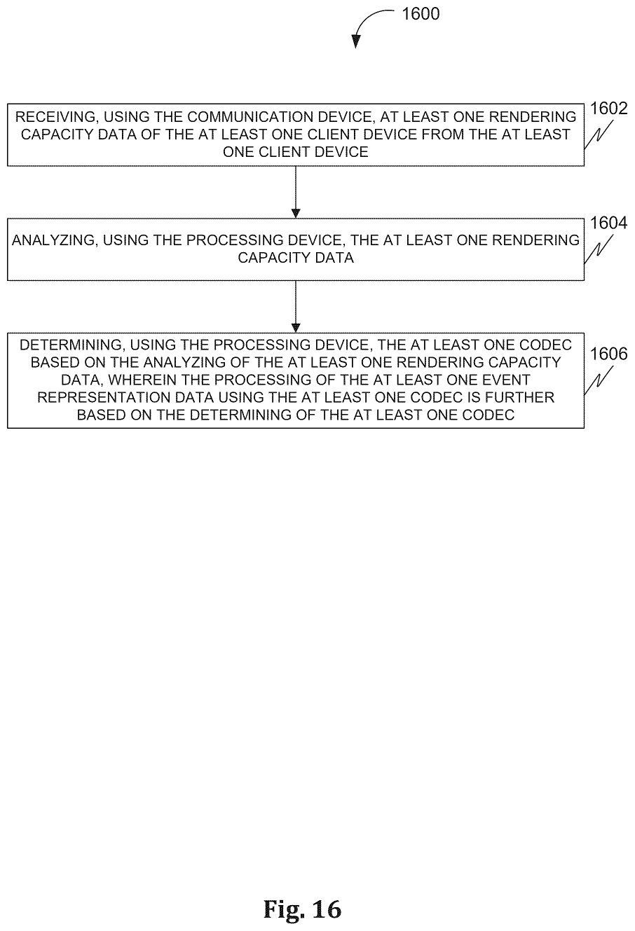

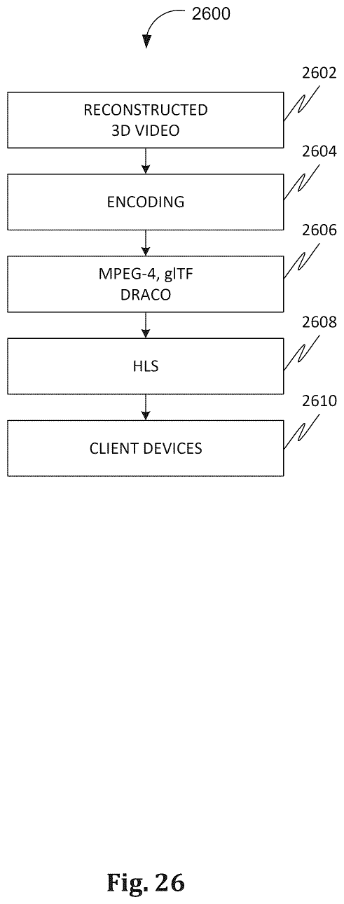

Further, FIG. 16 and FIG. 26 describe a feature of device adaptation and codecs. The feature includes analyzing rendering capacity data, selecting codecs, and encoding reconstructed video into glTF/Draco or MPEG-4 formats.

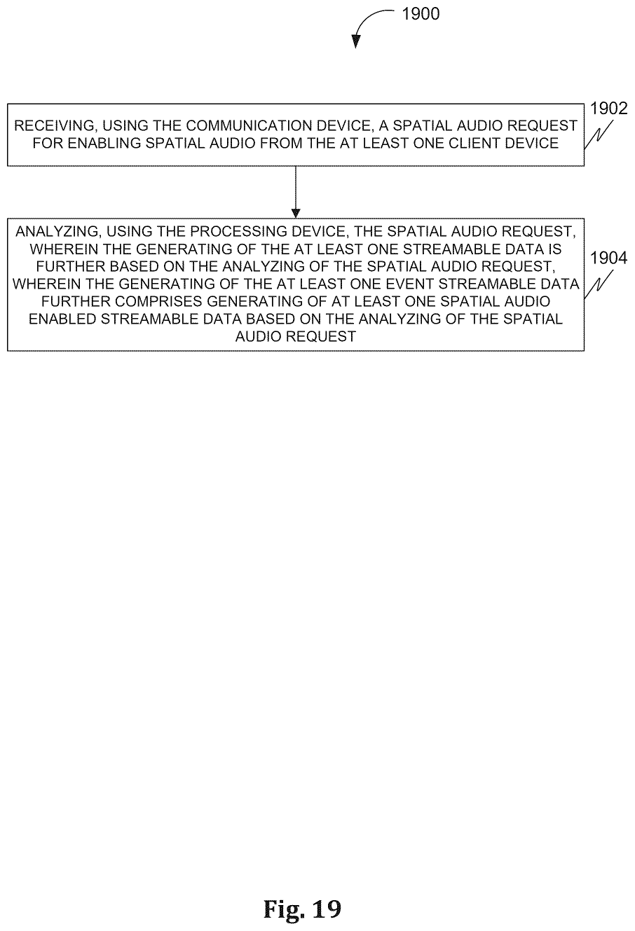

Further, FIG. 19 describes a feature of spatial audio. The feature includes generating spatial audio enabled streamable data.

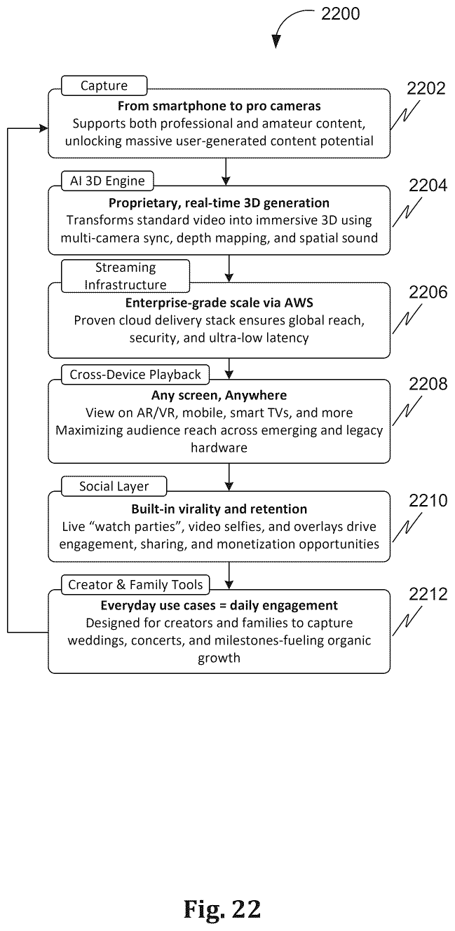

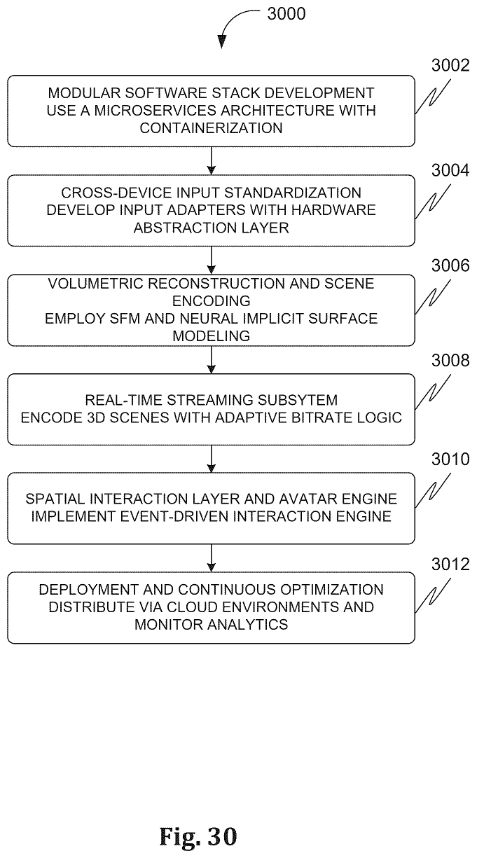

Further, FIG. 22, FIG. 23, FIG. 30, and FIG. 31 describe a feature of architecture and deployment. The feature includes a modular software stack development, a heterogeneous capture input handling, a volumetric reconstruction pipeline, and a Content Delivery Network (CDN)/cloud deployment.

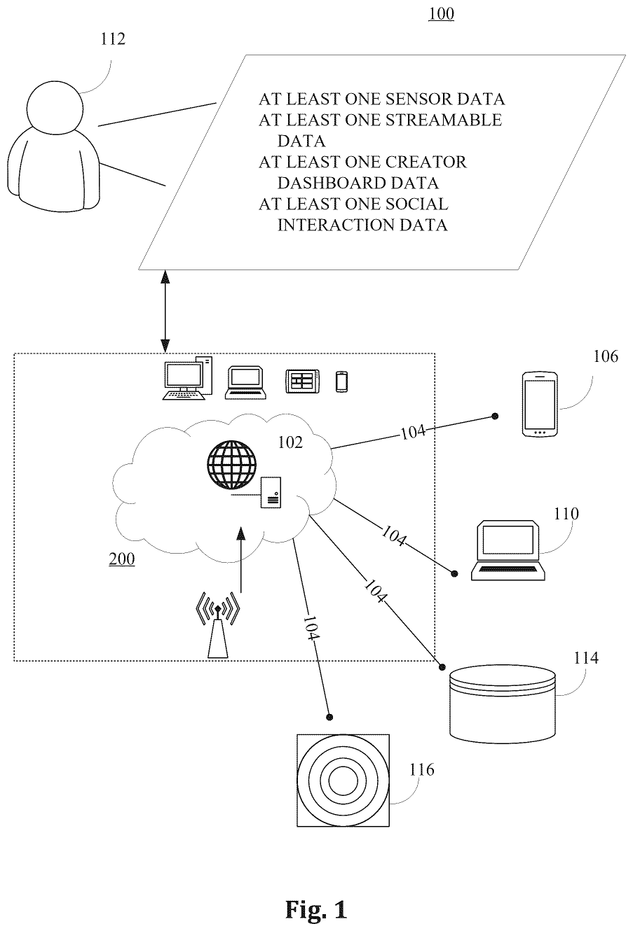

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not limited to, a website, a web application, a desktop application, and a mobile application compatible with a computing device 200.

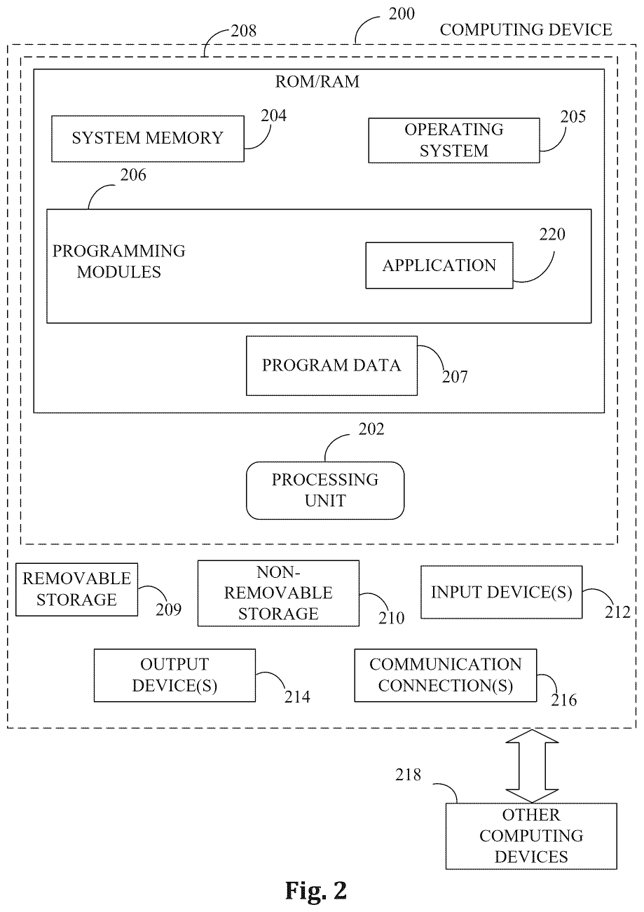

With reference to FIG. 2, a system consistent with an embodiment of the disclosure may include a computing device (i.e., a processing device, a communication device, and a storage device) or cloud service, such as computing device 200. In a basic configuration, computing device 200 may include at least one processing unit (i.e., processor) 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing modules and machine learning modules. Furthermore, embodiments of the disclosure may be practiced in conjunction with a graphics library, other operating systems, or any other application program, and are not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214, such as a display, speakers, a printer, etc., may also be included. The aforementioned devices are examples, and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations, such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

FIG. 3 illustrates a flowchart of a method 300 of facilitating streaming of events, in accordance with some embodiments.

Accordingly, the method 300 may include a step 302 of receiving, using a communication device 902, one or more sensor data from one or more sensors. Further, the one or more sensors 908 may be configured for generating the one or more sensor data by capturing one or more events. Further, the method 300 may include a step 304 of analyzing, using a processing device 904, the one or more sensor data. Further, the method 300 may include a step 306 of generating, using the processing device 904, one or more event representation data representing a virtual reconstruction of the one or more events based on the analyzing of the one or more sensor data. Further, the method 300 may include a step 308 of processing, using the processing device 904, the one or more event representation data. Further, the method 300 may include a step 310 of generating, using the processing device 904, one or more streamable data for streaming the one or more events based on the processing of the one or more event representation data. Further, the method 300 may include a step 312 of storing, using a storage device 906, the one or more streamable data. Further, the method 300 may include a step 314 of transmitting, using the communication device 902, the one or more streamable data to one or more client devices 910 associated with one or more clients. Further, the one or more client devices 910 may be configured for presenting the one or more streamable data.

Further, in some embodiments, the one or more sensor data may include one or more video data. Further, the capturing of the one or more events may include capturing a live event in 360-degree 3D, encompassing people and objects in motion, ambient light, and spatial sound in real-time. Further, the analyzing of the one or more sensor data may include merging one or more images and one or more scenes into a 3D volume, performing 3D reconstruction, etc. Further, the one or more event representation data may include a dynamic 3D, a reconstructed 3D content. Further, the one or more streamable data may include a volumetric 3D video content. Further, the one or more streamable may include free-viewpoint 3D scenes. Further, the one or more sensors 908 may include heterogeneous video input sources, depth-sensing cameras, 360° and 180° VR cameras, volumetric capture rigs, an array of active 3D stereo depth cameras, ambisonic microphones, etc. Further, the one or more client devices 910 may include smartphones, tablets, web browsers, smart TVs, and MR/VR headsets. Further, the processing device may include a capture subsystem, an AI reconstruction pipeline, a compression and encoding module, a device agnostic streaming engine, a streaming module, a synchronization module, and an interactive engagement layer. Further, the processing device may include a computing device, a processor, a processing unit, a graphics processing unit (GPU), a central processing unit (CPU), etc. Further, the communication device may include a communication interface. Further, the storage device may include a memory.

In some embodiments, the generating of the one or more event representation data includes generating the one or more event representation data using one or more artificial intelligence models for scene understanding and reconstruction of the one or more events. Further, the processing of the one or more event representation data may be further based on the generating of the one or more event representation data using the one or more artificial intelligence models.

Further, in some embodiments, the one or more artificial intelligence models may apply artificial intelligence (AI) and depth-aware computer vision techniques. Further, the one or more artificial intelligence models may include convolutional neural networks (CNNs), etc.

FIG. 4 illustrates a flowchart of a method 400 of facilitating streaming of events including generating, using the processing device 904, at least one rewatch streamable data for rewatching the at least one event with playback controls, in accordance with some embodiments.

Further, in some embodiments, the method 400 may include a step 402 of receiving, using the communication device 902, one or more rewatch requests associated with a recording of the one or more events from the one or more client devices 910. Further, in some embodiments, the method 400 may include a step 404 of analyzing, using the processing device 904, the one or more rewatch requests. Further, in some embodiments, the method 400 may include a step 406 of retrieving, using the storage device 906, the one or more streamable data based on the analyzing of the one or more rewatch requests. Further, in some embodiments, the method 400 may include a step 408 of processing, using the processing device 904, the one or more streamable data. Further, in some embodiments, the method 400 may include a step 410 of generating, using the processing device 904, one or more rewatch streamable data for rewatching the one or more events with playback controls based on the processing of the one or more streamable data. Further, in some embodiments, the method 400 may include a step 412 of transmitting, using the communication device 902, the one or more rewatch streamable data to the one or more client devices 910. Further, the one or more client devices 910 may be configured for controlling a playback of the one or more rewatch streamable data.

Further, in some embodiments, the processing of the one or more event representation data may include a step of compressing the one or more event representation data. Further, the processing of the one or more event representation data may include a step of encoding the one or more event representation data using an adaptive bitrate encoding technique based on the compressing of the one or more event representation data. Further, the generating of the one or more streamable data may be further based on the encoding of the one or more event representation data.

In some embodiments, the transmitting of the one or more streamable data further includes transmitting the one or more streamable data using one or more protocols.

FIG. 5 illustrates a flowchart of a method 500 of facilitating streaming of events including analyzing, using the processing device 904, the at least one dense point cloud data using at least one first algorithm, in accordance with some embodiments.

Further, in some embodiments, the method 500 may include a step 502 of generating, using the processing device 904, one or more dense point cloud data representing one or more dense point clouds of one or more first entities in the one or more events based on the analyzing of the one or more sensor data. Further, in some embodiments, the method 500 may include a step 504 of analyzing, using the processing device 904, the one or more dense point cloud data using one or more first algorithms. Further, the generating of the one or more event representation data may be further based on the analyzing of the one or more dense point cloud data. Further, the generating of the one or more event representation data includes generating one or more temporally consistent three-dimensional scene data representing a volumetric representation of an event space of the one or more events based on the analyzing of the one or more dense point cloud data.

In some embodiments, the processing of the one or more event representation data further includes processing the one or more event representation data using one or more codecs.

FIG. 6 illustrates a flowchart of a method 600 of facilitating streaming of events including receiving, using the communication device 902, at least one access selection for a plurality of event access options from the at least one client device 910, in accordance with some embodiments.

Further, in some embodiments, the method 600 may include a step 602 of generating, using the processing device 904, one or more creator dashboard data based on the one or more event representation data. Further, the one or more creator dashboard data includes two or more event access options. Further, the one or more creator dashboard data represents a user interface element presenting engagement metrics of the one or more events and the two or more event access options. Further, in some embodiments, the method 600 may include a step 604 of transmitting, using the communication device 902, the one or more creator dashboard data to the one or more client devices 910. Further, the one or more client devices 910 may be further configured for presenting the one or more creator dashboard data. Further, in some embodiments, the method 600 may include a step 606 of receiving, using the communication device 902, one or more access selections for the two or more event access options from the one or more client devices 910. Further, the generating of the one or more streamable data may be further based on the one or more access selections.

FIG. 7 illustrates a flowchart of a method 700 of facilitating streaming of events including analyzing, using the processing device 904, the at least one viewpoint request data using the at least one event representation data, in accordance with some embodiments.

Further, in some embodiments, the method 700 may include a step 702 of receiving, using the communication device 902, one or more viewpoint request data from the one or more client devices 910. Further, the one or more viewpoint request data represents a request for a different viewpoint of the one or more events. Further, in some embodiments, the method 700 may include a step 704 of analyzing, using the processing device 904, the one or more viewpoint request data using the one or more event representation data. Further, the generating of the one or more streamable data may be further based on the analyzing of the one or more viewpoint request data. Further, the generating of the one or more streamable data further includes generating one or more alternate viewpoint data representing the different viewpoints based on the analyzing of the one or more viewpoint request data.

FIG. 8 illustrates a flowchart of a method 800 of facilitating streaming of events including analyzing, using the processing device 904, at least one social interaction data, in accordance with some embodiments.

Further, in some embodiments, the method 800 may include a step 802 of receiving, using the communication device 902, one or more social interaction data from the one or more client devices 910. Further, the one or more social interaction data may be associated with a social interaction of the one or more clients with two or more clients streaming the one or more events. Further, in some embodiments, the method 800 may include a step 804 of analyzing, using the processing device 904, the one or more social interaction data. Further, the generating of the one or more streamable data may be further based on the analyzing of the one or more social interaction data. Further, the generating of the one or more streamable data further includes generating one or more interactive streamable data representing a social presence of the one or more clients in the one or more events based on the analyzing of the one or more social interaction data.

FIG. 9 illustrates a block diagram of a system 900 for facilitating streaming of events, in accordance with some embodiments.

Accordingly, the system 900 may include a communication device 902. Further, the communication device 902 may be configured for receiving one or more sensor data from one or more sensors 908. Further, the one or more sensors 908 may be configured for generating the one or more sensor data by capturing one or more events. Further, the communication device 902 may be configured for transmitting one or more streamable data to one or more client devices 910 associated with one or more clients. Further, the one or more client devices 910 may be configured for presenting the one or more streamable data. Further, the system 900 may include a processing device 904 communicatively coupled to the communication device 902. Further, the processing device 904 may be configured for analyzing the one or more sensor data. Further, the processing device 904 may be configured for generating one or more event representation data representing a virtual reconstruction of the one or more events based on the analyzing of the one or more sensor data. Further, the processing device 904 may be configured for processing the one or more event representation data. Further, the processing device 904 may be configured for generating the one or more streamable data for streaming the one or more events based on the processing of the one or more event representation data. Further, the system 900 may include a storage device 906 communicatively coupled to the processing device 904. Further, the storage device 906 may be configured for storing the one or more streamable data.

In some embodiments, the generating of the one or more event representation data includes generating the one or more event representation data using one or more artificial intelligence models for scene understanding and reconstruction of the one or more events. Further, the processing of the one or more event representation data may be further based on the generating of the one or more event representation data using the one or more artificial intelligence models.

Further, in some embodiments, the communication device 902 may be further configured for receiving one or more rewatch requests associated with a recording of the one or more events from the one or more client devices 910. Further, the communication device 902 may be further configured for transmitting one or more rewatch streamable data to the one or more client devices 910. Further, the one or more client devices 910 may be configured for controlling a playback of the one or more rewatch streamable data. Further, the processing device 904 may be further configured for analyzing the one or more rewatch requests. Further, the processing device 904 may be further configured for processing the one or more streamable data. Further, the processing device 904 may be further configured for generating the one or more rewatch streamable data for rewatching the one or more events with playback controls based on the processing of the one or more streamable data. Further, the storage device 906 may be further configured for retrieving the one or more streamable data based on the analyzing of the one or more rewatch requests.

Further, in some embodiments, the processing of the one or more event representation data may include compressing the one or more event representation data. Further, the processing of the one or more event representation data may include encoding the one or more event representation data using an adaptive bitrate encoding technique based on the compressing of the one or more event representation data. Further, the generating of the one or more streamable data may be further based on the encoding of the one or more event representation data.

In some embodiments, the transmitting of the one or more streamable data further includes transmitting the one or more streamable data using one or more protocols.

Further, in some embodiments, the processing device 904 may be further configured for generating one or more dense point cloud data representing one or more dense point clouds of one or more first entities in the one or more events based on the analyzing of the one or more sensor data. Further, the processing device 904 may be further configured for analyzing the one or more dense point cloud data using one or more first algorithms. Further, the generating of the one or more event representation data may be further based on the analyzing of the one or more dense point cloud data. Further, the generating of the one or more event representation data includes generating at least one temporally consistent three-dimensional scene data representing a volumetric representation of an event space of the one or more events based on the analyzing of the one or more dense point cloud data.

In some embodiments, the processing of the one or more event representation data further includes processing the one or more event representation data using one or more codecs.

Further, in some embodiments, the processing device 904 may be further configured for generating one or more creator dashboard data based on the one or more event representation data. Further, the one or more creator dashboard data may include two or more event access options. Further, the one or more creator dashboard data represents a user interface element presenting engagement metrics of the one or more events and the two or more event access options. Further, the communication device 902 may be further configured for transmitting the one or more creator dashboard data to the one or more client devices 910. Further, the one or more client devices 910 may be further configured for presenting the one or more creator dashboard data. Further, the one or more creator dashboard data may include two or more event access options. Further, the communication device 902 may be further configured for receiving one or more access selections for the two or more event access options from the one or more client devices 910. Further, the generating of the one or more streamable data may be further based on the one or more access selections.

In some embodiments, the communication device 902 may be further configured for receiving one or more viewpoint request data from the one or more client devices 910. Further, the one or more viewpoint request data represents a request for a different viewpoint of the one or more events. Further, the processing device 904 may be further configured for analyzing the one or more viewpoint request data using the one or more event representation data. Further, the generating of the one or more streamable data may be further based on the analyzing of the one or more viewpoint request data. Further, the generating of the one or more streamable data further includes generating one or more alternate viewpoint data representing the different viewpoint based on the analyzing of the one or more viewpoint request data.

In some embodiments, the communication device 902 may be further configured for receiving one or more social interaction data from the one or more client devices 910. Further, the one or more social interaction data may be associated with a social interaction of the one or more clients with two or more clients streaming the one or more events. Further, the processing device 904 may be further configured for analyzing the one or more social interaction data. Further, the generating of the one or more streamable data may be further based on the analyzing of the one or more social interaction data. Further, the generating of the one or more streamable data further includes generating one or more interactive streamable data representing a social presence of the one or more clients in the one or more events based on the analyzing of the one or more social interaction data.

In some embodiments, the analyzing of the one or more sensor data further includes analyzing the one or more sensor data using one or more depth estimation techniques. Further, the generating of the one or more event representation data may be further based on the analyzing of the one or more sensor data using the one or more depth estimation techniques.

In some embodiments, the one or more artificial intelligence models include one or more convolutional neural networks.

FIG. 10 illustrates a flowchart of a method 1000 of facilitating streaming of events including generating, using the processing device 904, at least one convolutional neural network, in accordance with some embodiments.

Further, in some embodiments, the method 1000 may include a step 1002 of obtaining, using the processing device 904, one or more multimodal Red Green Blue-Depths (RGB-D) datasets representing two or more images with characteristics of color and depth. Further, in some embodiments, the method 1000 may include a step 1004 of retrieving, using the storage device 906, one or more untrained convolutional neural networks. Further, in some embodiments, the method 1000 may include a step 1006 of training, using the processing device 904, the one or more untrained convolutional neural networks using the one or more multimodal RGB-D datasets. Further, in some embodiments, the method 1000 may include a step 1008 of generating, using the processing device 904, the one or more convolutional neural networks based on the training of the one or more untrained convolutional neural networks. Further, the generating of the one or more event representation data includes generating the one or more event representation data using the one or more convolutional neural networks.

In some embodiments, the one or more convolutional neural networks may be configured for predicting a geometry of an event space associated with the one or more events, and a motion of one or more moving entities in the one or more events.

In some embodiments, the transmitting of the one or more streamable data further includes transmitting the one or more streamable data using one or more content delivery networks.

In some embodiments, the transmitting of the one or more streamable data further includes transmitting the one or more streamable data using an adaptive streaming technology.

In some embodiments, the analyzing of the one or more sensor data includes analyzing one or more physical image data representing an image of the one or more events. Further, the generating of the one or more event representation data further includes generating a spatial mesh of the one or more entities based on the analyzing of the one or more physical image data.

In some embodiments, the analyzing of the one or more physical image data includes scanning the one or more physical image data as one or more dense three-dimensional point clouds.

In some embodiments, the analyzing of the one or more sensor data further includes analyzing each of a first camera data representing a field of view from a first camera and a second camera data representing a field of view from a second camera. Further, the generating of the spatial mesh includes generating an updated spatial mesh based on the analyzing of each of the first camera data and the second camera data. Further, the one or more sensors 908 include the first camera and the second camera.

In some embodiments, the one or more first algorithms may be a proprietary three-dimensional multi-view dynamic reconstruction algorithm.

In some embodiments, the generating of the one or more event representation data further includes generating one or more depth data representing a depth of the one or more first entities from the one or more sensors 908 using one or more second algorithms based on the analyzing of the one or more sensor data.

In some embodiments, the one or more second algorithms include one or more consistent online dynamic depth algorithms.

In some embodiments, the one or more second algorithms may be configured for fusing a stereo network, a motion network, and a fusion network. Further, the generating of the one or more event representation data may be further based on the fusing of the stereo network, the motion network, and the fusion network.

In some embodiments, the stereo network represents a deep learning model for processing a stereo image of the one or more events.

In some embodiments, the motion network represents a neural network for predicting a motion of the one or more first entities.

In some embodiments, the fusion network represents an architecture for combining two or more multimodal data. Further, the one or more sensor data includes the two or more multimodal data.

In some embodiments, the generating of the one or more event representation data further includes generating one or more color-texture data representing a color and texture of the one or more entities based on the analyzing of the one or more sensor data.

In some embodiments, the analyzing of the one or more sensor data further includes analyzing two or more video stream data using one or more of a spatial calibration algorithm and a frame timecode alignment algorithm. Further, the generating of the one or more event representation data further includes generating one or more fused video stream data representing a panoramic view of the one or more events based on the analyzing of the two or more video stream data.

In some embodiments, the method 800 may further include analyzing, using the processing device 904, the one or more event representation data using one or more artificial intelligence content moderation models. Further, the generating of the one or more streamable data may be further based on the analyzing of the one or more event representation data using the one or more artificial intelligence content moderation models.

In some embodiments, the one or more interactive streamable data includes one or more of a video overlay data representing an video content overlaid on the one or more streamable data, an emoji overlay data representing an emoji overlaid on the one or more streamable data, a voice overlay data representing a voice overlaid on the one or more streamable data, and a text overlay data representing a text overlaid on the one or more streamable data.

In some embodiments, the one or more interactive streamable data includes a masked streamable data representing a concealed appearance of the one or more clients in the one or more events.

In some embodiments, the one or more interactive streamable data includes a muted streamable data representing a muted audio of the one or more clients in the one or more events.

FIG. 11 illustrates a flowchart of a method 1100 of facilitating streaming of events including generating, using the processing device 904, at least one rewatchable alternate viewpoint data representing an alternate viewpoint of the at least one event, in accordance with some embodiments.

Further, in some embodiments, the method 1100 may include a step 1102 of receiving, using the communication device 902, one or more rewatchable viewpoint control data from the one or more client devices 910 based on the one or more rewatch streamable data. Further, the one or more rewatchable viewpoint control data may represent a request for the alternate viewpoint of the one or more events during a rewatch of the one or more events. Further, in some embodiments, the method 1100 may include a step 1104 of analyzing, using the processing device 904, the one or more rewatchable viewpoint control data. Further, in some embodiments, the method 1100 may include a step 1106 of generating, using the processing device 904, one or more rewatchable alternate viewpoint data representing the alternate viewpoint of the one or more events based on the analyzing of the one or more rewatchable viewpoint control data. Further, in some embodiments, the method 1100 may include a step 1108 of transmitting, using the communication device 902, the one or more rewatchable alternate viewpoint data to the one or more client devices 910.

In some embodiments, the one or more interactive streamable data includes an avatar data representing a virtual reality avatar of the one or more clients present in the one or more events.

FIG. 12 illustrates a flowchart of a method 1200 of facilitating streaming of events including generating, using the processing device 904, a short-form video data representing a social media ready short video, in accordance with some embodiments.

Further, in some embodiments, the method 1200 may include a step 1202 of receiving, using the communication device 902, a short-form video request associated with a short video of the one or more events from the one or more client devices 910. Further, in some embodiments, the method 1200 may include a step 1204 of analyzing, using the processing device 904, the short-form video request. Further, in some embodiments, the method 1200 may include a step 1206 of generating, using the processing device 904, the short-form video data representing a social media ready short video based on the analyzing of the short-form video request. Further, in some embodiments, the method 1200 may include a step 1208 of transmitting, using the communication device 902, the short-form video data to the one or more client devices 910.

In some embodiments, the one or more protocols include an adaptive bitrate streaming protocol which may be configured for transmitting the one or more streamable data based on a real-time bandwidth estimation.

FIG. 13 illustrates a flowchart of a method 1300 of facilitating streaming of events including analyzing, using the processing device 904, the at least one user engagement data, in accordance with some embodiments.

Further, in some embodiments, the method 1300 may include a step 1302 of receiving, using the communication device 902, one or more user engagement data representing a user engagement of the one or more clients with the one or more events from the one or more client devices 910. Further, in some embodiments, the method 1300 may include a step 1304 of storing, using the storage device 906, the one or more user engagement data. Further, in some embodiments, the method 1300 may include a step 1306 of analyzing, using the processing device 904, the one or more user engagement data. Further, the generating of the one or more creator dashboard data may be based on the analyzing of the one or more user engagement data.

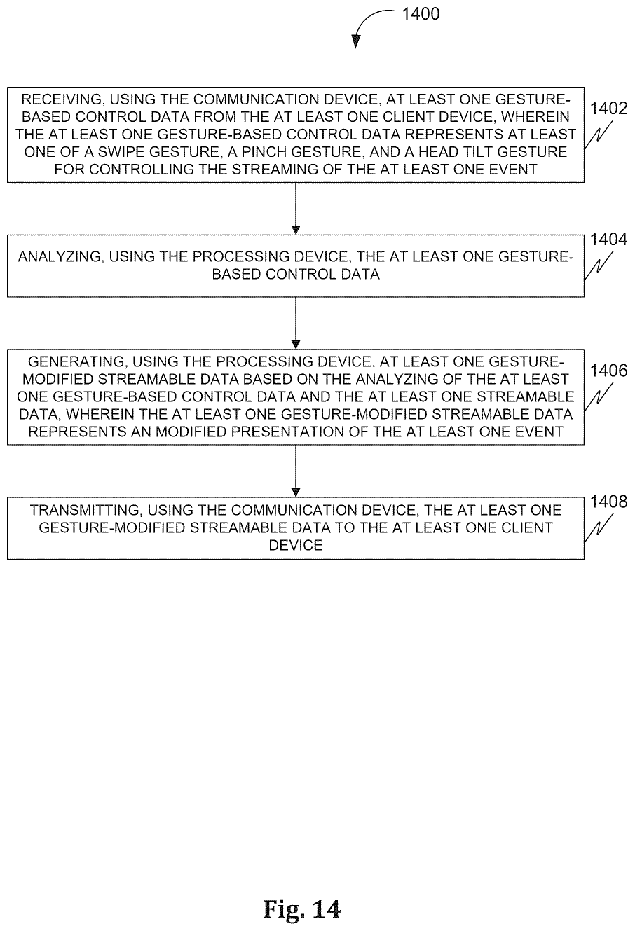

FIG. 14 illustrates a flowchart of a method 1400 of facilitating streaming of events including generating, using the processing device 904, at least one gesture-modified streamable data, in accordance with some embodiments.

Further, in some embodiments, the method 1400 may include a step 1402 of receiving, using the communication device 902, one or more gesture-based control data from the one or more client devices 910. Further, the one or more gesture-based control data represents one or more of a swipe gesture, a pinch gesture, and a head tilt gesture for controlling the streaming of the one or more events. Further, in some embodiments, the method 1400 may include a step 1404 of analyzing, using the processing device 904, the one or more gesture-based control data. Further, in some embodiments, the method 1400 may include a step 1406 of generating, using the processing device 904, one or more gesture-modified streamable data based on the analyzing of the one or more gesture-based control data. Further, the one or more gesture-modified streamable data represent a modified presentation of the one or more events. Further, in some embodiments, the method 1400 may include a step 1408 of transmitting, using the communication device 902, the one or more gesture-modified streamable data to the one or more client devices 910.

In some embodiments, the analyzing of the one or more social interaction data further includes analyzing the one or more social interaction data using the one or more artificial intelligence content moderation models for automated filtering, community flagging, and manual reviewing of the one or more social interaction data.

FIG. 15 illustrates a flowchart of a method 1500 of facilitating streaming of events including receiving, using the communication device 902, at least one selection of at least one of the plurality of privacy options from the at least one client device 910, in accordance with some embodiments.

Further, in some embodiments, the method 1500 may include a step 1502 of generating, using the processing device 904, two or more privacy control options based on the generating of the one or more event representation data. Further, the two or more privacy control options may be associated with masking an avatar of the one or more clients, limiting location visibility of the one or more clients, restricting a communication channel of a live stream of the one or more events, and quitting two or more engagement features. Further, in some embodiments, the method 1500 may include a step 1504 of transmitting, using the communication device 902, the two or more privacy options to the one or more client devices 910. Further, in some embodiments, the method 1500 may include a step 1506 of receiving, using the communication device 902, one or more selections of one or more of the two or more privacy options from the one or more client devices 910. Further, the generating of the one or more streamable data may be further based on the one or more selections.

FIG. 16 illustrates a flowchart of a method 1600 of facilitating streaming of events including determining, using the processing device 904, the at least one codec, in accordance with some embodiments.

Further, in some embodiments, the method 1600 may include a step 1602 of receiving, using the communication device 902, one or more rendering capacity data of the one or more client devices 910 from the one or more client devices 910. Further, in some embodiments, the method 1600 may include a step 1604 of analyzing, using the processing device 904, the one or more rendering capacity data. Further, in some embodiments, the method 1600 may include a step 1606 of determining, using the processing device 904, the one or more codecs based on the analyzing of the one or more rendering capacity data. Further, the processing of the one or more event representation data using the one or more codecs may be further based on the determining of the one or more codecs.

In some embodiments, the analyzing of the one or more sensor data further includes analyzing the one or more sensor data using one or more of a spatial positioning algorithm and a head tracking support algorithm.

In some embodiments, the generating of the one or more event representation data further includes generating the one or more event representation data using one or more real-time stitching software.

In some embodiments, the generating of the one or more alternate viewpoint data further includes generating the one or more alternate viewpoint data using one or more live switcher software.

In some embodiments, the two or more event access options includes a subscription option representing a subscription plan for subscribing one or more content creators associated with the one or more content creator dashboard data, a pay-per-view option representing an option for viewing the one or more events on a pay-per-view basis, and a free option representing an option of viewing the one or more events on a free of cost basis.

FIG. 17 illustrates a flowchart of a method 1700 of facilitating streaming of events including determining, using the processing device 904, a privilege of the at least one client to view the at least one event, in accordance with some embodiments.

Further, in some embodiments, the method 1700 may include a step 1702 of retrieving, using the storage device 906, two or more data representing privileges of the two or more clients. Further, in some embodiments, the method 1700 may include a step 1704 of analyzing, using the processing device 904, the two or more privileges data. Further, in some embodiments, the method 1700 may include a step 1706 of determining, using the processing device 904, the privilege of the one or more clients to view the one or more events based on the analyzing of the two or more privileges data. Further, the generating of the one or more streamable data may be further based on the determining of the privilege.

In some embodiments, the method 300 may further include encrypting, using the processing device 904, the one or more streamable data using one or more security protocols based on the generating of the one or more streamable data.

In some embodiments, the method 300 may further include generating, using the processing device 904, one or more digital collectible data representing a non-fungible token associated with the one or more events based on the processing of the one or more event representation data.

In some embodiments, the one or more protocols further include one or more of a HTTPS Live Streaming protocol, a Real Time Messaging Protocol, and a Real Time Streaming Protocol.

In some embodiments, the transmitting of the one or more streamable data further includes transmitting the one or more streamable data using one or more fifth generation cellular networks.

In some embodiments, the one or more sensors 908 includes one or more of one or more active three-dimensional red-blue-green cameras, one or more near infrared cameras, one or more stereoscopic cameras, one or more stereo smartphones, one or more webcams, one or more duals lens webcam, one or more volumetric capture rigs, one or more drone cams, one or more Light detections and Ranging (LiDAR) system, one or more times of flight system, one or more 180 degree Virtual Reality cameras, one or more 360 degree cameras, one or more ambisonic microphones, one or more headset microphones, one or more handheld wireless microphones, and one or more directional microphones.

In some embodiments, the one or more event representation data includes one or more of a point cloud data representing a point cloud of the one or more first entities in the one or more events, a mesh data representing a mesh surface of the one or more first entities, and a voxel data representing a voxel representation of an event space of the one or more events.

In some embodiments, the one or more sensor data further includes a stereo imagery data and a multi-view data.

In some embodiments, the one or more protocols include one or more of a Web Real-Time Communication (WebRTC) protocol and an HTTP Live Streaming (HLS) protocol.

In some embodiments, the one or more client devices 910 includes one or more of one or more mobile devices, one or more tablets, one or more augmented reality headsets, one or more virtual reality headsets, one or more mixed reality headsets, one or more smart displays, one or more room-scale extended reality setups, one or more augmented reality glass, one or more personal computers, one or more gaming consoles, one or more smart televisions, one or more room displays, one or more cave displays, one or more three-dimensional projectors, and one or more hologram tabletops.

In some embodiments, the one or more event representation data further includes at least one audio synchronized three-dimensional data representing an audio of the one or more events synchronized with a video of the one or more events. Further, the one or more sensors 908 may be further configured for capturing the audio and the video.

In some embodiments, the generating of the one or more depth data includes generating the one or more depth data using one or more personal computers.

In some embodiments, the generating of the one or more event representation data further includes generating the one or more event representation data using one or more graphical processing units (GPUs).

In some embodiments, the one or more graphical processing units further include a multiple GPU architecture associated with a parallel computational capability.

In some embodiments, the processing of the one or more event representation data further includes processing the one or more event representation data using one or more rendering software.

In some embodiments, the one or more codecs further include one or more audio codecs for low latency transforms and high-definition quality audio transmission. Further, the one or more audio codecs include one or more of a G.729 codec, an SVOPC codec, a SILK codec, and an Opus codec.

In some embodiments, the one or more codecs further include one or more video sharing codecs comprising an H.264/MPEG-4 Part 10 Advanced Video Coding codec.

In some embodiments, the one or more codecs further include at least one over-the-top streaming codec for modulating a streaming quality of the one or more streamable data based on one or more network conditions. Further, the at least one over-the-top streaming codec includes an MPEG-DASH (dynamic adaptive streaming over HTTP) codec.

In some embodiments, the one or more codecs further include one or more of a multi-view video coding profile codec, a stereo high profile codec for stereoscopic three-dimensional video, a multi-view high profile codec, a multi-view depth high profile codec, and a high efficiency video coding codec.

FIG. 18 illustrates a flowchart of a method 1800 of facilitating streaming of events including receiving, using the communication device 902, at least one control selection for at least one of the plurality of audio language options, the plurality of camera angle options, the plurality of subtitle options, and the plurality of streaming quality options from the at least one client device 910, in accordance with some embodiments.

Further, in some embodiments, the method 1800 may include a step 1802 of generating, using the processing device 904, a viewer control data based on the generating of the one or more event representation data. Further, the viewer control data includes an audio language category comprising two or more audio language options, a camera angle category representing two or more pre-defined camera angle options, a subtitle category comprising two or more subtitle options, and a streaming quality category comprising two or more streaming quality options. Further, in some embodiments, the method 1800 may include a step 1804 of transmitting, using the communication device 902, the viewer control data to the one or more client devices 910. Further, in some embodiments, the method 1800 may include a step 1806 of receiving, using the communication device 902, one or more control selections for one or more of the two or more audio language options, the two or more camera angle options, the two or more subtitle options, and the two or more streaming quality options from the one or more client devices. Further, the generating of the one or more streamable data may be further based on the one or more control selections.

In some embodiments, the one or more streamable data further includes one or more advertisement data representing one or more advertisements of one or more brands sponsoring the one or more events.

In some embodiments, the one or more advertisement data includes one or more interactive merchandise popup data representing a pop-up advertisement for a merchandise.

In some embodiments, the one or more creator dashboard data further includes an event pricing data representing a pricing for streaming the one or more events.

In some embodiments, the one or more creator dashboard data further includes a real-time audience interaction data representing a viewer count in the one or more events.

In some embodiments, the one or more interactive streamable data further includes a selfie video reaction data representing a selfie video reaction of the one or more clients overlaid on the one or more streamable data.

FIG. 19 illustrates a flowchart of a method 1900 of facilitating streaming of events including analyzing, using the processing device 904, the spatial audio request, in accordance with some embodiments.

Further, in some embodiments, the method 1900 may include a step 1902 of receiving, using the communication device 902, a spatial audio request for enabling spatial audio from the one or more client devices 910. Further, in some embodiments, the method 1900 may include a step 1904 of analyzing, using the processing device 904, the spatial audio request. Further, the generating of the one or more streamable data may be further based on the analyzing of the spatial audio request. Further, the generating of the one or more event streamable data further includes generating one or more spatial audio enabled streamable data based on the analyzing of the spatial audio request.

In some embodiments, the one or more client devices 910 may be further configured for rendering the one or more streamable data using one or more of a WebGL software, a Unity3D software, and one or more native mobile 3D engines.

In some embodiments, the one or more streamable data further includes a spatial tag data representing a virtual tag for the one or more first entities in the one or more events.

In some embodiments, the one or more user engagement data further includes a dwell time data representing a dwell time of the one or more clients in the one or more events and an avatar movement pattern data representing two or more movement patterns of the virtual reality avatar of the one or more clients.

In some embodiments, the one or more interactive streamable data may be anonymous.

In some embodiments, the one or more rewatch requests further include one or more time-jumping requests representing a request for a time jump in the recording of the one or more events.

In some embodiments, each of the spatial positioning algorithm and the head tracking support algorithm may be associated with one or more of an immersive mixed reality rendering and a virtual reality rendering of the one or more streamable data.

In some embodiments, the one or more event representation data further includes one or more of one or more depth map data and one or more segmentation mask data.

In some embodiments, the one or more client devices 910 may be further configured for running one or more of a Unity software, a WebXR software, and an unreal engine software.

In some embodiments, the text overlay data further includes a lyric data representing a lyric of a song playing in the one or more events.

In some embodiments, the one or more streamable data further includes a real-time player statistics data representing real-time statistics of a player in the one or more events.

In some embodiments, the one or more content delivery networks may be configured for multi-bitrate XR video delivery of the one or more streamable data.

In some embodiments, the one or more content delivery networks further include two or more content delivery networks for low latency XR content delivery of the one or more streamable data.

In some embodiments, the one or more security protocols further include one or more of a Secure Sockets Layer (SSL) protocol and an AES Advanced Encryption Standard (AES) protocol.

FIG. 20 illustrates a flowchart of a method 2000 of facilitating streaming of events including generating, using the processing device 904, a shared playback data representing a shared session state of the at least one event for the plurality of clients, in accordance with some embodiments.

Further, in some embodiments, the method 2000 may include a step 2002 of transmitting, using the communication device 902, the one or more streamable data to two or more client devices for social co-viewing. Further, the two or more client devices may be associated with the two or more clients. Further, in some embodiments, the method 2000 may include a step 2004 of receiving, using the communication device 902, one or more shared playback adjustment data representing a playback control of the streaming of the one or more events from one or more of the two or more client devices. Further, in some embodiments, the method 2000 may include a step 2006 of analyzing, using the processing device 904, the one or more shared playback adjustment data. Further, in some embodiments, the method 2000 may include a step 2008 of generating, using the processing device 904, a shared playback data representing a shared session state of the one or more events for the two or more clients based on the analyzing of the one or more shared playback adjustment data. Further, in some embodiments, the method 2000 may include a step 2010 of transmitting, using the communication device 902, the shared playback data to the two or more client devices.

In some embodiments, the shared playback data further includes a timecode alignment data representing an alignment of a timeline of the one or more events among the two or more client devices.

FIG. 21 illustrates a flowchart of a method 2100 of facilitating streaming of events including receiving, using the communication device 902, at least one token response to a token data from the at least one client device 910, in accordance with some embodiments.

Further, in some embodiments, the method 2100 may include a step 2102 of generating, using the processing device 904, a token data representing a token for validating an access of the one or more clients to the one or more events based on the determining of the privilege of the one or more clients. Further, in some embodiments, the method 2100 may include a step 2104 of transmitting, using the communication device 902, the token data to the one or more client devices 910. Further, in some embodiments, the method 2100 may include a step 2106 of receiving, using the communication device 902, one or more token responses to the token data from the one or more client devices 910. Further, the generating of the one or more streamable data may be further based on the one or more token responses.

In some embodiments, the one or more artificial intelligence content moderation models further include one or more of a natural language processing model and an image recognition model.

In some embodiments, the shared playback data further includes a shared viewpoint data representing a shared viewpoint of the one or more events for the two or more clients.

In some embodiments, the token data may be time-sensitive.

FIG. 22 illustrates a flowchart of a method 2200 of an end-to-end process for facilitating streaming of events, in accordance with some embodiments.

Further, the method 2200 may include a step 2202 of capturing from a smartphone and professional cameras. Further, the smartphone and the professional cameras support both professional and amateur content, thereby unlocking massive user generated content potential. Further, the method 2202 may include a step 2204 of using an AI 3D engine for proprietary real time 3D generation. The AI 3D engine transforms the standard video into an immersive three-dimensional video using multi-camera synchronization, depth mapping, and spatial sound. Further, the method 2200 may include a step 2206 of using a streaming infrastructure. Further, the streaming infrastructure allows enterprise-grade scale via AWS. AWS's proven cloud delivery stack ensures global reach, security, and ultra-low latency. Further, the method 2200 may include a step 2208 of allowing cross device playback. Further, the cross device playback may be provided on any screen, anywhere. The playback may be viewed on AR/VR, mobile, smart TVs, and more for maximizing audience reach across emerging and legacy hardware. Further, the method 2200 may include a step 2210 of providing a social layer. Further, the social layer has a built-in virality and retention. Further, the social layer has live “watch parties”, video selfies, and overlays that drive engagement, sharing, and monetization opportunities. Further, the method 2200 may include a step 2212 of providing Creator & Family Tools. Further, the Creator & Family Tools have everyday use cases that are equivalent to daily engagement. Further, the Creator & Family Tools are designed for creators and families to capture weddings, concerts, and milestones-fueling organic growth.

FIG. 23 illustrates an architecture of a system 2300 for facilitating streaming of events, in accordance with some embodiments.

Further, as shown in FIG. 23, a Capture Module 2308 is configured for receiving the one or more sensor data from Heterogeneous Systems 2302, a 360 degree camera 2304, and a Volumetric Capture Rig 2306. Further, a Reconstruction Engine 2310 is configured for generating the one or more event representation data based on the one or more sensor data. Further, a Compression and Encoding Module 2312 is configured for processing the one or more event representation data using an Interaction Layer 2314 based on the generating of the one or more event representation data. Further, the Compression and Encoding module 2312 is configured for generating the one or more streamable data based on the processing of the one or more event representation data. Further, a Device-Agnostic Stream Module 2316 is configured for streaming the one or more streamable data to Client Devices 2318. Further, the Client Devices 2318 include a Smartphone 2320, a Head Mounted Display (HMD) 2322, and a Tablet 2324. Further, the Interaction Layer 2314 is associated with Spatial Co-viewing, ViewPoint Control, Avatars, and Media Overlay.

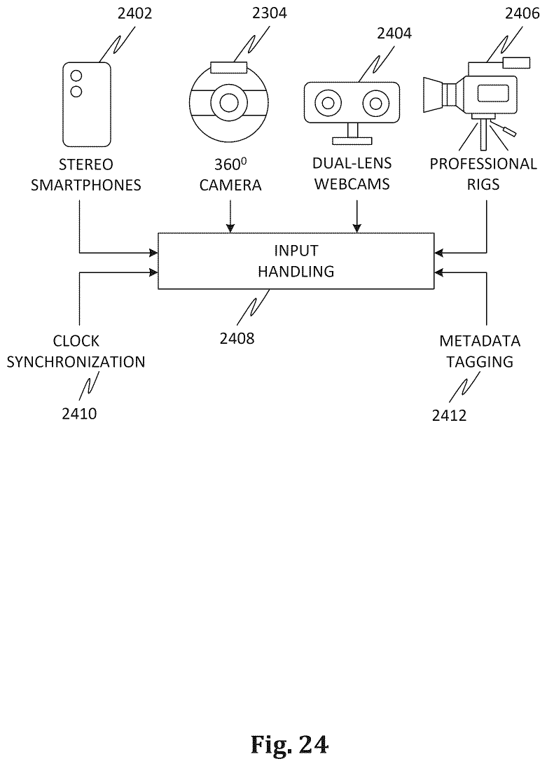

FIG. 24 depicts a heterogeneous input and capture pipeline for facilitating streaming of events, in accordance with some embodiments.

Further, as shown in FIG. 24, stereo smartphones 2402, the 360 degree camera 2304, a dual-lens webcam 2404, and professional rigs 2406 feed inputs into a unified input handling module 2408. Further, the heterogeneous input and capture pipeline includes a clock synchronization module 2410 and a metadata tagging module 2412.

FIG. 25 depicts an artificial intelligence based reconstruction pipeline 2500 for facilitating streaming of events, in accordance with some embodiments.

Further, the artificial intelligence based reconstruction pipeline 2500 includes an input processing module 2502, a convolutional neural network 2504, a multi-view stereo fusion module 2506, a depth estimation module 2508, and a volumetric mesh generation module 2510.

FIG. 26 illustrates a flowchart of a compression and streaming subsystem 2600 of the system 2300, in accordance with some embodiments.

Further, the flowchart includes a step 2604 of encoding a 3D reconstructed video 2602 into formats MPEG-4, glTF, and Draco 2606. Further, the flowchart includes a step of streaming the formats MPEG-4, glTF, and Draco 2606, an HLS protocol 2608 to client devices 2610.

FIG. 27 depicts a real-time spatial co-viewing interface 2700 of the system 2300, in accordance with some embodiments.

Further, the real-time spatial co-viewing interface 2700 may allow multiple users 2706 to interact in a 3D scene with individual viewpoint control 2702, avatars, emojis, overlays, text/video reactions 2704, and a synchronized timeline.

FIG. 28 depicts a content moderation and privacy control interface 2800 of the system 2300, in accordance with some embodiments.

Further, the content moderation and privacy control interface 2800 includes a user settings panel 2802 with avatar masking settings, mute controls settings, and visibility settings. Further, the content moderation and privacy control interface includes an automated moderation layer 2804 for detecting inappropriate content.

FIG. 29 illustrates a creator monetization dashboard interface 2900 of the system 2300, in accordance with some embodiments.

Further, the creator monetization dashboard interface 2900 depicts earnings of the content creator, engagement stats of the content creator, viewer count of the at least one event, access tier settings (free, PPV, subscription), and a payout button element.

FIG. 30 illustrates an alternative flowchart of a method 3000 associated with the system 2300, in accordance with some embodiments.

Further, the method 300 includes a modular software stack development module 3002 uses a microservices architecture with containerization, a cross device input standardization module 3004 for developing input adapters with hardware abstraction layer, a volumetric reconstruction and scene encoding module 3006 for employing SfM and neural implicit surface modeling, a real-time streaming subsystem 3008 to encode 3D scenes with adaptive bitrate logic, a spatial interaction layer and an avatar engine 3010 to encode 3D scenes with adaptive bitrate logic, and a deployment and continuous optimization module 3012 to distribute via cloud environments and monitor analytics.

FIG. 31 illustrates a block diagram of a system 3100 for facilitating streaming of events, in accordance with some embodiments.

Further, the system 3100 includes an array of RGB-D and Near Infrared Cameras 3102, Directional Microphones 3104, a Video and Audio Production Console 3106, Video and Audio Processing Central Processing Units (CPUs) 3108, 3D Reconstruction Graphic Processing Units (GPUs) 3110, Rendering and Encoding CPUs 3112, Content Delivery Networks (CDNs) 3114, and Display Devices 3116. Further, the Array of RGB-D and Near Infrared camera 3102 is configured for capturing the one or more sensor data. Further, the Video and Audio Processing Central Processing Units 3108 are configured for analyzing the at least one sensor data. Further, the 3D Reconstruction Graphic Processing Units 3110 are configured for generating the event representation data. Further, the Rendering and Encoding CPUs 3112 are configured for generating the one or more streamable data. Further, the Content Delivery Networks 3114 are configured for transmitting the one or more streamable data to the Display Devices 3116.

Although the invention has been explained in relation to its preferred embodiment, it is to be understood that many other possible modifications and variations can be made without departing from the spirit and scope of the invention as hereinafter claimed.

What is claimed is:

1. A method of facilitating streaming of events, the method comprising:
receiving, using a communication device, at least one sensor data from at least one sensor, wherein the at least one sensor is configured for generating the at least one sensor data by capturing at least one event;
analyzing, using a processing device, the at least one sensor data;
generating, using the processing device, at least one event representation data representing a virtual reconstruction of the at least one event based on the analyzing of the at least one sensor data;
processing, using the processing device, the at least one event representation data;
generating, using the processing device, at least one streamable data for streaming the at least one event based on the processing of the at least one event representation data;
storing, using a storage device, the at least one streamable data; and
transmitting, using the communication device, the at least one streamable data to at least one client device associated with at least one client, wherein the at least one client device is configured for presenting the at least one streamable data.

2. The method of claim 1, wherein the generating of the at least one event representation data comprises generating the at least one event representation data using at least one artificial intelligence model for the virtual reconstruction of the at least one event, wherein the processing of the at least one event representation data is further based on the generating of the at least one event representation data using the at least one artificial intelligence model.

3. The method of claim 1 further comprising:
receiving, using the communication device, at least one rewatch request associated with a recording of the at least one event from the at least one client device;
analyzing, using the processing device, the at least one rewatch request;
retrieving, using the storage device, the at least one streamable data based on the analyzing of the at least one rewatch request;
processing, using the processing device, the at least one streamable data;
generating, using the processing device, at least one rewatch streamable data for rewatching the at least one event with playback controls based on the processing of the at least one streamable data; and
transmitting, using the communication device, the at least one rewatch streamable data to the at least one client device, wherein the at least one client device is configured for controlling a playback of the at least one rewatch streamable data.

4. The method of claim 1, wherein the processing of the at least one event representation data comprises:
compressing the at least one event representation data; and
encoding the at least one event representation data using an adaptive bitrate encoding technique based on the compressing of the at least one event representation data, wherein the generating of the at least one streamable data is further based on the encoding of the at least one event representation data.

5. The method of claim 1, wherein the transmitting of the at least one streamable data further comprises transmitting the at least one streamable data using at least one protocol.

6. The method of claim 1 further comprising:
generating, using the processing device, at least one dense point cloud data representing at least one dense point cloud of at least one first entity in the at least one event based on the analyzing of the at least one sensor data; and
analyzing, using the processing device, the at least one dense point cloud data using at least one first algorithm, wherein the generating of the at least one event representation data is further based on the analyzing of the at least one dense point cloud data, wherein the generating of the at least one event representation data comprises generating at least one temporally consistent three-dimensional scene data representing a volumetric representation of an event space of the at least one event based on the analyzing of the at least one dense point cloud data.

7. The method of claim 1, wherein the processing of the at least one event representation data further comprises processing the at least one event representation data using at least one codec.

8. The method of claim 1 further comprising:
generating, using the processing device, at least one creator dashboard data based on the at least one event representation data, wherein the at least one creator dashboard data comprises a plurality of event access options, wherein the at least one creator dashboard data represents an user interface element presenting engagement metrics of the at least one event and the plurality of event access options;
transmitting, using the communication device, the at least one creator dashboard data to the at least one client device, wherein the at least one client device is further configured for presenting the at least one creator dashboard data; and
receiving, using the communication device, at least one access selection for the plurality of event access options from the at least one client device, wherein the generating of the at least one streamable data is further based on the at least one access selection.

9. The method of claim 1 further comprising:
receiving, using the communication device, at least one viewpoint request data from the at least one client device, wherein the at least one viewpoint request data represents a request for a different viewpoint of the at least one event; and
analyzing, using the processing device, the at least one viewpoint request data using the at least one event representation data, wherein the generating of the at least one streamable data is further based on the analyzing of the at least one viewpoint request, wherein the generating of the at least one streamable data further comprises generating at least one alternate viewpoint data representing the different viewpoint based on the analyzing of the at least one viewpoint request data.

10. The method of claim 1 further comprising:
receiving, using the communication device, at least one social interaction data from the at least one client device, wherein the at least one social interaction data is associated with a social interaction of the at least one client with a plurality of clients streaming the at least one event; and
analyzing, using the processing device, the at least one social interaction data, wherein the generating of the at least one streamable data is further based on the analyzing of the at least one social interaction data, wherein the generating of the at least one streamable data further comprises generating at least one interactive streamable data representing a social presence of the at least one client in the at least one event based on the analyzing of the at least one social interaction data.

11. A system of facilitating streaming of events, the system comprising:
a communication device configured for:
receiving at least one sensor data from at least one sensor, wherein the at least one sensor is configured for generating the at least one sensor data by capturing at least one event; and
transmitting at least one streamable data to at least one client device associated with at least one client, wherein the at least one client device is configured for presenting the at least one streamable data;
a processing device communicatively coupled to the communication device is configured for:
analyzing the at least one sensor data;
generating at least one event representation data representing a virtual reconstruction of the at least one event based on the analyzing of the at least one sensor data;
processing the at least one event representation data; and
generating the at least one streamable data for streaming the at least one event based on the processing of the at least one event representation data; and
a storage device communicatively coupled to the processing device, wherein the storage device is configured for storing the at least one streamable data.

12. The system of claim 11, wherein the generating of the at least one event representation data comprises generating the at least one event representation data using at least one artificial intelligence model for scene understanding and reconstruction of the at least one event, wherein the processing of the at least one event representation data is further based on the generating of the at least one event representation data using the at least one artificial intelligence model.

13. The system of claim 11, wherein the communication device is further configured for:
receiving at least one rewatch request associated with a recording of the at least one event from the at least one client device; and
transmitting at least one rewatch streamable data to the at least one client device, wherein the at least one client device is configured for controlling a playback of the at least one rewatch streamable data, wherein the processing device is further configured for:
analyzing the at least one rewatch request;
processing the at least one streamable data; and
generating the at least one rewatch streamable data for rewatching the at least one event with playback controls based on the processing of the at least one streamable data, wherein the storage device is further configured for retrieving the at least one streamable data based on the analyzing of the at least one rewatch request.

14. The system of claim 11, wherein the processing of the at least one event representation data comprises:
compressing the at least one event representation data; and
encoding the at least one event representation data using an adaptive bitrate encoding technique based on the compressing of the at least one event representation data, wherein the generating of the at least one streamable data is further based on the encoding of the at least one event representation data.

15. The system of claim 11, wherein the transmitting of the at least one streamable data further comprises transmitting the at least one streamable data using at least one protocol.

16. The system of claim 11, wherein the processing device is further configured for:
generating at least one dense point cloud data representing at least one dense point cloud of at least one first entity in the at least one event based on the analyzing of the at least one sensor data; and
analyzing the at least one dense point cloud data using at least one first algorithm, wherein the generating of the at least one event representation data is further based on the analyzing of the at least one dense point cloud data, wherein the generating of the at least one event representation data comprises generating at least one temporally consistent three-dimensional scene data representing a volumetric representation of an event space of the at least one event based on the analyzing of the at least one dense point cloud data.

17. The system of claim 11, wherein the processing of the at least one event representation data further comprises processing the at least one event representation data using at least one codec.

18. The system of claim 11, wherein the processing device is further configured for generating at least one creator dashboard data based on the at least one event representation data, wherein the at least one creator dashboard data comprises a plurality of event access options, wherein the at least one creator dashboard data represents an user interface element presenting engagement metrics of the at least one event and the plurality of event access options, wherein the communication device is further configured for:
transmitting the at least one creator dashboard data to the at least one client device, wherein the at least one client device is further configured for presenting the at least one creator dashboard data; and
receiving at least one access selection for the plurality of event access options from the at least one client device, wherein the generating of the at least one streamable data is further based on the at least one access selection.

19. The system of claim 11, wherein the communication device is further configured for receiving at least one viewpoint request data from the at least one client device, wherein the at least one viewpoint request data represents a request for a different viewpoint of the at least one event, wherein the processing device is further configured for analyzing the at least one viewpoint request data using the at least one event representation data, wherein the generating of the at least one streamable data is further based on the analyzing of the at least one viewpoint request data, wherein the generating of the at least one streamable data further comprises generating at least one alternate viewpoint data representing the different viewpoint based on the analyzing of the at least one viewpoint request data.

20. The system of claim 11, wherein the communication device is further configured for receiving at least one social interaction data from the at least one client device, wherein the at least one social interaction data is associated with a social interaction of the at least one client with a plurality of clients streaming the at least one event, wherein the processing device is further configured for analyzing the at least one social interaction data, wherein the generating of the at least one streamable data is further based on the analyzing of the at least one social interaction data, wherein the generating of the at least one streamable data further comprises generating at least one interactive streamable data representing a social presence of the at least one client in the at least one event based on the analyzing of the at least one social interaction data.
